(19) United States
(12) Patent Application Publication
(10) Pub. No.: US 2023/0382749 A1
(43) Pub. Date: Nov. 30, 2023

(54) PHOTODRIVEN TRANSFER HYDROGENATION OF N2 TO NH3

(71) Applicant: California Institute of Technology, Pasadena, CA (US)

(72) Inventors: Christian M. JOHANSEN, Pasadena, CA (US); Emily A. BOYD, Pasadena, CA (US); Jonas C. PETERS, Pasadena, CA (US)

(21) Appl. No.: 18/324,521

(22) Filed: May 26, 2023

Related U.S. Application Data
(60) Provisional application No. 63/346,423, filed on May 27, 2022.

(51) Int. Cl. C01C 1/04; C01C 1/08; B01J 19/12; B01J 35/00; B01J 35/12; B01J 31/18; B01J 31/02

(52) U.S. Cl. CPC C01C 1/0411; C01C 1/08; B01J 19/127; B01J 35/004; B01J 35/12; B01J 31/189; B01J 31/0298; B01J 31/181; B01J 31/0284; B01J 2219/0892; B01J 2219/0884; B01J 2219/1203; B01J 2523/68; B01J 2523/827; B01J 2231/62; B01J 2231/641; B01J 2531/007

(57) ABSTRACT

Included herein are methods for photodriven hydrogenation of N₂, the methods comprising, for example: hydrogenating N₂ to NH₃ in the presence of a light, an organic transfer agent, and a first metal-containing catalyst; wherein: the transfer agent and the first catalyst are in a solution; the transfer agent comprises n chemically transferable electrons and protons, n being an integer equal to or greater than 1; the step of hydrogenating comprises at least one charge-transfer reaction via which the transfer agent donates at least one electron and at least one proton to one or more other chemical species; the step of hydrogenating comprises at least one photochemical reaction; and the light is characterized by energy sufficient to drive the at least one photochemical reaction. Also disclosed herein are methods comprising regenerating a spent-transfer agent back into the transfer agent.

### CROSS-REFERENCE TO RELATED APPLICATIONS

This application claims the benefit of priority to U.S. Provisional Patent Application No. 63/346,423, filed May 27, 2022, which is hereby incorporated by reference in its entirety.

### STATEMENT REGARDING FEDERALLY SPONSORED RESEARCH OR DEVELOPMENT

This invention was made with government support under Grant No. GM070757 awarded by the National Institutes of Health. The government has certain rights in the invention.

### BACKGROUND OF INVENTION

The Haber-Bosch process enabled industrial-scale production of ammonia, which gave rise to new industries. The Haber-Bosch process is an example of a hydrogenation process. Hydrogenation processes, such as of normally stable molecules such as N₂ and CO₂, represent a useful approach and useful sources for generating value-added chemicals and materials. N₂ is abundant, and therefore an interesting source for production of NH₃ and derivative chemicals. However, typical hydrogenation processes require intense energy input in the form of temperature and pressure (e.g., Haber-Bosch process), electrical energy, and/or aggressive chemical reagents, for example, which results in high environmental and/or commercial costs. There is a need, therefore, for hydrogenation processes, capable of hydrogenating substrates such as N₂, which do not require high heat, high pressure, high electrical energy input, or aggressive chemical reagents.

### SUMMARY OF THE INVENTION

Provided herein are methods that address the above issues by providing hydrogenation processes that can hydrogenate substrates such as, but not limited to, N₂ without requiring or necessarily using high heat, high pressure, high electrical energy, and/or aggressive chemical reagents. Instead, the hydrogenation processes disclosed herein may be performed under mild conditions where the energy input to drive the hydrogenation is in the form of light.

Included herein are methods for photodriven hydrogenation of N₂, the methods comprising, for example: hydrogenating N₂ to NH₃ in the presence of a light, an organic transfer agent, and a first metal-containing catalyst; wherein: the transfer agent and the first catalyst are in a solution; the transfer agent comprises n chemically transferable electrons and protons, n being an integer equal to or greater than 1; the step of hydrogenating comprises at least one charge-transfer reaction via which the transfer agent donates at least one electron and at least one proton to one or more other chemical species; the step of hydrogenating comprises at least one photochemical reaction; and the light is characterized by energy sufficient to drive the at least one photochemical reaction. Also disclosed herein are methods comprising regenerating a spent-transfer agent back into the transfer agent.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIGS. 1A-1C: Thermodynamics and strategies for hydrogenation of N₂. FIG. 1A: Thermodynamics of hydrogenation of N₂ to NH₃. FIG. 1B: Schematic of an overall design for light-driven transfer hydro-genation of N₂; chemical structure of the Hantzsch ester used in this study (HEH₂); representative reduction of α-bromo acetophenone. FIG. 1C: Net stoichiometry and estimated driving force of transfer hydrogenation from HEH₂ to N₂ forming NH₃; photodriven (blue LED) process described in this study, in the absence and presence of a photoredox catalyst. All thermochemical values are given in MeCN at 25° C. with ferrocenium/ferrocene (Fc^{+/0}) as reference potential.

FIG. 2: Catalytic yields for photodriven transfer hydrogenation of N₂ to NH₃, NO₃ ⁻ to NH₃, and acetylene to ethylene and ethane. Reactions performed with 2.3 mM [Mo]Br₃ concentration, using a single 34 W Kessel H150 Blue lamp unless otherwise noted. All yields reported are an average of at least two runs. All runs with Ir use 2.3 mM photosensitizer loading unless otherwise noted. ^{a}3.6 mM [Mo]Br₃. ^{b}3.6 mM Ir. Ir=[Ir(ppy)₂(dtbbpy)]BAr^{F}₄; ppy=2-phenylpyridinyl; dtbbpy=4,4′-di-tert-butyl-2,2′-bipyridine; BAr^{F}₄=tetrakis(3,5-bis(trifluoromethyl)phenyl)borate; dF(CF₃)ppy=5-trifluoromethyl-2-(3,5-difluoro-phenyl)-pyridine; p-F(Me)ppy=5-methyl-2-(5-fluoro-phenyl)-pyridine; PF₆—=hexafluorophosphate).

FIGS. 3A-3B: Possible scenarios for photodriven transfer hydrogenation from HEH₂ to N₂ mediated by a metal catalyst and buffer system (Col/[ColH]*). FIG. 3A: Scenario in absence of photoredox catalyst, in which [HEH₂]* is oxidatively quenched by [ColH]⁺ to generate [ColH]⁻. FIG. 3B: Scenario with photoredox catalyst, in which [Ir^{III}]⁺* is reductively quenched by HEH₂. Pathways involving N═N bond cleavage to yield M=N intermediates (not shown) are also plausible (FIGS. 25A-25B).

FIG. 4: Estimated BDFE_{eff} values and corresponding ΔΔG_{f}(NH₃) for the transformations of interest herein. Values estimated using eqns 1 and 2.

FIG. 5: Set-up for catalysis with Schlenk tube, stir plate, Kessil® 34 W 150 Blue lamp and dewar. Lamp is turned off for clarity.

FIGS. 6A-6D: ¹H NMR (DMSO-d₆, 400 MHz) of: FIG. 6A: ¹⁴NH₄Cl obtained from reaction of natural abundance reactants under ¹⁴N₂ (Ir-free conditions in FIG. 2, entry 1). FIG. 6B: ¹⁴NH₄Cl obtained from reaction of ¹⁵N-labeled HEH₂ (otherwise natural abundance reactants) under ¹⁴N₂ (Ir-free conditions in FIG. 2, entry 1). FIG. 6C: ¹⁴NH₄Cl obtained from reaction of ¹⁵N-labeled Col/[ColH]OTf (otherwise natural abundance reactants) under ¹⁴N₂ (Ir-free conditions in FIG. 2, entry 1); FIG. 6D: ¹⁵NH₄Cl obtained from reaction under ¹⁵N₂ (otherwise natural abundance reactants, Ir-free conditions in FIG. 2, entry 1).

FIG. 7: ¹H NMR (DMSO-d₆, 400 MHz) of the nonvolatile products of the Mo-catalyzed reaction of HEH₂, [ColH]OTf, [Col], and N₂ under blue LED irradiation (FIG. 2, entry 1).

FIG. 8: ¹H NMR (DMSO-d₆, 400 MHz) of the nonvolatile products of the Col/[ColH]OTf-, Ir- and Mo-catalyzed reaction of HEH₂ and N₂ under blue LED irradiation (FIG. 2, entry 11, catalytic buffer).

FIG. 9: CW-EPR spectrum (2-MeTHF, 77 K) of non-volatile products post-catalysis (conditions in FIG. 2, entry 1). Mixture of unknown [Mo] products are observed.

FIG. 10A: ¹H NMR (THF-d₈, 400 MHz) time course of the Mo-catalyzed reaction of HEH₂, [ColH]OTf, Col, and N₂ under blue LED irradiation in a J. Young tube (FIG. 2, entry 1). FIG. 10B: Relative ratio of HE and HEH₂ plotted over time.

FIG. 11: ¹H NMR (THF-d₈, 400 MHz) of 15 minutes and 48 hour time points of the reaction of the Mo-catalyzed reaction of HEH₂, [ColH]OTf, Col, and N₂ under blue LED irradiation in a J. Young tube (FIG. 9). Integrals of HEH₂ and HE quartet peak at 4.0 ppm are compared to constant THF solvent residual peaks to estimate total recovery of HEH₂ and HE. Approx. 90% is recovered. Similarly, integrals of Col/[ColH]OTf aromatic peak at ˜7.0 ppm are compared to constant THF solvent residual peaks to estimate total recovery of Col/[ColH]OTf. Approx. 90% is recovered. *indicates minor organic impurity that grows in, see FIG. 12.

FIG. 12: ¹H NMR (THF-d₈, 400 MHz) before irradiation and at indicated timepoints following blue LED irradiation of the reaction of HEH₂ with 1 equiv Col and 1 equiv [ColH]OTf in a J. Young tube. Integration relative to the THF residual peak at 3.58 ppm indicates that after 48 hours, 79% of HEH₂ and 10% of the total initial buffer loading are consumed, while HE is produced in 16% conversion along with the same major organic side product peaks observed in N₂R with [Mo]Br₃ (FIGS. 10A, 10B and 11).

FIG. 13: ¹H NMR (THF-d₈, 400 MHz) before irradiation and at indicated timepoints following blue LED irradiation of HE with 1 equiv Col and 1 equiv [ColH]OTf in a J. Young tube. No reaction is observed.

FIG. 14: ¹H NMR (THF-d₈, 400 MHz) of 15 minutes to 240 min of the Mo-catalyzed reaction of HEH₂, [ColH]OTf, Col, and N₂ under blue LED irradiation in a J. Young tube (FIGS. 10A-10B). The H2 peak (4.54 ppm, ref. 45) grows in over time.

FIG. 15A: Steady-state fluorescence of HEH₂ (0.5 mM) with varying amounts of [ColH]OTf (18 mM to 144 mM). FIG. 15B: Stern-Vollmer quenching plot of I₀/I_{c} against concentration of [ColH]OTf. Slope is 42±2.4 M⁻¹; R²=0.98.

FIG. 16A: Steady-state fluorescence of HEH₂ (0.5 mM) with varying amounts of Col (18 mM to 144 mM). FIG. 16B: Stern-Vollmer quenching plot of I₀/I_{c} against concentration of Col (bottom). Slope is 1.3±0.9 M⁻¹.

FIG. 17: UV-vis of HEH₂ (0.1 mM) with 0 mM (blue) to 14 mM (red) Col concentration.

FIG. 18: UV-vis of HEH₂ (0.1 mM) with 0 mM (blue) to 11 mM (red) [ColH]OTf concentration.

FIG. 19: Reaction conditions and balanced equation for the catalytic reduction of [TBA]NO₃ to generate NH₃.

FIGS. 20A-20F: ¹H NMR (DMSO-d₆, 400 MHz) of: FIG. 20A: ¹⁴NH₄Cl obtained from reaction of natural abundance [TBA]NO₃ with HEH₂, buffer, and [Mo]Br₃ under blue light irradiation (Table 7 entry A7). FIG. 20B: ¹⁵NH₄Cl obtained from reaction of [TBA]¹⁵NO₃ with HEH₂, buffer, and [Mo]Br₃ under blue light irradiation. FIG. 20C: ¹⁴NH₄Cl obtained from reaction of natural abundance [TBA]NO₃ with HEH₂, buffer, [Mo]Br₃ and [Ir]BAr^{F}₄ under blue light irradiation (Table 7, entry C7). FIG. 20D: ¹⁵NH₄Cl obtained from reaction of [TBA]¹⁵NO₃ with HEH₂, buffer, [Mo]Br₃ and [Ir]BAr^{F}₄ under blue light irradiation. FIG. 20E: ¹⁴NH₄Cl obtained from reaction of natural abundance [TBA]NO₃ with HEH₂, buffer, and [Ir]BAr^{F}₄ under blue light irradiation (Table 7, entry F7).

FIG. 20F: ¹⁵NH₄Cl obtained from reaction of [TBA]¹⁵NO₃ with HEH₂, buffer, and [Ir]BAr^{F}₄ under blue light irradiation.

FIG. 21: Comparison of ΔG (in kcal mol⁻¹) in aqueous solution of pH 0 referenced to NHE.(49, 50) While the 6e⁻ reduction and 8e⁻ reduction of N₂ and NO₃—respectively are both downhill, only the intermediates of NO₃ are also thermodynamically favored to form.

FIG. 22: Balanced equations for the catalytic reduction of acetylene to generate ethylene and ethane.

FIGS. 23A-23C: ¹H NMR (THF-d₈, 400 MHz) of the volatiles obtained from the acetylene reduction reaction in Table 8: FIG. 23A: Standard conditions (Table 8, entry A8). FIG. 23B: No [Mo]Br₃ (Table 8, entry E8). FIG. 23C: No irradiation (Table 8, entry 18). *Trace pentane.

FIG. 24: Mechanistic scenario in absence of photoredox catalyst in which [HEH₂]* is quenched by a M(N₂) intermediate.

FIGS. 25A-25B: Possible scenarios for photodriven transfer hydrogenation from HEH₂ to N₂ mediated by a metal catalyst and buffer system (Col/[ColH]*). These schemes depict a mechanism in which N₂ cleavage occurs and the subsequent M≡N is hydrogenated. FIG. 25A: Scenario in absence of photoredox catalyst, in which [HEH₂]* is oxidatively quenched by [ColH]⁺ to generate [ColH]*. FIG. 25B: Scenario with photoredox catalyst, in which [Ir^{III}]⁺* is reductively quenched by HEH₂.

FIG. 26: ¹H NMR (DMSO-d₆, 400 MHz) of ¹⁵N-HEH₂.

FIG. 27: ¹H NMR (DMSO-d₆, 400 MHz) of ¹⁵N-labelled [ColH]OTf.

FIG. 28: ¹H NMR (MeCN-d₃, 400 MHz) of [Ir]BAr^{F}₄.

FIG. 29: Schemes and conditions representing exemplary aspects of hydrogenation processes disclosed herein, according to some aspects.

FIG. 30: Schemes, conditions, and reagents representing exemplary aspects of hydrogenation processes disclosed herein, according to some aspects.

FIG. 31: Schemes, conditions, and reagents representing exemplary aspects of hydrogenation processes disclosed herein, according to some aspects.

FIG. 32: Schemes, conditions, and reagents representing exemplary aspects of hydrogenation processes disclosed herein, according to some aspects.

FIG. 33: Exemplary conditions, according to some aspects, for hydrogenation of N₂, further including a table summarizing the effect of removing a particular component of the process.

FIGS. 34A-34B: Exemplary conditions, according to some aspects, for hydrogenation of N₂, and corresponding NMR spectra.

FIG. 35: Exemplary conditions, according to some aspects, for hydrogenation of N₂, further including a table summarizing the effect of varying the buffer or aspects thereof.

FIGS. 36A-36B: Exemplary conditions, according to some aspects, for hydrogenation of N₂, further including a table summarizing the effects of changing the buffer.

FIG. 37: Exemplary conditions, according to some aspects, for hydrogenation of N₂, further including a table summarizing the effects of changing the transfer agent.

FIG. 38: Exemplary conditions, according to some aspects, for hydrogenation of N₂, further including a table summarizing the effects of changing the light.

FIG. 39: Exemplary conditions, according to some aspects, for hydrogenation of N₂, further including a table summarizing the effects of changing the light, and further including light spectra corresponding to the different light examples.

FIG. 40: Exemplary conditions, according to some aspects, for hydrogenation of N₂, further including a plot summarizing the NH₃ yield per catalyst as a function of relative buffer concentration under blue or red light.

FIGS. 41A-41B: Steady-state fluorescence of HEH₂ (0.5 mM) with varying amounts of buffer.

FIG. 42: Exemplary conditions, components, and aspects, for certain hydrogenation processes included herein.

FIGS. 43A-43B: Plot showing solution state infrared data in THF.

FIGS. 44A-44C: EPR data of organic radical formed upon illumination.

FIG. 45: Thermodynamic data corresponding to the illustrated molecules and their interaction.

FIG. 46: Exemplary aspects pertaining to the metal catalyst for hydrogenation.

FIGS. 47A-47E: Exemplary conditions, components, and aspects, for certain hydrogenation processes included herein, including UV-Vis data at different time ranges during the hydrogenation process summarized.

FIGS. 48A-48F: Exemplary conditions, components, and aspects, for certain hydrogenation processes included herein.

FIG. 49: A reaction scheme, summarizing chemical reactions of a hydrogenation process, according to some aspects herein, for hydrogenation of N₂.

FIG. 50: Exemplary conditions, components, and aspects, for certain hydrogenation processes included herein, with a photosensitizer.

FIG. 51: Exemplary conditions, components, and aspects, for certain hydrogenation processes included herein, with a photosensitizer, further including a table summarizing the effect of varying aspects associated with the photosensitizer.

FIG. 52: Exemplary conditions, components, and aspects, for certain hydrogenation processes included herein, including UV-Vis data at different time ranges during the hydrogenation process summarized.

FIG. 53: A reaction scheme, summarizing chemical reactions of a hydrogenation process, according to some aspects herein, for hydrogenation of N₂ with a photosensitizer.

FIG. 54: Exemplary conditions, components, and aspects, for certain hydrogenation processes included herein, summarizing that yield of hydrogenated product is increased with use of a photosensitizer.

FIG. 55: Illustrations showing that light may overcome the activation barrier needed for hydrogenation to initiate and proceed.

FIG. 56A: Exemplary thermodynamic data corresponding to various aspects of hydrogenation processes disclosed herein, generally showing that light is able to drive the hydrogenation processes disclosed herein.

FIG. 57: Exemplary conditions, components, and aspects, for certain hydrogenation processes included herein.

FIG. 58: Exemplary conditions, components, and aspects, for certain hydrogenation processes included herein in comparison to Haber-Bosch.

FIG. 59: Exemplary conditions, components, and aspects, for certain hydrogenation processes included herein, including an exemplary starting species or substrates.

FIGS. 60-62: Exemplary conditions, components, and aspects, for certain hydrogenation processes including transfer agent regeneration/recycle processes, referred to as Transfer Agent Recycle Strategy #1, according to aspects herein.

FIG. 63-66: Exemplary conditions, components, and aspects, for certain hydrogenation processes including transfer agent regeneration/recycle processes, referred to as Transfer Agent Recycle Strategy #2, according to aspects herein.

FIGS. 67 and 68A-68C: Exemplary conditions, components, and aspects, for certain hydrogenation processes including transfer agent regeneration/recycle processes, referred to as Transfer Agent Recycle Strategy #3, according to aspects herein.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

As used herein, the term “hydrogenation” generally refers to the addition of at least one H, each H being a proton and electron pair (i.e., one proton and one electron) or a “proton-electron pair”, to another molecule or compound via one or more chemical reactions involving at least one reagent having one or more transferable H and said another molecule or compound to form a hydrogenated or a hydrogenated and reduced product, relative to the substrate. Said another molecule or compound may be referred to herein as the substrate, such as N₂, for example. The hydrogenated or reduced product refers to the desired or intended product of the hydrogenation reaction, such as NH₃, and generally does not refer to but does not obviate the possibility of byproducts being produced. In some aspects, the hydrogenated or reduced product is one chemical species, such as NH₃. In some aspects, the hydrogenated or reduced product is two or more chemical species, which may be referred to together as the (hydrogenated or reduced) products, such as H2CCH₂ and H3CCH₃ (e.g., wherein the substrate may be HCCH). The reagent having one or more transferable H is referred to herein as a “transfer agent,” such as a Hantzsch ester. The transfer agent transfers or donates its one or more transferable H directly and/or indirectly (e.g., intermediate species and/or other reagents, catalysts, cocatalysts, buffer acid and/or base species, etc., may be involved to effectuate the transfer or hydrogenation) to said substrate via one or more chemical reactions. In some aspects, each molecule of a transfer agent has one, two, three, or four transferrable H. In some aspects, a transfer agent is one chemical species, such as a Hantzsch ester. In some aspects, a transfer agent is two, three, or four different chemical species that together behave, function, or serve as the transfer agent to transfer or donate the one or more transferable H thereof to said substrate. Generally, unless made explicitly otherwise (an example being “H2 gas”), “H2” is used herein as a shorthand to refer to two transferable or transferred H or two electron-proton pairs or 2e⁻/2 H⁺, rather than H2 gas, as would be evident to those skilled in the art in light of the discussion and descriptions herein. In some aspects, multiple molecules of the transfer agent participate in a single pass of the complete hydrogenation reaction. For example, in some aspects, a complete single pass of hydrogenation of N₂ to NH₃ requires three Hantzsch ester molecules, to transfer a total of 6H, or 6e⁻/6 H⁺, per single N₂ molecule which yields two molecules of NH₃ as product. In some aspects, hydrogenation refers to the addition of one H to another molecule or compound (to the substrate). In some aspects, hydrogenation refers to the addition of two H to another molecule or compound (to the substrate). In some aspects, hydrogenation refers to the addition of three H to another molecule or compound (to the substrate). In some aspects, hydrogenation refers to the addition of four H to another molecule or compound (to the substrate). The hydrogenation reaction may also be a reduction reaction, such as in the case of hydrogenation of N₂ to NH₃, which is also referred to as the nitrogen reduction reaction (N₂RR). Generally, a hydrogenation process requires energy input which may be in the form of heat and/or pressure, notably such as the Haber-Bosch process, harsh chemical reagents, electrical energy, and/or light. Generally, the hydrogenation processes and reactions disclosed herein are photodriven, preferably, but not necessarily, wherein no extra heat and pressure beyond that of standard room temperature conditions such as NTP (NTP=normal temperature and pressure being 20° C. and 1 atm) is necessary and/or is provided for the hydrogenation, and further preferably, but not necessarily, wherein no extra heat and pressure beyond that of standard room temperature conditions such as NTP nor electrical energy (e.g., no voltage bias through the reaction solution) is necessary and/or is provided for the hydrogenation. In some aspects, the hydrogenation processes and reactions disclosed herein comprise at least one photochemical reaction, or photodriven chemical reaction, as would be understood by those skilled in the relevant art(s).

The terms “analog” and “analogue” are used interchangeably and are used in accordance with their plain ordinary meaning within Chemistry and Biology and refers to a chemical compound that is structurally similar to another compound (i.e., a so-called “reference” compound) but differs in composition, e.g., in the replacement of one atom by an atom of a different element, or in the presence of a particular functional group, or the replacement of one functional group by another functional group, or the absolute stereochemistry of one or more chiral centers of the reference compound, including isomers thereof. Accordingly, an analog is a compound that is similar or comparable in function and appearance but not in structure or origin to a reference compound. The analogue can be a natural analogue or a synthetic analogue. In embodiments, a peptide analogue has five or fewer substituted or unsubstituted amino acids, or derivatives thereof, that are different, removed, added, or any combination of these, with respect to the reference peptide.

As used herein, the term “group” may refer to a functional group of a chemical compound. Groups of the present compounds refer to an atom or a collection of atoms that are a part of the compound. Groups of the present invention may be attached to other atoms of the compound via one or more covalent bonds. Groups may also be characterized with respect to their valence state. The present invention includes groups characterized as monovalent, divalent, trivalent, etc. valence states.

The term “moiety” refers to a group, such as a functional group, of a chemical compound or molecule. A moiety is a collection of atoms that are part of the chemical compound or molecule. The present invention includes moieties characterized as monovalent, divalent, trivalent, etc. valence states. Generally, but not necessarily, a moiety comprises more than one functional group. A “peptide moiety” is a moiety or group that comprises or consists of a peptide.

As used herein, the term “substituted” refers to a compound wherein one or more hydrogens is replaced by another functional group, provided that the designated atom's normal valence is not exceeded. An exemplary substituent includes, but is not limited to: a halogen or halide, an alkyl, a cycloalkyl, an aryl, a heteroaryl, an acyl, an alkoxy, an alkenyl, an alkynyl, an alkylaryl, an arylene, a heteroarylene, an alkenylene, a cycloalkenylene, an alkynylene, a hydroxyl (—OH), a carbonyl (RCOR′), a sulfide (e.g., RSR′), a phosphate (ROP(═O)(OH)₂), an azo (RNNR′), a cyanate (ROCN), an amine (e.g., primary, secondary, or tertiary), an imine (RC(═NH)R′), a nitrile (RCN), a pyridinyl (or pyridyl), a diamine, a triamine, an azide, a diimine, a triimine, an amide, a diimide, or an ether (ROR′); where each of R and R′ is independently a hydrogen or a substituted or unsubstituted alkyl group, aryl group, alkenyl group, or a combination of these. Optional substituent functional groups are also described below. In some embodiments, the term substituted refers to a compound wherein each of more than one hydrogen is replaced by another functional group, such as a halogen group. For example, when the substituent is oxo (i.e., ═O), then two hydrogens on the atom are replaced. The substituent group can be any substituent group described herein. For example, substituent groups can include one or more of a hydroxyl, an amino (e.g., primary, secondary, or tertiary), an aldehyde, a carboxylic acid, an ester, an amide, a ketone, nitro, an urea, a guanidine, cyano, fluoroalkyl (e.g., trifluoromethane), halo (e.g., fluoro), aryl (e.g., phenyl), heterocyclyl or heterocyclic group (i.e., cyclic group, e.g., aromatic (e.g., heteroaryl) or non-aromatic where the cyclic group has one or more heteroatoms), oxo, or combinations thereof. Combinations of substituents and/or variables are permissible provided that the substitutions do not significantly adversely affect synthesis or use of the compound.

As used herein, the term “derivative” refers to a compound wherein an atom or functional group is replaced by another atom or functional group (e.g., a substituent function group as also described below), including, but not limited to: a hydrogen, a halogen or halide, an alkyl, a cycloalkyl, an aryl, a heteroaryl, an acyl, an alkoxy, an alkenyl, an alkynyl, an alkylaryl, an arylene, a heteroarylene, an alkenylene, a cycloalkenylene, an alkynylene, a hydroxyl (—OH), a carbonyl (RCOR′), a sulfide (e.g., RSR′), a phosphate (ROP(═O)(OH)₂), an azo (RNNR′), a cyanate (ROCN), an amine (e.g., primary, secondary, or tertiary), an imine (RC(═NH)R′), a nitrile (RCN), a pyridinyl (or pyridyl), a diamine, a triamine, an azide, a diimine, a triimine, an amide, a diimide, or an ether (ROR′); where each of R and R′ is independently a hydrogen or a substituted or unsubstituted alkyl group, aryl group, alkenyl group, or a combination of these. Optional substituent functional groups are also described below. Preferably, the term “derivative” refers to a compound wherein one or two atoms or functional groups are independently replaced by another atom or functional group. Preferably, the term derivative does not refer to or include replacement of a chalcogen atom (S, Se) that is a member of a heterocyclic group. Preferably, the term derivative does not refer to or include replacement of a chalcogen atom (S, Se) nor a N (nitrogen) where the chalcogen atom and the N are members same heterocyclic group. Preferably, but not necessarily, the term derivative does not include breaking a ring structure, replacement of a ring member, or removal of a ring member.

Unless otherwise specified, the term “average molecular weight,” refers to number average molecular weight. Number average molecular weight is the defined as the total weight of a sample volume divided by the number of molecules within the sample. As is customary and well known in the art, peak average molecular weight and weight average molecular weight may also be used to characterize the molecular weight of the distribution of polymers within a sample.

As is customary and well known in the art, hydrogen atoms in formulas presented throughout herein are not necessarily always explicitly shown, for example, hydrogen atoms bonded to the carbon atoms of aromatic, heteroaromatic, and alicyclic rings are not always explicitly shown in formulas presented herein. The structures provided herein, for example in the context of the description of formulas just listed and schematics and structures in the drawings, are intended to convey to one of reasonable skill in the art the chemical composition of compounds of the methods and compositions of the invention, and as will be understood by one of skill in the art, the structures provided do not indicate the specific positions and/or orientations of atoms and the corresponding bond angles between atoms of these compounds.

As used herein, the terms “alkylene” and “alkylene group” are used synonymously and refer to a divalent group derived from an alkyl group as defined herein. The invention includes compounds having one or more alkylene groups. Alkylene groups in some compounds function as linking and/or spacer groups. Compounds of the invention may have substituted and/or unsubstituted C₁-C₂₀ alkylene, C₁-C₁₀ alkylene and C₁-C₅ alkylene groups, for example, as one or more linking groups (e.g. L¹-L²).

As used herein, the terms “cycloalkylene” and “cycloalkylene group” are used synonymously and refer to a divalent group derived from a cycloalkyl group as defined herein. The invention includes compounds having one or more cycloalkylene groups. Cycloalkyl groups in some compounds function as linking and/or spacer groups. Compounds of the invention may have substituted and/or unsubstituted C₃-C₂₀ cycloalkylene, C₃-C₁₀ cycloalkylene and C₃-C₅ cycloalkylene groups, for example, as one or more linking groups (e.g. L¹-L²).

As used herein, the terms “arylene” and “arylene group” are used synonymously and refer to a divalent group derived from an aryl group as defined herein. The invention includes compounds having one or more arylene groups. In some embodiments, an arylene is a divalent group derived from an aryl group by removal of hydrogen atoms from two intra-ring carbon atoms of an aromatic ring of the aryl group. Arylene groups in some compounds function as linking and/or spacer groups. Arylene groups in some compounds function as chromophore, fluorophore, aromatic antenna, dye and/or imaging groups. Compounds of the invention include substituted and/or unsubstituted C₃-C₃₀ arylene, C₃-C₂₀ arylene, C₃-C₁₀ arylene and C₁-C₅ arylene groups, for example, as one or more linking groups (e.g. L¹-L²).

As used herein, the terms “heteroarylene” and “heteroarylene group” are used synonymously and refer to a divalent group derived from a heteroaryl group as defined herein. The invention includes compounds having one or more heteroarylene groups. In some embodiments, a heteroarylene is a divalent group derived from a heteroaryl group by removal of hydrogen atoms from two intra-ring carbon atoms or intra-ring nitrogen atoms of a heteroaromatic or aromatic ring of the heteroaryl group. Heteroarylene groups in some compounds function as linking and/or spacer groups. Heteroarylene groups in some compounds function as chromophore, aromatic antenna, fluorophore, dye and/or imaging groups. Compounds of the invention include substituted and/or unsubstituted C₃-C₃₀ heteroarylene, C₃-C₂₀ heteroarylene, C₁-C₁₀ heteroarylene and C₃-C₅ heteroarylene groups, for example, as one or more linking groups (e.g. L¹-L²).

As used herein, the terms “alkenylene” and “alkenylene group” are used synonymously and refer to a divalent group derived from an alkenyl group as defined herein. The invention includes compounds having one or more alkenylene groups. Alkenylene groups in some compounds function as linking and/or spacer groups. Compounds of the invention include substituted and/or unsubstituted C₂-C₂₀ alkenylene, C₂-C₁₀ alkenylene and C₂-C₅ alkenylene groups, for example, as one or more linking groups (e.g. L¹-L²).

As used herein, the terms “cycloalkenylene” and “cycloalkenylene group” are used synonymously and refer to a divalent group derived from a cycloalkenyl group as defined herein. The invention includes compounds having one or more cycloalkenylene groups. Cycloalkenylene groups in some compounds function as linking and/or spacer groups. Compounds of the invention include substituted and/or unsubstituted C₃-C₂₀ cycloalkenylene, C₃-C₁₀ cycloalkenylene and C₃-C₅ cycloalkenylene groups, for example, as one or more linking groups (e.g. L¹-L²).

As used herein, the terms “alkynylene” and “alkynylene group” are used synonymously and refer to a divalent group derived from an alkynyl group as defined herein. The invention includes compounds having one or more alkynylene groups. Alkynylene groups in some compounds function as linking and/or spacer groups. Compounds of the invention include substituted and/or unsubstituted C₂-C₂₀ alkynylene, C₂-C₁₀ alkynylene and C₂-C₅ alkynylene groups, for example, as one or more linking groups (e.g. L¹-L²).

As used herein, the term “halo” refers to a halogen group such as a fluoro (—F), chloro (—Cl), bromo (—Br), iodo (—I) or astato (—At).

The term “heterocyclic” refers to ring structures containing at least one other kind of atom, in addition to carbon, in the ring. Examples of such heteroatoms include nitrogen, oxygen and sulfur. Heterocyclic rings include heterocyclic alicyclic rings and heterocyclic aromatic rings. Examples of heterocyclic rings include, but are not limited to, pyrrolidinyl, piperidyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, triazolyl and tetrazolyl groups. Atoms of heterocyclic rings can be bonded to a wide range of other atoms and functional groups, for example, provided as substituents.

The term “carbocyclic” refers to ring structures containing only carbon atoms in the ring. Carbon atoms of carbocyclic rings can be bonded to a wide range of other atoms and functional groups, for example, provided as substituents.

The term “alicyclic ring” refers to a ring, or plurality of fused rings, that is not an aromatic ring. Alicyclic rings include both carbocyclic and heterocyclic rings.

The term “aromatic ring” refers to a ring, or a plurality of fused rings, that includes at least one aromatic ring group. The term aromatic ring includes aromatic rings comprising carbon, hydrogen and heteroatoms. Aromatic ring includes carbocyclic and heterocyclic aromatic rings. Aromatic rings are components of aryl groups.

The term “fused ring” or “fused ring structure” refers to a plurality of alicyclic and/or aromatic rings provided in a fused ring configuration, such as fused rings that share at least two intra ring carbon atoms and/or heteroatoms.

As used herein, the term “alkoxyalkyl” refers to a substituent of the formula alkyl-O-alkyl.

As used herein, the term “polyhydroxyalkyl” refers to a substituent having from 2 to 12 carbon atoms and from 2 to 5 hydroxyl groups, such as the 2,3-dihydroxypropyl, 2,3,4-trihydroxybutyl or 2,3,4,5-tetrahydroxypentyl residue.

As used herein, the term “polyalkoxyalkyl” refers to a substituent of the formula alkyl-(alkoxy)ₙ-alkoxy wherein n is an integer from 1 to 10, preferably 1 to 4, and more preferably for some embodiments 1 to 3.

Amino acids include glycine, alanine, valine, leucine, isoleucine, methionine, proline, phenylalanine, tryptophan, asparagine, glutamine, glycine, serine, threonine, serine, rhreonine, asparagine, glutamine, tyrosine, cysteine, lysine, arginine, histidine, aspartic acid and glutamic acid. As used herein, reference to “a side chain residue of a natural α-amino acid” specifically includes the side chains of the above-referenced amino acids. Peptides are comprised of two or more amino acids connected via peptide bonds.

Alkyl groups include straight-chain, branched and cyclic alkyl groups. Alkyl groups include those having from 1 to 30 carbon atoms. Alkyl groups include small alkyl groups having 1 to 3 carbon atoms. Alkyl groups include medium length alkyl groups having from 4-10 carbon atoms. Alkyl groups include long alkyl groups having more than 10 carbon atoms, particularly those having 10-30 carbon atoms. The term cycloalkyl specifically refers to an alky group having a ring structure such as ring structure comprising 3-30 carbon atoms, optionally 3-20 carbon atoms and optionally 2-10 carbon atoms, including an alkyl group having one or more rings. Cycloalkyl groups include those having a 3-, 4-, 5-, 6-, 7-, 8-, 9- or 10-member carbon ring(s) and particularly those having a 3-, 4-, 5-, 6-, or 7-member ring(s). The carbon rings in cycloalkyl groups can also carry alkyl groups. Cycloalkyl groups can include bicyclic and tricycloalkyl groups. Alkyl groups are optionally substituted. Substituted alkyl groups include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Substituted alkyl groups include fully halogenated or semihalogenated alkyl groups, such as alkyl groups having one or more hydrogens replaced with one or more fluorine atoms, chlorine atoms, bromine atoms and/or iodine atoms. Substituted alkyl groups include fully fluorinated or semifluorinated alkyl groups, such as alkyl groups having one or more hydrogens replaced with one or more fluorine atoms. An alkoxy group is an alkyl group that has been modified by linkage to oxygen and can be represented by the formula R—O and can also be referred to as an alkyl ether group. Examples of alkoxy groups include, but are not limited to, methoxy, ethoxy, propoxy, butoxy and heptoxy. Alkoxy groups include substituted alkoxy groups wherein the alky portion of the groups is substituted as provided herein in connection with the description of alkyl groups. As used herein MeO— refers to CH₃O—. Compositions of some embodiments of the invention comprise alkyl groups as terminating groups, such as polymer backbone terminating groups and/or polymer side chain terminating groups.

Alkenyl groups include straight-chain, branched and cyclic alkenyl groups. Alkenyl groups include those having 1, 2 or more double bonds and those in which two or more of the double bonds are conjugated double bonds. Alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those in which a double bond is in the ring or in an alkenyl group attached to a ring. The term cycloalkenyl specifically refers to an alkenyl group having a ring structure, including an alkenyl group having a 3-, 4-, 5-, 6-, 7-, 8-, 9- or 10-member carbon ring(s) and particularly those having a 3-, 4-, 5-, 6- or 7-member ring(s). The carbon rings in cycloalkenyl groups can also carry alkyl groups. Cycloalkenyl groups can include bicyclic and tricyclic alkenyl groups. Alkenyl groups are optionally substituted. Substituted alkenyl groups include among others those which are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogen atoms replaced with one or more fluorine atoms. Compositions of some embodiments of the invention comprise alkenyl groups as terminating groups, such as polymer backbone terminating groups and/or polymer side chain terminating groups.

Aryl groups include groups having one or more 5-, 6- or 7-member aromatic rings, including heterocyclic aromatic rings. The term heteroaryl specifically refers to aryl groups having at least one 5-, 6- or 7-member heterocyclic aromatic rings. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, or S atoms in the ring. Heterocyclic aromatic rings can include those with one, two or three N atoms, those with one or two O atoms, and those with one or two S atoms, or combinations of one or two or three N, O or S atoms. Aryl groups are optionally substituted. Substituted aryl groups include among others those which are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocyclic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent and polyvalent groups, of the aromatic and heterocyclic aromatic groups listed herein are provided in a covalently attached configuration in the compounds of the invention at any suitable point of attachment. In embodiments, aryl groups contain between 5 and 30 carbon atoms. In embodiments, aryl groups contain one aromatic or heteroaromatic six-membered ring and one or more additional five- or six-membered aromatic or heteroaromatic ring. In embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents. Compositions of some embodiments of the invention comprise aryl groups as terminating groups, such as polymer backbone terminating groups and/or polymer side chain terminating groups. As used herein “-(phenyl)” refers to a monovalent phenyl group bonded with another group, element, or compound.

Arylalkyl groups are alkyl groups substituted with one or more aryl groups wherein the alkyl groups optionally carry additional substituents and the aryl groups are optionally substituted. Specific alkylaryl groups are phenyl-substituted alkyl groups, e.g., phenylmethyl groups. Alkylaryl groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl groups having one or more hydrogens replaced with one or more fluorine atoms, chlorine atoms, bromine atoms and/or iodine atoms. Compositions of some embodiments of the invention comprise arylalkyl groups as terminating groups, such as polymer backbone terminating groups and/or polymer side chain terminating groups.

As to any of the groups described herein which contain one or more substituents, it is understood that such groups do not contain any substitution or substitution patterns which are sterically impractical and/or synthetically non-feasible. Optional substitution of alkyl groups includes substitution with one or more alkenyl groups, aryl groups or both, wherein the alkenyl groups or aryl groups are optionally substituted. Optional substitution of alkenyl groups includes substitution with one or more alkyl groups, aryl groups, or both, wherein the alkyl groups or aryl groups are optionally substituted. Optional substitution of aryl groups includes substitution of the aryl ring with one or more alkyl groups, alkenyl groups, or both, wherein the alkyl groups or alkenyl groups are optionally substituted.

Optional substituents for any alkyl, alkenyl and aryl group includes substitution with one or more of the following substituents, among others:
halogen, including fluorine, chlorine, bromine or iodine;
pseudohalides, including —CN;
—COOR where R is a hydrogen or an alkyl group or an aryl group and more specifically where R is a methyl, ethyl, propyl, butyl, or phenyl group all of which groups are optionally substituted;
—COR where R is a hydrogen or an alkyl group or an aryl group and more specifically where R is a methyl, ethyl, propyl, butyl, or phenyl group all of which groups are optionally substituted;
—CON(R)₂ where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—OCON(R)₂ where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—N(R)₂ where each R, independently of each other R, is a hydrogen, or an alkyl group, or an acyl group or an aryl group and more specifically where R is a methyl, ethyl, propyl, butyl, phenyl or acetyl group, all of which are optionally substituted; and where R and R can form a ring which can contain one or more double bonds and can contain one or more additional carbon atoms;
—SR, where R is hydrogen or an alkyl group or an aryl group and more specifically where R is hydrogen, methyl, ethyl, propyl, butyl, or a phenyl group, which are optionally substituted;
—SO₂R, or —SOR where R is an alkyl group or an aryl group and more specifically where R is a methyl, ethyl, propyl, butyl, or phenyl group, all of which are optionally substituted;
—OCOOR where R is an alkyl group or an aryl group;
—SO₂N(R)₂ where each R, independently of each other R, is a hydrogen, or an alkyl group, or an aryl group all of which are optionally substituted and wherein R and R can form a ring which can contain one or more double bonds and can contain one or more additional carbon atoms; and
—OR where R is H, an alkyl group, an aryl group, or an acyl group all of which are optionally substituted. In a particular example R can be an acyl yielding —OCOR″ where R″ is a hydrogen or an alkyl group or an aryl group and more specifically where R″ is methyl, ethyl, propyl, butyl, or phenyl groups all of which groups are optionally substituted.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups which contain one or more substituents, it is understood that such groups do not contain any substitution or substitution patterns which are sterically impractical and/or synthetically non-feasible.

Certain compounds of the present invention possess asymmetric carbon atoms (optical or chiral centers) or double bonds; the enantiomers, racemates, diastereomers, tautomers, geometric isomers, stereoisometric forms that may be defined, in terms of absolute stereochemistry, as (R)- or (S)- or, as D- or L- for amino acids, and individual isomers are encompassed within the scope of the present invention. The compounds of the present invention do not include those which are known in art to be too unstable to synthesize and/or isolate. The present invention is meant to include compounds in racemic and optically pure forms. Optically active (R)- and (S)-, or D- or L-isomers may be prepared using chiral synthons or chiral reagents, or resolved using conventional techniques. When the compounds described herein contain olefinic bonds or other centers of geometric asymmetry, and unless specified otherwise, it is intended that the compounds include both E and Z geometric isomers.

Many of the molecules disclosed herein contain one or more ionizable groups. Ionizable groups include groups from which a proton can be removed (e.g., —COOH) or added (e.g., amines) and groups that can be quaternized (e.g., amines). All possible ionic forms of such molecules and salts thereof are intended to be included individually in the disclosure herein. With regard to salts of the compounds herein, one of ordinary skill in the art can select from among a wide variety of available counterions that are appropriate for preparation of salts of this invention for a given application. In specific applications, the selection of a given anion or cation for preparation of a salt can result in increased or decreased solubility of that salt.

As used herein, the term “isomers” refers to compounds having the same number and kind of atoms, and hence the same molecular weight, but differing in respect to the structural arrangement or configuration of the atoms. Isomers include structural isomers and stereoisomers such as enantiomers.

The term “tautomer,” as used herein, refers to one of two or more structural isomers which exist in equilibrium and which are readily converted from one isomeric form to another. It will be apparent to one skilled in the art that certain compounds of this invention may exist in tautomeric forms, all such tautomeric forms of the compounds being within the scope of the invention.

Unless otherwise stated, structures depicted herein are also meant to include all stereochemical forms of the structure; i.e., the R and S configurations for each asymmetric center. Therefore, single stereochemical isomers as well as enantiomeric and diastereomeric mixtures of the present compounds are within the scope of the invention.

Unless otherwise stated, structures depicted herein are also meant to include compounds which differ only in the presence of one or more isotopically enriched atoms. For example, compounds having the present structures except for the replacement of a hydrogen by a deuterium or tritium, or the replacement of a carbon by ¹³C- or ¹⁴C-enriched carbon are within the scope of this invention.

The compounds of the present invention may also contain unnatural proportions of atomic isotopes at one or more of the atoms that constitute such compounds. For example, the compounds may be radiolabeled with radioactive isotopes, such as for example tritium (³H), iodine-125 (¹²⁵I), or carbon-14 (¹⁴C). All isotopic variations of the compounds of the present invention, whether radioactive or not, are encompassed

As would be understood by one of skill in the art, “N(CH₃)” refers N attached to an methyl group (also abbreviated in art as “NMe”) and may also be represented as N—(CH₃), or —N(CH₃)— where the N is attached to two other groups or elements besides the methyl group. As would be understood by one of skill in the art, “N(C₂H₆)” refers to N attached to an ethyl group (also abbreviated in art as “NEt”) and may also be represented as N—(C₂H₆), or —N(C₂H₆)— where the N is attached to two other groups or elements besides the ethyl group.

Where substituent groups are specified by their conventional chemical formulae, written from left to right, they equally encompass the chemically identical substituents that would result from writing the structure from right to left, e.g., —CH₂O— is equivalent to —OCH₂—.

Where used, a bond represented by “ [symbol] ” (a squiggly or wavy line) and drawn between any two elements, groups, or species refers to a bond having any angle or geometry, such as in the case of a chemical species exhibiting stereochemistry such as chirality. For example, the compound characterized by formula (FX100):

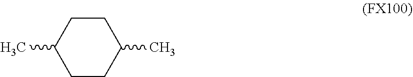

may correspond to one or more compounds, such as those characterized by the formulas (FX100a), (FX100b), (FX100c), and (FX100d):

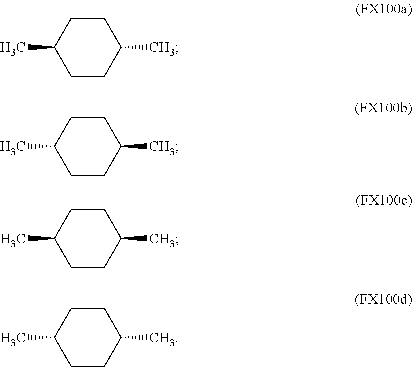

It must also be noted that a bond represented as a non-wavy or non-squiggly line, such as a “ [symbol] ”, may exhibit more than one stereochemical configuration, such as chirality. In other words, the compound characterized by formula (FX100e):

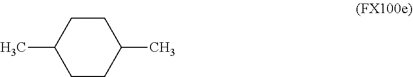

may correspond to one or more compounds, such as those characterized by the formulas (FX100a), (FX100b), (FX100c), and (FX100d).

When referring to a material being aqueous, the term “aqueous” refers to said material being dispersed, dissolved, or otherwise solvated by water. An “aqueous solution” refers to a solution that comprises water as solvent and one or more solute species dispersed, dissolved, or otherwise solvated by the water. An aqueous process, such as a polymerization, is a process taking place in an aqueous solution. Optionally, but not necessarily, an aqueous solution or an aqueous solvent includes 20 vol. % or less, optionally 15 vol. % or less, optionally 10 vol. % or less, preferably 5 vol. % or less, of a non-water or organic species. Optionally, but not necessarily, an aqueous solution or an aqueous solvent includes 20 vol. % or less, optionally 15 vol. % or less, optionally 10 vol. % or less, preferably 5 vol. % or less, of a non-water liquid.

The term “±” refers to an inclusive range of values, such that “X±Y,” wherein each of X and Y is independently a number, refers to an inclusive range of values selected from the range of X−Y to X+Y. In the cases of “X±Y” wherein Y is a percentage (e.g., 1.0±20%), the inclusive range of values is selected from the range of X−Z to X+Z, wherein Z is equal to X·(Y/100). For example, 1.0±20% refers to the inclusive range of values selected from the range of 0.8 to 1.2.

The term “and/or” is used herein, in the description and in the claims, to refer to a single element alone or any combination of elements from the list in which the term and/or appears.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

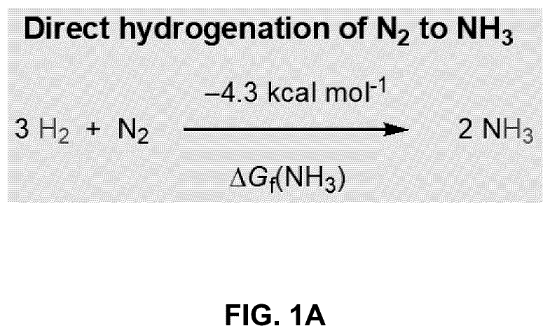

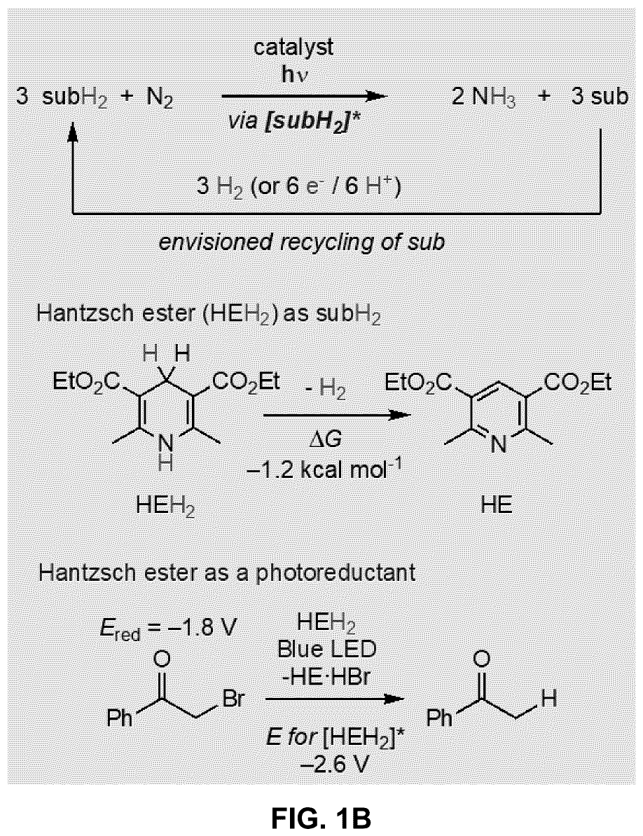

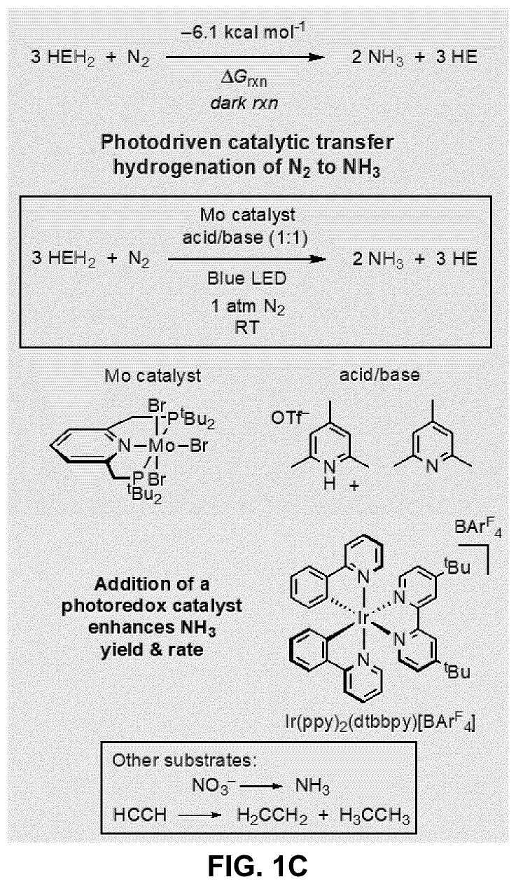

Multi-electron reductive transformations of small molecule substrates (e.g., N₂, CO₂, NO₃) are challenging to mediate in homogeneous catalysis and most typically require considerable energy input via harsh chemical reagents and/or conditions to be driven forward. The nitrogen reduction reaction (N₂RR) offers a case in point, substantial progress has now been made in molecular catalyst design but significant overpotentials are generally needed to observe NH₃ product.(1,2,3). For nitrogen reduction (N₂R), kinetic challenges also prevail for enzymatic and heterogeneous catalysis that require substantial energy inputs, via ATP hydrolysis for the former and high temperature and pressure or electrochemical overpotential for the latter, (4,5,6) despite a thermally favorable Gibbs free energy of formation, ΔG_{f}(NH₃) (FIG. 1A).

The organometallic catalysis field has pursued photochemical strategies as a means of driving small molecule reductions, with considerable success being achieved for CO₂ reduction (CO₂R, typically by 2e⁻/2 H⁺) as the target transformation.(7,8) Such strategies are still challenged by the widespread use of sacrificial donors whose oxidation products are not readily recycled. While design schemes are envisaged to someday couple photodriven CO₂R catalysis with water oxidation, photodriven transfer hydrogenation using a suitable precatalyst offers an approach to reductive small molecule catalysis, especially if the net H₂-donor (subH₂; FIG. 1B) derives from a structure than can be efficiently recycled, for example via hydrogenation or electrochemically.

Inspired by momentum in applications of reductive photoredox catalysis to organic synthesis, photodriven transfer hydrogenations towards deep (>2e⁻) reductions of small molecules are attractive compared to using harsh chemical reagents. Significant in this context is the nitrogen reduction reaction (N₂RR), where a synthetic photocatalyst system does not appear to have yet been developed prior to this disclosure.

Reduced Hantzsch esters (HEH₂, FIG. 1B) and chemically related structures (e.g., reduced acridine, phenanthridine) have been explored for thermally and photochemically driven reductive hydride (H⁻; NADH-like) and H-atom transfers in organic synthesis.(9) Moreover, they are highlighted for their chemical (and electrochemical) recyclability via net hydrogenation of the spent pyridine-type oxidation product.(10,11) Whereas the types of transformations they participate in are most typically two-electron processes, they are also tempting to explore for deeper multi-electron reductions of the type pursued in small molecule reductive catalysis. Focusing on N₂R,(12) we noted that despite long known and still debated studies of photocatalytic nitrogen fixation using semiconductors,(13,14,15) and photodriven N₂R mediated by nitrogenase coupled with CdS,(16,17) as yet there were no examples of photochemically driven catalytic N₂R using well-defined molecular systems. Hence, photoinduced N₂R via transfer hydrogenation from a Hantzsch ester or related donor, which requires the donors to engage in successive transfers to mediate a deep 6e⁻/6 H⁺ reduction process, provides an excellent test case of this strategy for small molecule substrates.

A reduced Hantzsch ester (HEH₂), and related organic structures, can behave as 2e⁻/2 H⁺ photoreductants, when partnered with a suitable catalyst (e.g., Mo-containing catalyst) under light irradiation (e.g., blue light). HEH₂ facilitates delivery of successive H₂-equivalents for the 6e⁻/6 H⁺ catalytic reduction of N₂ to NH₃. This catalysis is optionally enhanced by addition of a photoredox catalyst (e.g., Ir-containing photocatalyst or photosensitizer). Therefore, a useful example of hydrogenation processes disclosed herein is the photoinduced Mo-catalyzed transfer hydrogenation of nitrogen to ammonia from a reduced Hantzsch ester (HEH₂), which is demonstrated herein both with and without a photoredox catalyst. Reductions of additional substrates, such as but not limited to nitrate and acetylene, are also disclosed herein. The photodriven hydrogenation processes disclosed herein are not limited to the aforementioned reagents, however, as other reagents, including transfer agents, catalysts, and substrates, are disclosed herein as well, such as those provided in the following exemplary aspects.

### Certain Exemplary Aspects and Embodiments:

Various aspects are contemplated (i.e., contemplated and disclosed) herein, several of which are set forth in the paragraphs below. It is explicitly contemplated that any aspect or portion thereof can be combined to form an aspect. In addition, it is explicitly contemplated that: any reference to Aspect 1 includes reference to Aspects 1a, 1b, 1c, 1d, 1e, and/or 1f, etc., and any combination thereof; any reference to Aspect 10 includes reference to Aspects 13a, 13b, 13c, 13d, 13e, 13f, and/or 13g, and so on (any reference to an aspect includes reference to that aspect's lettered versions). Moreover, the terms “any preceding aspect” and “any one of the preceding aspects” means any aspect that appears prior to the aspect that contains such phrase (for example, the sentence “Aspect 32: The method or system of any preceding aspect . . . ” means that any aspect prior to aspect 32 is referenced, including letter versions, including aspects 1a through 31). For example, it is contemplated that, optionally, any material, method, or device of any the below aspects may be useful with or combined with any other aspect provided below. Further, for example, it is contemplated that any embodiment or aspect described above may, optionally, be combined with any of the below listed aspects.

Aspect 1a: A method for photodriven hydrogenation of N₂, the method comprising:
hydrogenating N₂ to NH₃ in the presence of a light, a phototransfer agent (optionally organic phototransfer agent), and a first metal-containing catalyst;
wherein the phototransfer agent and the first catalyst are in contact with a solution or in the solution;
wherein the light is characterized by energy sufficient to photoexcite the phototransfer agent from a first state to an excited state thereof;
wherein the phototransfer agent comprises n chemically transferable electrons and protons, n being an integer equal to or greater than 1; and
the step of hydrogenating comprises at least one charge-transfer reaction (optionally a plurality of charge-transfer reactions) via which the phototransfer agent donates at least one electron and at least one proton to one or more other chemical species.

Aspect 1b: A method for photodriven hydrogenation of N₂, the method comprising:
hydrogenating N₂ to NH₃ in the presence of a light, a transfer agent (optionally organic phototransfer agent), and a first metal-containing catalyst;
wherein:
the transfer agent and the first catalyst are in contact with a solution or in the solution;
the transfer agent comprises n chemically transferable electrons and protons, n being an integer equal to or greater than 1;
the step of hydrogenating comprises at least one charge-transfer reaction (optionally a plurality of charge-transfer reactions) via which the transfer agent donates at least one electron and at least one proton to one or more other chemical species;
the step of hydrogenating comprises at least one photochemical reaction; and
the light is characterized by energy sufficient to drive the at least one photochemical reaction.

Aspect 1c: A method for photodriven hydrogenation of a starting chemical species, the method comprising:
hydrogenating a starting chemical species to one or more hydrogenated product species in the presence of a light, an organic transfer agent, and a first metal-containing catalyst;
wherein:
the transfer agent, the first catalyst, and the starting chemical species are in contact with a solution or in the solution;
the transfer agent comprises n chemically transferable electrons and protons, n being an integer equal to or greater than 1;
the step of hydrogenating comprises at least one charge-transfer reaction (optionally a plurality of charge-transfer reactions) via which the transfer agent donates at least one electron and at least one proton to one or more other chemical species;
the step of hydrogenating comprises at least one photochemical reaction; and the light is characterized by energy sufficient to drive the at least one photochemical reaction.

Aspect 1d: A method of hydrogenation of N₂, the method comprising:
hydrogenating N₂ to NH₃ in the presence of a light, a transfer agent (optionally organic transfer agent), and a first metal-containing catalyst; and regenerating the spent-transfer agent back into the transfer agent;
wherein:
wherein hydrogenation of N₂ to NH₃ comprises oxidation of the transfer agent to the spent-transfer agent;
the transfer agent and the first catalyst are in contact with a solution or in the solution;
the transfer agent comprises n chemically transferable electrons and protons, n being an integer equal to or greater than 1;
the step of hydrogenating comprises at least one charge-transfer reaction (optionally a plurality of charge-transfer reactions) via which the transfer agent donates at least one electron and at least one proton to one or more other chemical species;
the light is characterized by energy sufficient to photoexcite the transfer agent from a first state to an excited state thereof.

Aspect 1e: A method of hydrogenation of N₂, the method comprising:
hydrogenating a starting chemical species to one or more hydrogenated product species in the presence of a light, a transfer agent (optionally organic transfer agent), and a first metal-containing catalyst; and regenerating the spent-transfer agent back into the transfer agent;
wherein:
wherein hydrogenation of N₂ to NH₃ comprises oxidation of the transfer agent to the spent-transfer agent;
the transfer agent, the first catalyst, and the starting chemical species are in contact with a solution or in the solution;
the transfer agent comprises n chemically transferable electrons and protons, n being an integer equal to or greater than 1;
the step of hydrogenating comprises at least one charge-transfer reaction (optionally a plurality of charge-transfer reactions) via which the transfer agent donates at least one electron and at least one proton to one or more other chemical species;
the step of hydrogenating comprises at least one photochemical reaction; and
the light is characterized by energy sufficient to drive the at least one photochemical reaction.

Aspect f: The method of any of Aspects 1a-1e, wherein the step of hydrogenating, or the chemical reactions thereof, does not or cannot initiate or occur in the absence said light at about room temperature (e.g., 20° C.) and about 1 atm pressure. Aspect 1g: The method of any of Aspects 1a-1e, wherein absence of said light (e.g., turning off the light, removing the light, or removing the solution from the light) terminates or stops the hydrogenating process/step, at about room temperature (e.g., 20° C.) and about 1 atm pressure. Aspect 1h: The method of any of Aspects 1a-1g, further comprising stopping or terminating the step of hydrogenating by absenting said light.

Aspect 2: The method of Aspect 1, wherein the transfer agent is a phototransfer agent; and wherein the light is characterized by energy sufficient to photoexcite the phototransfer agent from a first state to an excited state thereof.

Aspect 3a: The method of Aspect 1, wherein the step of hydrogenating further occurs in the presence of a photosensitive cocatalyst; wherein photosensitive cocatalyst is in the solution; wherein the light is characterized by energy sufficient to photoexcite the photosensitive cocatalyst from a first state to an excited state thereof; and wherein the step of hydrogenating comprises one or more chemical reactions via which the transfer agent chemically reduces the photosensitive cocatalyst. Aspect 3b: The method of Aspect 1, wherein the step of hydrogenating further occurs in the presence of a photosensitive cocatalyst; wherein the photosensitive cocatalyst is in the solution; wherein the light is characterized by energy sufficient to photoexcite the photosensitive cocatalyst from a first state to an excited state thereof; after which the transfer agent chemically reduces the photosensitive cocatalyst to the reduced first state photosensitive cocatalyst, which subsequently reduces the first metal catalyst and any intermediates that might form during N₂ hydrogenation. Aspect 3c: wherein the step of hydrogenating further occurs in the presence of a photosensitive cocatalyst; wherein the photosensitive cocatalyst is in the solution; wherein the light is characterized by energy sufficient to photoexcite the photosensitive cocatalyst from a first state to an excited state thereof; wherein the transfer agent chemically reduces the excited state of the photosensitive cocatalyst to a reduced first state of the photosensitive cocatalyst; and wherein the reduced first state of the photosensitive cocatalyst reduces the first metal catalyst and/or one or more species comprising the first metal catalyst during N₂ hydrogenation.

Aspect 4a: The method of Aspect 3, wherein the transfer agent reductively quenches the photosensitive cocatalyst to generate a reduced photosensitive cocatalyst and/or the transfer agent reductively regenerates a ground state of the photosensitive cocatalyst. Aspect 4b: The method of Aspect 3, wherein subsequently the now oxidized first state photosensitive cocatalyst is reduced by the transfer reagent to reform the first state photosensitive cocatalyst. Aspect 4c: The method of Aspect 3, wherein the excited state of the photosensitive cocatalyst reduces the first metal catalyst and/or one or more species comprising the first metal catalyst thereby forming an oxidized first state of the photosensitive cocatalyst; and wherein the transfer agent reduces the oxidized first state of the photosensitive cocatalyst thereby regenerating the first state of the photosensitive cocatalyst.

Aspect 5: The method of any of the preceding Aspects, wherein the transfer agent comprises one or more azine groups.

Aspect 6: The method of any of the preceding Aspects, wherein the transfer agent comprises one or more pyridine groups.

Aspect 7: The method of any of the preceding Aspects, wherein the transfer agent comprises a dihydropyridine group, a hydroquinone group, and/or any derivative thereof.

Aspect 8a: The method of any of the preceding Aspects, wherein the transfer agent is or comprises a Hantzsch Ester and/or a derivative thereof. Aspect 8b: The method of any of the preceding Aspects, wherein the transfer agent is or comprises a Hantzsch Ester.

Aspect 9: The method of any of the preceding Aspects, wherein n is 1, 2, or 4.

Aspect 10: The method of any of the preceding Aspects, wherein n is 2.

Aspect 11: The method of any of the preceding Aspects, wherein the transfer agent is a combination of at least one hydride- or electron-donor species and at least one proton-donor species.

Aspect 12: The method of any of the preceding Aspects, wherein each molecule of the transfer agent comprises the n transferable electrons and protons.

Aspect 13a: The method of any of the preceding Aspects, wherein the transfer agent comprises at least one compound characterized by formula FX1, FX2, FX3, FX4, FX5, FX6, FX7, FX8, FX9A, FX9B, FX10A, FX10B, FX11, FX12A, FX12B, FX13A, FX13B, FX14A, FX14B, FX15A, FX15B, FX16A, FX16B, FX17A, FX17B, FX18A, or FX18B or any derivative thereof:

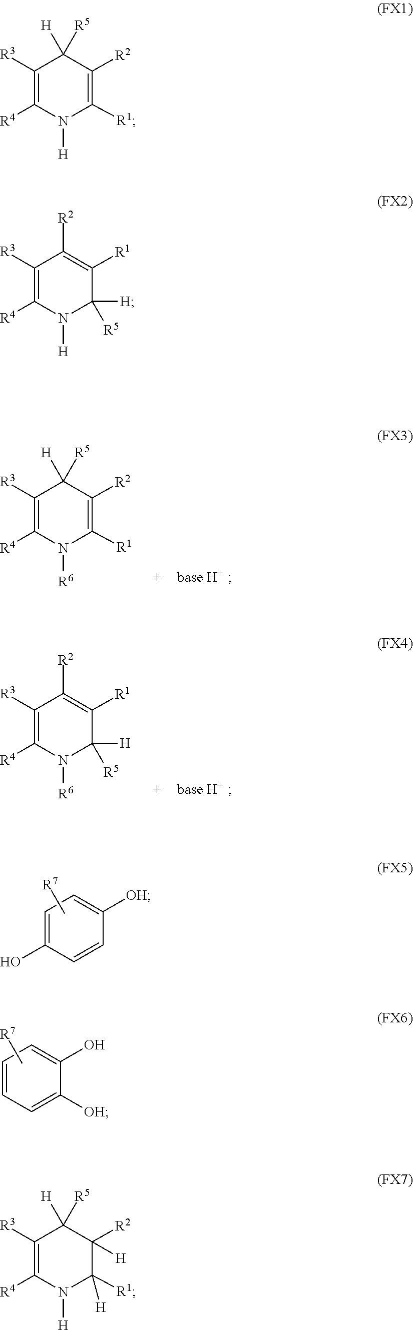

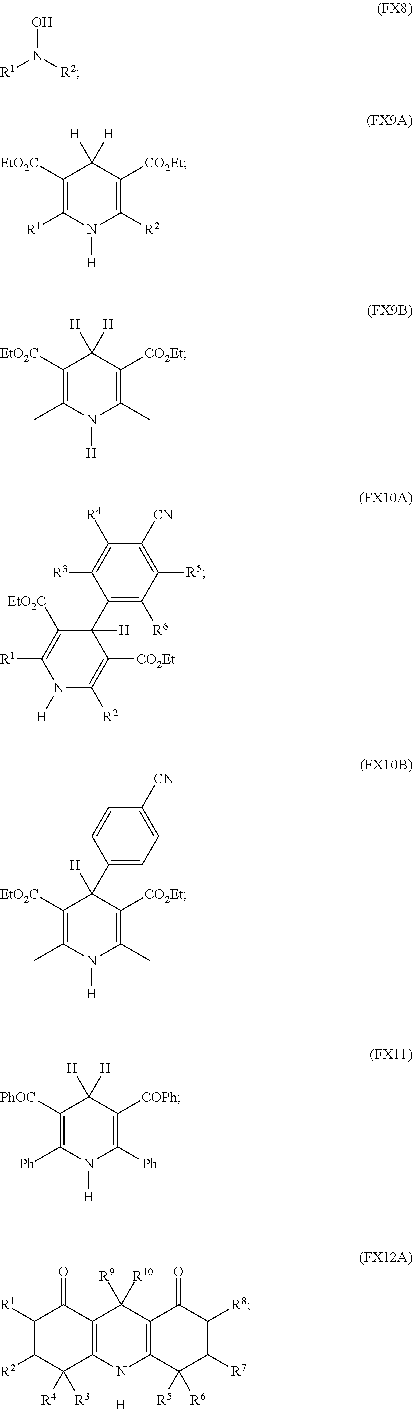

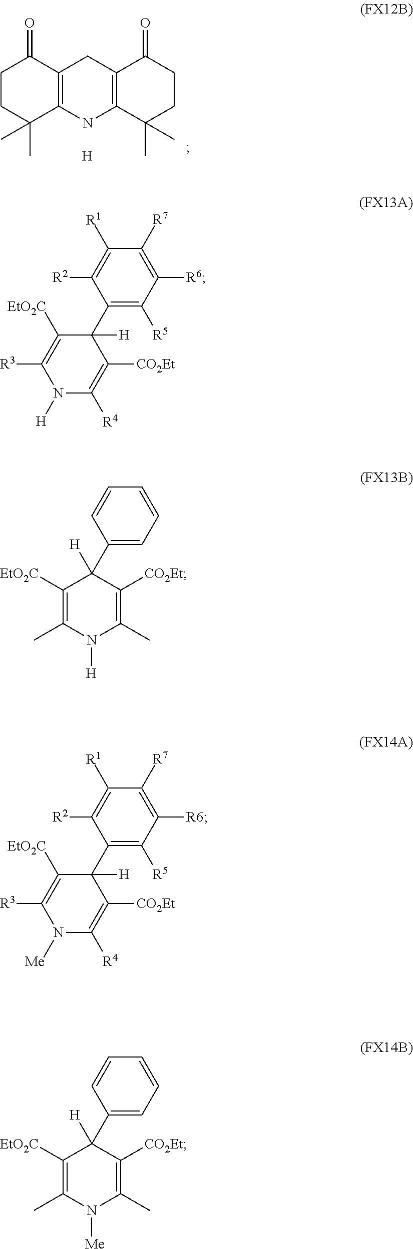

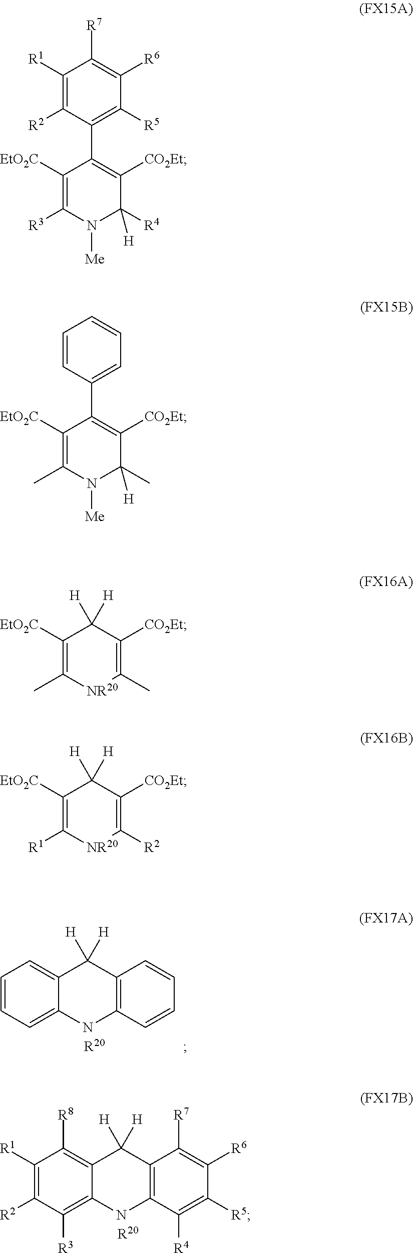

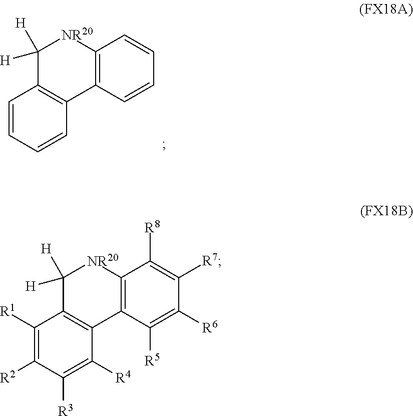

each of R₁, R₂, R₃, R₄, R₅, R₆, R₇, R₈, R₉, and R₁₀ is independently H or a monovalent functional group characterized by a molecular weight less than 400 g/mol (optionally less than 350 g/mol, optionally less than 300 g/mol, optionally less than 250 g/mol, optionally less than 200 g/mol, optionally less or equal to than 175 g/mol, optionally less or equal to than 150 g/mol, optionally less or equal to than 125 g/mol, optionally less or equal to than 100 g/mol, optionally less or equal to than 50 g/mol, optionally less or equal to than 25 g/mol); each R²⁰ is independently H or a methyl group;
each baseH+ is independently a Bronsted base;
each Et is an ethyl group;
each Me is a methyl group; and
each Ph is a phenyl group.

Aspect 13b: The method of any of the preceding Aspects, wherein the transfer agent is characterized by formula FX1, FX2, FX3, FX4, FX5, FX6, FX7, FX8, FX9A, FX9B, FX10A, FX10B, FX11, FX12A, FX12B, FX13A, FX13B, FX14A, FX14B, FX15A, FX15B, FX16A, FX16B, FX17A, FX17B, FX18A, or FX18B or any derivative thereof.

Aspect 13c: The method of any of the preceding Aspects, wherein the transfer agent is characterized by formula FX1, FX2, FX3, FX4, FX5, FX6, FX7, FX8, FX9A, FX9B, FX10A, FX10B, FX11, FX12A, FX12B, FX13A, FX13B, FX14A, FX14B, FX15A, FX15B, FX16A, FX16B, FX17A, FX17B, FX18A, or FX18B. Aspect 13d: The method of any of Aspects 10a-10c, wherein each of R₁, R₂, R₃, R₄, R₅, R₆, R₇, R₈, R₉, and R₁₀ is independently H or a substituted or unsubstituted functional group selected from the group consisting of an alkyl, an aromatic, a carbonyl, an ester, a ketone, an aldehyde, an amide, a carboxylic acid, an alcohol, a halide, a nitro group, an amine, a primary amine, a secondary amine, a tertiary amine, an ether, a heterocycle, a nitrile, a sulfonate, a thiol, a sulfoxide, and any combination thereof. Aspect 13e: The method of any of Aspects 10a-10c, wherein each of R₁, R₂, R₃, R₄, R₅, R₆, R₇, R₈, R₉, and R₁₀ is independently H, a halogen, or a substituted or unsubstituted functional group selected from the group consisting of: alkyl group, aryl group, cycloalkyl group, aryl group, heteroaryl group, hydroxyl group, alkoxy group, alkenyl group, acyl group, hydrocarbyl group, alkynyl group, alkynyl group, alkylaryl group, halocarbon group, thiol group, amine group, amide group, aminyl group, phosphorous-containing group, silicon-containing group, a boron-containing group, pyridinium, and any combination of these. Aspect 13f: The method of any of Aspects 10a-10c, wherein each of R₁, R₂, R₃, R₄, R₅, R₆, R₇, R₈, R₉, and R₁₀ is independently H, a halogen, or a substituted or unsubstituted functional group selected from the group consisting of: C₁-C₃₀ alkyl, C₃-C₃₀ cycloalkyl, C₅-C₃₀ aryl, C₅-C₃₀ heteroaryl, C₁-C₃₀ acyl, C₁-C₃₀ hydroxyl, C₁-C₃₀ alkoxy, C₂-C₃₀ alkenyl, C₂-C₃₀ alkynyl, C₅-C₃₀ alkylaryl, —CO₂R⁷⁰, —CONR⁷¹R⁷², —COR⁷³, SOR⁷⁴, —OSR⁷⁵, —SO₂R⁷⁶, —OR⁷⁷, —SR⁷⁸, —NR⁷⁹R⁸⁰, —NR⁸¹COR⁸², C₁-C₃₀ alkyl halide, phosphonate, phosphonic acid, silane, siloxane, silsesquioxane, C₂-C₃₀ halocarbon chain, pyrdinium, substituted pyridinium, or any combination thereof; each of R⁷⁰-R⁸² is independently a H, C₅-C₁₀ aryl, or C₁-C₁₀ alkyl, and any combination of these. Aspect 13g: The method of any of Aspects 10a-10c, wherein each of R₁, R₂, R₃, R₄, R₅, R₆, R₇, R₈, R₉, and R₁₀ is independently a hydrogen, a halogen, or a substituted or unsubstituted C₁-C₅ alkyl. Aspect 13h: The method of any of Aspects 10a-10c, wherein each of R₁, R₂, R₃, R₄, R₅, R₆, R₇, R₈, R₉, and R₁₀ is independently H or a substituted or unsubstituted functional group selected from the group consisting of an alkyl, an aromatic, a carbonyl, an ester, a ketone, an aldehyde, an amide, a carboxylic acid, an alcohol, a halide, an amine, a primary amine, a secondary amine, a tertiary amine, an ether, a heterocycle, a nitrile, a sulfonate, a thiol, a sulfoxide, and any combination thereof.

Aspect 14: The method of Aspect 13, wherein each of R₁, R₂, R₃, R₄, R₅, R₆, R₇, R₈, R₉, and R₁₀ is independently not an alkyne group nor a nitro group.

Aspect 15a: The method of any of the preceding Aspects, wherein the step of hydrogenating is characterized by an overall reaction comprising a 3:1 ratio of transfer agent to starting species and a 3:2 ratio of transfer agent to hydrogenated product. Aspect 15b: The method of any of the preceding Aspects, wherein the step of hydrogenating is characterized by an overall reaction comprising a 3:1 ratio of transfer agent to N₂ and a 3:2 ratio of transfer agent to produced NH₃.

Aspect 16: The method of any of the preceding Aspects, wherein the step of hydrogenating comprises a sequence of reactions, the sequence of reactions comprising at least two intermediate reactions comprising transfer of at least a proton from the transfer agent.

Aspect 17: The method of any of the preceding Aspects, wherein the step of hydrogenating is characterized by an overall reaction characterized by equation EQ1:

3(subH₂)+N₂→2NH₃+3(sub) (EQ1); wherein:
subH₂ is the transfer agent characterized by n being 2; and
sub is a spent-transfer agent, being the transfer agent after donating two protons and two electrons.

Aspect 18a: The method of any of the preceding Aspects, wherein the transfer agent has a concentration in the solution selected from the range of 1 mM to 10 M, and wherein each value and range of therebetween is explicitly contemplated and disclosed herein inclusively. Aspect 18b: The method of any of the preceding Aspects, wherein the transfer agent has a concentration in the solution selected from the range of 0.5 mM (optionally 0.8 mM, optionally 1 mM, optionally 1.5 mM, optionally 2 mM, optionally 5 mM, optionally 8 mM, optionally 10 mM, optionally 15 mM, optionally 20 mM, optionally 25 mM, optionally 30 mM, optionally 35 mM, optionally 40 mM, optionally 45 mM, optionally 50 mM, optionally 55 mM, optionally 60 mM, optionally 65 mM, optionally 70 mM, optionally 75 mM, optionally 80 mM, optionally 85 mM, optionally 90 mM, optionally 95 mM, optionally 100 mM) to 10 M (optionally 9 M, optionally 8 M, optionally 7 M, optionally 6 M, optionally 5 M, optionally 4 M, optionally 3 M, optionally 2 M, optionally 1 M, optionally 0.9 M, optionally 0.7 M, optionally 0.5 M, optionally 0.3 M).

Aspect 19: The method of any of the preceding Aspects, wherein the solution comprises (e.g., initially, in absence of the first metal-containing catalyst) a pre-catalyst that is converted to the first metal-containing catalyst during the step of hydrogenating.

Aspect 20a: The method of any of the preceding Aspects, wherein the first catalyst is capable of binding dinitrogen (N₂). Aspect 20b: The method of any of the preceding Aspects, wherein the first catalyst is capable of binding two nitrogen atoms (2N).

Aspect 21: The method of any of the preceding Aspects, wherein the step of hydrogenating comprises a sequence of reactions, the sequence of reactions comprising the first catalyst binding with, independently: (N), (2N), (2N and H), (2N and 2H), (NH), (N and 3H), (2N and 3H), (2N and 4H), and/or (N and 2H). For clarity and illustration, the notation “2N” refers to two N corresponding to the first catalyst optionally binding to each N separately or binding to N₂; likewise, for non-limiting clarification and illustration, each of the notations (2N and H), (2N and 2H), (NH), (N and 3H), (2N and 3H), (2N and 4H), and/or (N and 2H) refer to the given amount N and H binding to the first catalyst without limitation with respect to the form or variation in which that many N and H atoms bind to the catalyst, where the binding may involve individual N, amine(s) (e.g., NH₂), dinitrogen (N₂), H, H₂, and/or any other variation subject to chemical/physical feasibility.

Aspect 22: The method of any of the preceding Aspects, wherein the first catalyst is a metalorganic metal-trihalide compound.

Aspect 23: The method of any of the preceding Aspects, wherein the first catalyst comprises at least one aryl and/or at least one pyridine group.

Aspect 24a: The method of any of the preceding Aspects, wherein the first catalyst comprises a metal element selected from the group consisting of Mo, W, Fe, Ru, Os, and any combination thereof. Aspect 24b: The method of any of the preceding Aspects, wherein the first catalyst comprises a metal element selected from the group consisting of Mo and W.

Aspect 25: The method of any of the preceding Aspects, wherein the first catalyst is a metalorganic compound comprising molybdenum and at least one phosphine ligand.

Aspect 26: The method of Aspect 25 comprising a step of providing one or more first precursors to the solution; wherein the step of hydrogenating comprises the one or more first precursors converting to the first catalyst in situ during the step of hydrogenating.

Aspect 27: The method of Aspect 26, wherein the one or more first precursors comprise molybdenum trisiodide tris tetrahydrofuran [Mol₃(THF)] and at least one compound comprising one or more phosphine ligands. Optionally, the at least one compound of Aspect 27 comprising one or more phosphine ligands is characterized by formula FX19A, FX19B, FX19C, FX19D, or a derivative thereof:

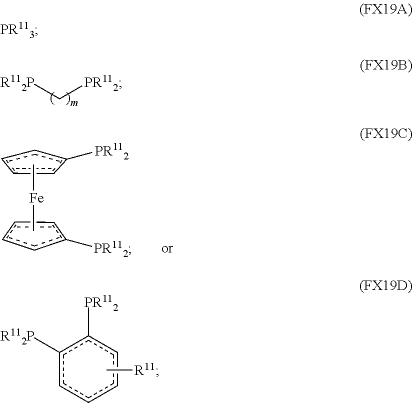

wherein each R is independently a C₁-C₁₀ alkyl group or a C₆-C₁₈ aromatic group and wherein m is an integer selected from the range of 1 to 4.

Aspect 28a: The method of any of the preceding Aspects, wherein the first catalyst comprises at least one compound characterized by formula, FX20, FX21, FX22, FX23, or a derivative thereof:

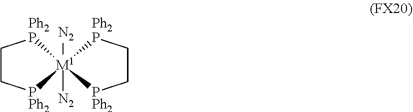

where M¹ is Mo or W and each Ph is a phenyl group;

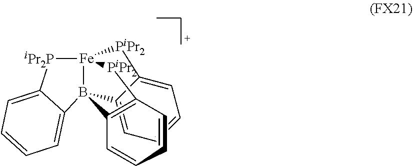

where each iPr is an isopropyl group;

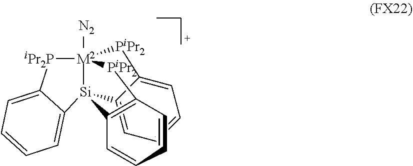

where M² is Fe, Ru, or Os and wherein each iPr is an isopropyl group; or

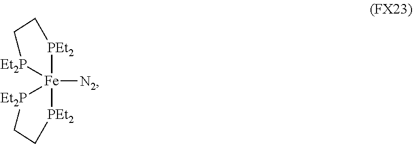

where each Et is an ethyl group.

Aspect 28b: The method of any of the preceding Aspects, wherein the first catalyst is characterized by formula FX20, FX21, FX22, FX23, or a derivative thereof. Aspect 28c: The method of any of the preceding Aspects, wherein the first catalyst is characterized by formula FX20, FX21, FX22, or FX23.

Aspect 29a: The method of any of the preceding Aspects, wherein the first catalyst has a concentration in the solution selected from the range of 0.01 mM to 100 mM, and wherein each value and range of therebetween is explicitly contemplated and disclosed herein inclusively. Aspect 29b: The method of any of the preceding Aspects, wherein the first catalyst has a concentration in the solution selected from the range of 0.01 mM (optionally 0.02 mM, optionally 0.05 mM, optionally 0.08 mM, optionally 0.1 mM, optionally 0.2 mM, optionally 0.5 mM, optionally 0.7 mM, optionally 0.9 mM, optionally 1.0 mM, optionally 1.2 mM, optionally 1.5 mM, optionally 1.7 mM, optionally 2.0 mM, optionally 2.5 mM, optionally 3.0 mM, optionally 5.0 mM, optionally 5.5 mM, optionally 7.0 mM, optionally 10.0 mM) to 100 mM (optionally 99 mM, optionally 95 mM, optionally 90 mM, optionally 85 mM, optionally 80 mM, optionally 75 mM, optionally 70 mM, optionally 65 mM, optionally 50 mM, optionally 45 mM, optionally 40 mM, optionally 35 mM, optionally 30 mM).

Aspect 30: The method of any of the preceding Aspects, wherein the step of hydrogenating is further in the presence of a buffer, the solution comprising the buffer; wherein the buffer is different from each of the first catalyst and the transfer agent; and wherein the buffer is characterized by (e.g., comprises) a Bronsted acid species and a Bronsted base species thereof. As used herein, the term “buffer” is used consistently with the term as known and used in the art of chemistry, wherein a buffer generally comprises an acid and its conjugate base (or vice versa) which is typically used to regulate pH of a solution.

Aspect 31: The method of Aspect 30, wherein the buffer or the acid Bronsted species thereof is characterized by a pKa greater than 0.

Aspect 32: The method of Aspect 30 or 31, wherein the buffer or the Bronsted base species thereof is characterized by a pKa less than 50.

Aspect 33a: The method of any of Aspects 30-32, wherein the buffer or the Bronsted base species thereof is capable of deprotonating a cationic form of the transfer agent; and wherein the buffer or the Bronsted acid species thereof is capable of protonating the first catalyst having two N bound thereto. Aspect 29b: The method of any of Aspects 26-28, wherein the buffer or the Bronsted base species thereof is capable of deprotonating a cationic form of the transfer agent and/or wherein the buffer or the Bronsted acid species thereof is capable of protonating the first catalyst having two N bound thereto.

Aspect 34: The method of any of Aspects 30-43, wherein each of the Bronsted acid species and the Bronsted base species independently comprises pyridine group, a pyrazine group, a pyridazine group, a pyrimidine group, or any combination thereof.

Aspect 35: The method of any of Aspects 30-34, wherein the Bronsted acid comprises a collidine or a derivative thereof and the Bronsted base species comprises a collidinium or a derivative thereof.

Aspect 36a: The method of any of Aspects 30-35, wherein the buffer has a concentration in the solution selected from the range of 1 mM to 10 M, and wherein each value and range of therebetween is explicitly contemplated and disclosed herein inclusively. Aspect 36b: The method of any of Aspects 30-35, wherein the buffer has a concentration in the solution selected from the range of 0.5 mM (optionally 0.8 mM, optionally 1 mM, optionally 1.5 mM, optionally 2 mM, optionally 5 mM, optionally 8 mM, optionally 10 mM, optionally 15 mM, optionally 20 mM, optionally 25 mM, optionally 30 mM, optionally 35 mM, optionally 40 mM, optionally 45 mM, optionally 50 mM, optionally 55 mM, optionally 60 mM, optionally 65 mM, optionally 70 mM, optionally 75 mM, optionally 80 mM, optionally 85 mM, optionally 90 mM, optionally 95 mM, optionally 100 mM) to 10 M (optionally 9 M, optionally 8 M, optionally 7 M, optionally 6 M, optionally 5 M, optionally 4 M, optionally 3 M, optionally 2 M, optionally 1 M, optionally 0.9 M, optionally 0.7 M, optionally 0.5 M, optionally 0.3 M).

Aspect 37: The method of any of the preceding Aspects, wherein the step of hydrogenating is further in the presence of a photosensitizer, the solution comprising the photosensitizer; wherein the photosensitizer is different from each of the first catalyst, the transfer agent, and the buffer; and wherein the photosensitizer is capable of absorbing the light.

Aspect 38: The method of Aspect 37, wherein the photosensitizer is metalorganic, each molecule of which comprising one or more metal elements.

Aspect 39: The method of Aspect 38, wherein the photosensitizer comprises Ir or Ru.

Aspect 40a: The method of any of Aspects 37-39, wherein a reduced state of the photosensitizer comprises a reduction potential selected from the range of −1 to −4 V vs. ferrocene/ferrocenium (redox couple as reference) at 25° C. Aspect 40b: The method of any of Aspects 37-39, wherein a reduced state of the photosensitizer comprises a reduction potential selected from the range of −1 to −4 V (wherein each value and range of therebetween is explicitly contemplated and disclosed herein inclusively) vs. ferrocene/ferrocenium at 25° C.

Aspect 41a: The method of any of Aspects 37-40, wherein a reduced state of the photosensitizer comprises a reduction potential sufficient to reduce the first catalyst and any intermediate species of the first catalyst occurring during the hydrogenation of N₂. Aspect 41 b: The method of any of Aspects 37-40, wherein a reduced state of the photosensitizer comprises a reduction potential sufficient to reduce the first catalyst or at least one intermediate species of the first catalyst occurring during the hydrogenation of N₂. Aspect 41c: The method of any of Aspects 37-40, wherein a reduced state of the photosensitizer comprises a reduction potential sufficient to reduce the first catalyst and at least one intermediate species of the first catalyst occurring during the hydrogenation of N₂.

Aspect 42: The method of any of Aspects 37-41, wherein the photosensitizer and the transfer agent are selected such the transfer agent or state thereof can quench an excited state of the photosensitizer.

Aspect 43a: The method of any of Aspects 37-42, wherein the photosensitizer has a concentration in the solution selected from the range of 0.01 mM to 100 mM, and wherein each value and range of therebetween is explicitly contemplated and disclosed herein inclusively. Aspect 43b: The method of any of Aspects 37-42, wherein the first catalyst has a concentration in the solution selected from the range of 0.01 mM (optionally 0.02 mM, optionally 0.05 mM, optionally 0.08 mM, optionally 0.1 mM, optionally 0.2 mM, optionally 0.5 mM, optionally 0.7 mM, optionally 0.9 mM, optionally 1.0 mM, optionally 1.2 mM, optionally 1.5 mM, optionally 1.7 mM, optionally 2.0 mM, optionally 2.5 mM, optionally 3.0 mM, optionally 5.0 mM, optionally 5.5 mM, optionally 7.0 mM, optionally 10.0 mM) to 100 mM (optionally 99 mM, optionally 95 mM, optionally 90 mM, optionally 85 mM, optionally 80 mM, optionally 75 mM, optionally 70 mM, optionally 65 mM, optionally 50 mM, optionally 45 mM, optionally 40 mM, optionally 35 mM, optionally 30 mM).

Aspect 44: The method of any of Aspects 37-43, wherein the photosensitizer is selected from the group consisting of [Ir(ppy)₂(dtbbpy)]BAr^{F}4, [Ir(dF(CF₃)ppy)₂(dtbbpy)]PF₆, [Ir^{II}(dF(CF₃)ppy)₂(dtbpy)]PF₆, [Ir(p-F(Me)ppy)₂(dtbbpy)]PF₆, [Ru(bpy)₃](PF₆)₂, [Ru(phen)₃](PF₆)₂, a 12-aryl dihydrobenzoacridine complexe, any derivative thereof, and any combination thereof.

Aspect 45: The method of any of Aspects 37-43, wherein the photosensitizer comprises a compound characterized by formula FX24, FX25, or any derivative thereof:

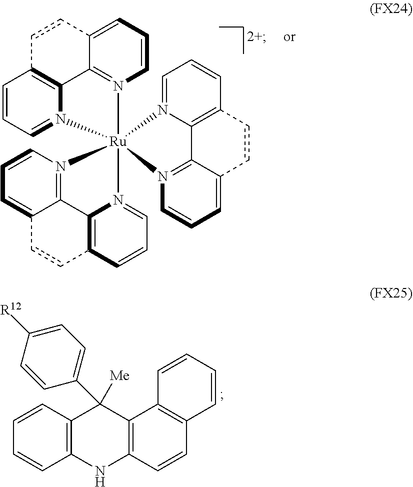

wherein R¹² is H, —OCH, —CF₃, or —CN.

Aspect 46a: The method of any of the preceding Aspects, wherein the light comprises a primary peak wavelength being less than 800 nm. Aspect 46b: The method of any of the preceding Aspects, wherein the light comprises a primary peak wavelength being less than 1000 nm, optionally less than 900 nm, optionally less than 800 nm, optionally less than 700 nm, optionally less than 600 nm, optionally less than 500 nm, optionally less than 475 nm, optionally less than 450 nm, optionally less than 425 nm, optionally less than 400 nm, optionally less than 375 nm, optionally less than 350 nm, optionally less than 325 nm, optionally less than 300 nm, optionally selected from the range of 1000 nm to 200 nm, optionally selected from the range of 900 nm to 200 nm, optionally selected from the range of 800 nm to 200 nm, optionally selected from the range of 700 nm to 200 nm, optionally selected from the range of 600 nm to 200 nm, optionally selected from the range of 500 nm to 200 nm, optionally selected from the range of 700 nm to 200 nm, optionally selected from the range of 700 nm to 250 nm, optionally selected from the range of 700 nm to 300 nm, optionally selected from the range of 700 nm to 350 nm, optionally selected from the range of 700 nm to 400 nm, optionally selected from the range of 700 nm to 425 nm, optionally selected from the range of 700 nm to 450 nm, optionally selected from the range of 600 nm to 300 nm, optionally selected from the range of 500 nm to 300 nm, optionally selected from the range of 500 nm to 400 nm. Aspect 46c: The method of any of the preceding Aspects, wherein the light comprises a primary peak wavelength selected from the range of 700 nm to 200 nm and wherein each value and range of therebetween is explicitly contemplated and disclosed herein inclusively. As used herein, the term “primary peak wavelength” refers to the wavelength at which the intensity of a light's spectrum is an absolute maximum with respect to the spectrum. This is intended to refer, therefore, to the absolute maximum of said spectrum rather than a local maximum, if present, in a spectrum having multiple peaks. In the case of a spectrum having two or more absolute maxima, the term “primary peak wavelength” may refer to any one or combination of said peaks.

Aspect 47: The method of any of the preceding Aspects, wherein the light comprises a primary peak wavelength being less than 500 nm.

Aspect 48a: The method of any of the preceding Aspects, wherein the light comprises an intensity greater than or equal to 1000 W/m². Aspect 48b: The method of any of the preceding Aspects, wherein the light comprises an intensity selected from the range of 100 W/m² to 1,000,000 W/m², and wherein each value and range of therebetween is explicitly contemplated and disclosed herein inclusively. Aspect 48c: The method of any of the preceding Aspects, wherein the light comprises an intensity selected from the range of 100 W/m² (optionally 200 W/m², optionally 300 W/m², optionally 400 W/m², optionally 500 W/m², optionally 600 W/m², optionally 700 W/m², optionally 800 W/m², optionally 900 W/m²) to 1,000,000 W/m² (optionally 500,000 W/m², optionally 100,000 W/m², optionally 50,000 W/m², optionally 25,000 W/m², optionally 10,000 W/m², optionally 7500 W/m², optionally 5000 W/m², optionally 2500 W/m², optionally 1500 W/m²) at and/or near the solution surface and/or in the solution and/or at or near a position where the hydrogenation is occurring in the presence of the first catalyst and the transfer agent.

Aspect 49: The method of any of the preceding Aspects, wherein the solution is an aqueous solution. Optionally, an aqueous solution comprises up to 5 vol. % of organic solvent.

Aspect 50: The method of any of the preceding Aspects, wherein the solution is a nonaqueous solution. Optionally, a nonaqueous solution comprises up to 5 vol. % of water.

Aspect 51a: The method of any of the preceding Aspects, wherein a solvent of the solution and/or the transfer agent are selected such that the transfer agent has a solubility of at least 1 mM in said solvent. Aspect 51 b: The method of any of the preceding Aspects, wherein the transfer agent has a solubility of at least 1 mM in said solution or in a solvent of the solution.

Aspect 52: The method of any of the preceding Aspects, wherein the solution comprises an organic solvent being tetrahydrofuran, toluene, diethyl ether, benzene, trifluoroethanol, methanol, one or more other alcohols, or any combination thereof.

Aspect 53a: The method of any of the preceding Aspects, wherein the solution comprises N₂ dissolved therein at a concentration of at least 0.1 mM, optionally at least 0.2 mM, optionally at least 0.3 mM, optionally at least 0.4 mM, optionally at least 0.5 mM, optionally at least 0.6 mM, optionally at least 0.7 mM, optionally at least 0.8 mM, optionally at least 0.9 mM, optionally at least 1.0 mM. Aspect 53b: The method of any of the preceding Aspects optionally comprising bubbling N₂ gas or an N₂-containing gas through the solution during the step of hydrogenating.

Aspect 54: The method of any of the preceding Aspects, wherein the solution is exposed to a partial pressure of N₂ gas being at least 0.2 atm, optionally at least 0.3 atm, optionally at least 0.4 atm, optionally at least 0.5 atm, optionally at least 0.6 atm, optionally at least 0.7 atm, optionally at least 0.8 atm, optionally at least 0.9 atm, optionally at least 1.0 atm, optionally at least 1.1 atm, optionally at least 1.2 atm, optionally at least 1.5 atm, optionally at least 2 atm, optionally selected from the range of 0.2 atm to 10 atm, and wherein each value and range of therebetween is explicitly contemplated and disclosed herein inclusively, such as optionally selected from the range of 0.5 atm to 10 atm, optionally selected from the range of 0.6 atm to 10 atm, optionally selected from the range of 0.7 atm to 10 atm.

Aspect 55a: The method of any of the preceding Aspects, wherein the step of hydrogenating occurs at a temperature selected from the range of −80° C. to 50° C., and wherein each value and range of therebetween is explicitly contemplated and disclosed herein inclusively. Aspect 55b: The method of any of the preceding Aspects, wherein the step of hydrogenating occurs at a temperature selected from the range of −80° C. to 70° C., and wherein each value and range of therebetween is explicitly contemplated and disclosed herein inclusively. Aspect 55c: The method of any of the preceding Aspects, wherein the step of hydrogenating occurs at a temperature selected from the range of −80° C. (optionally −50° C., optionally −25° C., optionally −10° C., optionally −5° C., optionally 0° C., optionally 1° C., optionally 2° C., optionally 5° C., optionally 7° C., optionally 9° C., optionally 10° C., optionally 12° C., optionally 15° C., optionally 18° C., optionally 19° C.) to 50° C. (optionally 45° C., optionally 40° C., optionally 35° C., optionally 30° C., optionally 28° C., optionally 26° C., optionally 25° C., optionally 24° C., optionally 23° C., optionally 22° C., optionally 21° C.).

Aspect 56a: The method of any of the preceding Aspects, wherein the solution is exposed to a total gas pressure selected from the range of 0.7 atm to 10 atm, and wherein each value and range of therebetween is explicitly contemplated and disclosed herein inclusively. Aspect 56b: The method of any of the preceding Aspects, wherein the solution is exposed to a total gas pressure selected from the range of 0.5 atm to 10 atm, and wherein each value and range of therebetween is explicitly contemplated and disclosed herein inclusively, such as optionally selected from the range of 0.6 atm to 10 atm, optionally selected from the range of 0.7 atm to 10 atm, optionally selected from the range of 0.8 atm to 10 atm, optionally selected from the range of 0.9 atm to 10 atm, optionally selected from the range of 1.0 atm to 10 atm, optionally selected from the range of 1.1 atm to 10 atm.

Aspect 57: The method of any of the preceding Aspects, wherein the step of hydrogenating is characterized as a homogeneous reaction.

Aspect 58: The method of any of the preceding Aspects, wherein the step of hydrogenating is characterized by a yield of NH₃ per molecule of first catalyst being selected from the range of 1 to 1,000,000, and wherein each value and range of therebetween is explicitly contemplated and disclosed herein inclusively, such as optionally selected from the range of 5 to 1,000,000, optionally selected from the range of 10 to 1,000,000, optionally selected from the range of 15 to 1,000,000, optionally selected from the range of 20 to 1,000,000, optionally selected from the range of 25 to 1,000,000, selected from the range of 5 to 1,000, optionally selected from the range of 20 to 1,000, optionally selected from the range of 25 to 2,000.

Aspect 59: The method of any of the preceding Aspects, wherein the step of hydrogenating is characterized by a completion of at least 80%, optionally at least 85% optionally at least 90%, optionally at least 92%, optionally at least 95%, optionally at least 97%, optionally at least 99% within 72 hours, wherein completion corresponds to an amount of transfer agent consumed relative to a starting amount of the transfer agent.

Aspect 60: The method of any of the preceding Aspects, wherein the step of hydrogenating is characterized by a ΔΔG upon irradiation of greater than 25 kcal mol-1, optionally greater than or equal to 30 kcal mol-1, optionally greater than or equal to 35 kcal mol⁻¹, optionally greater than or equal to 40 kcal mol⁻¹. Here, ΔΔG is calculated using the following equations:

$${BDFE}_{eff} = 23.06 ( {E}_{ox} ) + 1.37 ( {pK}_{a} ) + {C}_{G}$$

$$Δ Δ {G}_{f} ( product ) = 3 ( \frac{{BDFE}_{H 2}}{2} - {BDFE}_{eff} )$$

where: “BDFE” is bond dissociation free energy; Eₒₓ is the reduction potential of the strongest reductant readily available in the solution such as the excited state photoreductant, reduced ground state photosensitizer or excited state photosensitizer, depending on the mechanistic scheme; pKa is the acid dissociation constant of the strongest acid readily available in the solution such as the buffer; CG is the solvation constant; and “product” is the hydrogenated product, such as NH₃. Applicable BDFE, Eₒₓ, and CG values for exemplary molecules or reactions are provided throughout herein. Calculated ΔΔG values for various exemplary reactions or hydrogenations are provided throughout herein as well.

Aspect 61: The method of any of the preceding Aspects, wherein the step of hydrogenating is characterized by a ΔΔG upon irradiation that is at least 10 kcal mol⁻¹ greater, optionally at least 15 kcal mol⁻¹ greater, optionally at least 20 kcal mol⁻¹ greater, optionally at least 25 kcal mol⁻¹ greater, optionally at least 30 kcal mol⁻¹ greater, optionally at least 35 kcal mol⁻¹ greater than the ΔΔG without irradiation. See above Aspect 60 for discussion of ΔΔG.

Aspect 62: The method of any of the preceding Aspects, wherein hydrogenation of N₂ to NH₃ comprises oxidation of the transfer agent to a spent-transfer agent, the spent-transfer agent having at least one proton (e.g., 2 protons) and at least one electron (e.g., two electrons) (i.e., at least one H or at least one electron-proton pair) fewer than the transfer agent; wherein the solution is a first solution; and wherein the method further comprises: regenerating the spent-transfer agent back into the transfer agent.

Aspect 63a: A method of hydrogenation of N₂, the method comprising:
hydrogenating N₂ to NH₃ in the presence of a light, a phototransfer agent (optionally organic phototransfer agent), and a first metal-containing catalyst; and
regenerating the spent-transfer agent back into the transfer agent;
wherein:
wherein hydrogenation of N₂ to NH₃ comprises oxidation of the phototransfer agent to the spent-transfer agent;
the phototransfer agent and the first catalyst are in contact with a solution or in the solution;
the phototransfer agent comprises n chemically transferable electrons and protons, n being an integer equal to or greater than 1;
the step of hydrogenating comprises at least one charge-transfer reaction (optionally a plurality of charge-transfer reactions) via which the transfer agent donates at least one electron and at least one proton to one or more other chemical species;
the light is characterized by energy sufficient to photoexcite the phototransfer agent from a first state to an excited state thereof.

Aspect 63b: A method of hydrogenation of N₂, the method comprising:
hydrogenating a starting chemical species to one or more hydrogenated product species in the presence of a light, a transfer agent (optionally organic transfer agent), and a first metal-containing catalyst; and
regenerating the spent-transfer agent back into the transfer agent;
wherein:
wherein hydrogenation of N₂ to NH₃ comprises oxidation of the transfer agent to the spent-transfer agent;
the transfer agent, the first catalyst, and the starting chemical species are in contact with a solution or in the solution;
the transfer agent comprises n chemically transferable electrons and protons, n being an integer equal to or greater than 1;
the step of hydrogenating comprises at least one charge-transfer reaction (optionally a plurality of charge-transfer reactions) via which the transfer agent donates at least one electron and at least one proton to one or more other chemical species;
the step of hydrogenating comprises at least one photochemical reaction; and the light is characterized by energy sufficient to drive the at least one photochemical reaction.

Aspect 64: The method of Aspect 63, wherein the first solution further comprises a buffer and an organic photosensitizer; and wherein the step of hydrogenating occurs in the presence of the buffer and the photosensitizer.

Aspect 65: The method of any of Aspects 62, 63, or 64, wherein the steps of hydrogenating and regenerating are occurring simultaneously in the same first solution;
wherein the step of regenerating comprises one or more regeneration reactions;
wherein the solution further comprises a hydrogenation catalyst for catalyzing at least one of the regeneration reactions; and
wherein the steps of hydrogenating and regenerating are occurring in the presence of N₂ gas and H₂ gas.

Aspect 66: The method of any of Aspects 62, 63, or 64, wherein the steps of hydrogenating and regenerating are performed sequentially, in any order, in said first solution in the presence of the first metal-containing catalyst;
wherein the step of regenerating comprises one or more regeneration reactions;
wherein the solution further comprises a hydrogenation catalyst for catalyzing at least one of the regeneration reactions;
wherein the step of regenerating is performed in the presence of an H₂ gas; and
wherein the step of hydrogenating is performed in the presence of N₂ gas.

Aspect 67: The method of Aspect 66, wherein the step of regenerating is performed in absence of the light and/or wherein the transfer agent is not photoexcited during the step of regenerating.

Aspect 68: The method of any of Aspects 66 or 67, wherein the H₂ gas has a pressure of at least 0.1 bar.

Aspect 69: The method of any of Aspects 66, 67, or 68, wherein the steps of hydrogenating and regenerating are cycled/repeated a plurality of times.

Aspect 70: The method of any of Aspects 62, 63, or 64, wherein the steps of hydrogenating and regenerating are performed separately; wherein the step of hydrogenating occurs in the first solution and the step of regenerating occurs in a second solution;
wherein the step of regenerating comprises one or more regeneration reactions;
wherein the second solution comprises:
   a hydrogenation catalyst for catalyzing at least one of the regeneration reactions; and
   the spent-transfer agent; and
wherein the step of regenerating is performed in the presence of an H₂ gas.

Aspect 71: The method of Aspect 70 further comprising a step of transferring the spent-transfer agent from the first solution to the second solution.

Aspect 72: The method of any of Aspects 70 or 71, wherein the second solution further comprises a second buffer.

Aspect 73: The method of any of Aspects 70-72, wherein the step of regenerating is performed in absence of the light and/or wherein the transfer agent is not photoexcited during the step of regenerating.

Aspect 74: The method of any of Aspects 70-73, wherein the second solution is free of the first metal-containing catalyst and wherein the first solution is free of the hydrogenation catalyst.

Aspect 75: The method of any of Aspects 70-74, wherein the hydrogenation catalyst is a metalorganic catalyst comprising Ru, Rh, Ir, Pt, Pd, Ni, Co, Mn, Fe, or any combination thereof.

Aspect 76: A method for photodriven hydrogenation of a starting chemical species, the method comprising:
hydrogenating a starting chemical species to one or more hydrogenated product species in the presence of a light, an organic transfer agent, and a first metal-containing catalyst;
wherein:
the transfer agent, the first catalyst, and the starting chemical species are in a solution;
the transfer agent comprises n chemically transferable electrons and protons, n being an integer equal to or greater than 1;
the step of hydrogenating comprises at least one charge-transfer reaction (optionally a plurality of charge-transfer reactions) via which the transfer agent donates at least one electron and at least one proton to one or more other chemical species;
the step of hydrogenating comprises at least one photochemical reaction; and
the light is characterized by energy sufficient to drive the at least one photochemical reaction.

Aspect 77: The method of any of the preceding Aspects, wherein the step of hydrogenating comprises reducing the starting chemical species.

Aspect 78: The method of any of the preceding Aspects, wherein the starting chemical species comprises NO₃—, HCCH, CO₂, CO, HCN, PO₄²⁻, SO₄³⁻, NO, N₂O, or any combination thereof.

Aspect 79: The method of any of Aspects 76-78, wherein the transfer agent is a phototransfer agent; and wherein the light is characterized by energy sufficient to photoexcite the phototransfer agent from a first state to an excited state thereof.

Aspect 80: The method of any of Aspects 76-78, wherein the step of hydrogenating further occurs in the presence of a photosensitive cocatalyst; wherein photosensitive cocatalyst is in the solution; wherein the light is characterized by energy sufficient to photoexcite the photosensitive cocatalyst from a first state to an excited state thereof; and wherein the step of hydrogenating comprises one or more chemical reactions via which the transfer agent chemically reduces the photosensitive cocatalyst.

Aspect 81: The method of Aspect 80, wherein the transfer agent reductively quenches the photosensitive cocatalyst to generate a reduced photosensitive cocatalyst and/or the transfer agent reductively regenerates a ground state of the photosensitive cocatalyst.

### Discussion of Particular Non-Limiting Aspects:

Considering thermodynamic parameters relevant to the aforementioned goals, in its ground state the first C—H bond dissociation free energy (BDFE_{C—H}) of HEH₂ is 62.3 kcal mol⁻¹ in MeCN at 25° C. (all following thermochemical values are defined at these conditions), which is not weak enough to bimolecularly liberate H₂.(18) Photoexcitation of HEH₂, however, renders an excited state that is highly reducing (Eₒₓ for [HEH₂]* is ˜−2.6 V vs Fc^{+/0}; Fc=ferrocene).(19,20) Photodriven (blue LED) reduction of α-bromo acetophenone to acetophenone by HEH₂ illustrates its capacity to deliver an H₂ equivalent (FIG. 1B).(Error! Bookmark not defined.) For a dark N₂R reaction, we estimate the overpotential for reduction of N₂ by HEH₂ to generate NH₃ as 1.8 kcal mol⁻¹ ((ΔΔG_{f}(NH₃), FIG. 1C). Using light (blue LED), we show herein that it is indeed possible to catalyze photoinduced transfer hydrogenation from HEH₂ to N₂ using Nishibayashi's molybdenum pre-catalyst (FIG. 1C)(21) at atmospheric pressure and 23° C. The inclusion of an Ir-photoredox catalyst (FIG. 1C) within this system, while not necessary for turnover, enhances the yields and rates of NH₃ generation.

For our present catalysis system, we noted that a photoreduction step from the excited state of HEH₂, [HEH₂]*, liberates the ground state radical cation HEH₂*⁺, which is a sufficiently strong oxidant (E_{red}=0.48 V vs Fc*¹⁰) to be deleterious to N₂R.(Error! Bookmark not defined.) We therefore reasoned that inclusion of a base to deprotonate HEH₂*⁺ (pKₐ ˜−1) would be prudent.(Error! Bookmark not defined.) However, the presence of a moderate Brønsted acid is typically required for chemically driven N₂R, suggesting a buffered system might be needed. A collidine/collidinium (abbreviated Col/[ColH]⁺; Col=2,4,6-trimethylpyridine) mixture was chosen as Col will readily deprotonate HEH₂*⁺ while [ColH]*, with a pKₐ of 15 in MeCN,(22) has been previously shown to be compatible with chemically driven N₂R using (PNP)MoBr₃ as a pre-catalyst (PNP=2,6-bis(di-tert-butylphosphinomethyl)pyridine) with (Cp*)₂Co (E_{1/2}(Co^{III/II})=−1.91 V; Cp*=pentamethylcyclopentadienyl) as the reductant.(Error!Bookmark not defined, 23)

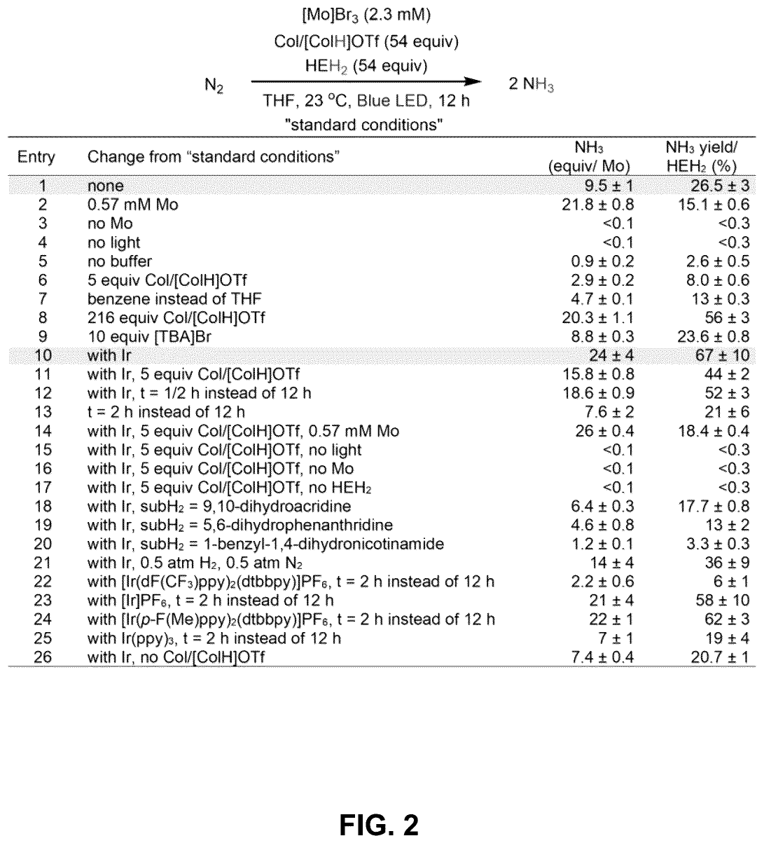

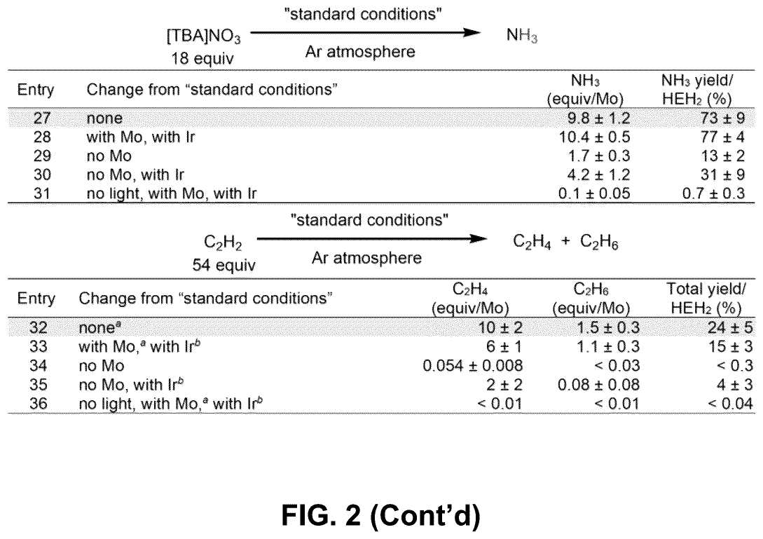

See FIG. 2 for exemplary conditions and results. Each “Entry” in FIG. 2 represents an exemplary hydrogenation process according to certain aspects disclosed herein. These are discussed below.

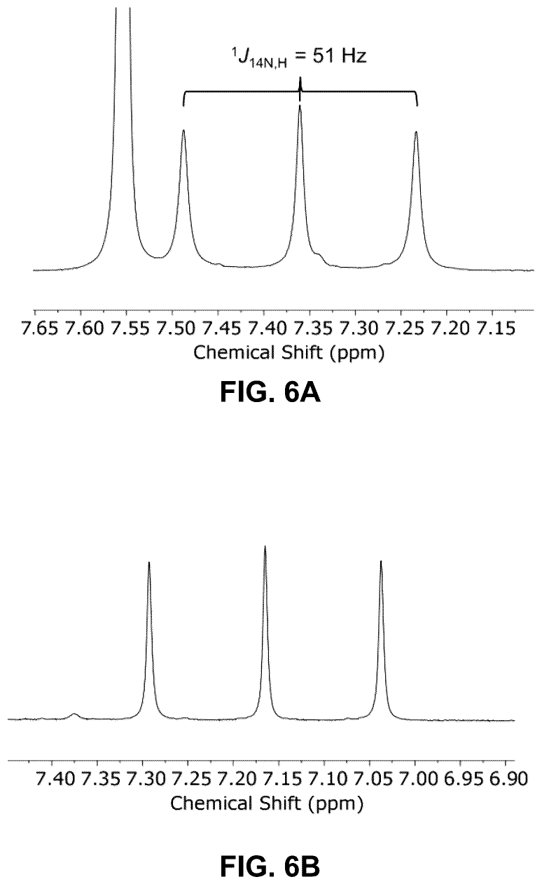

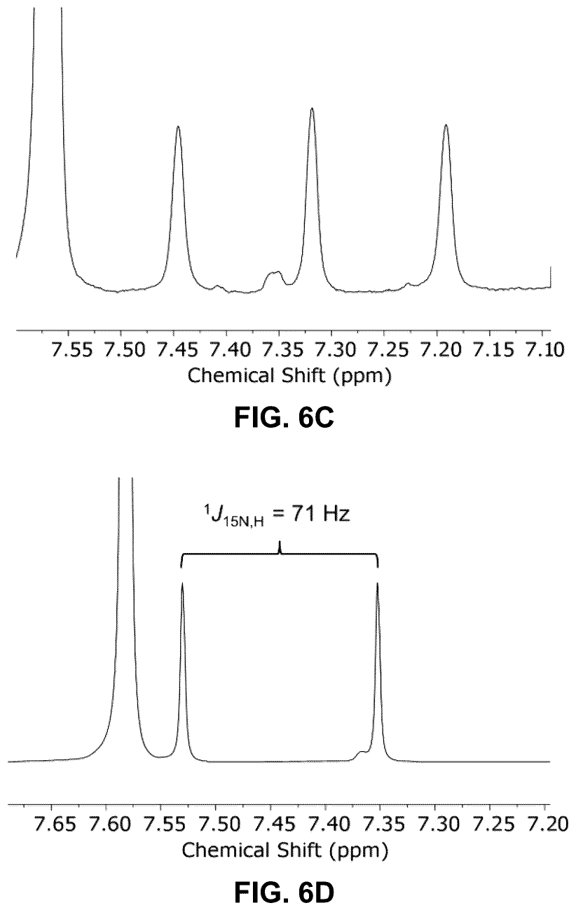

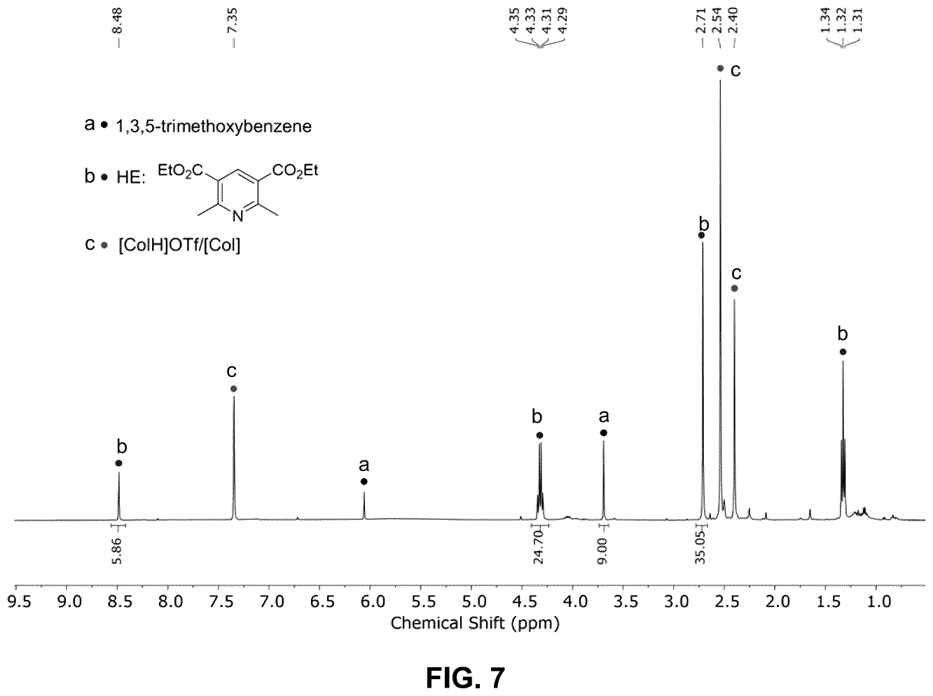

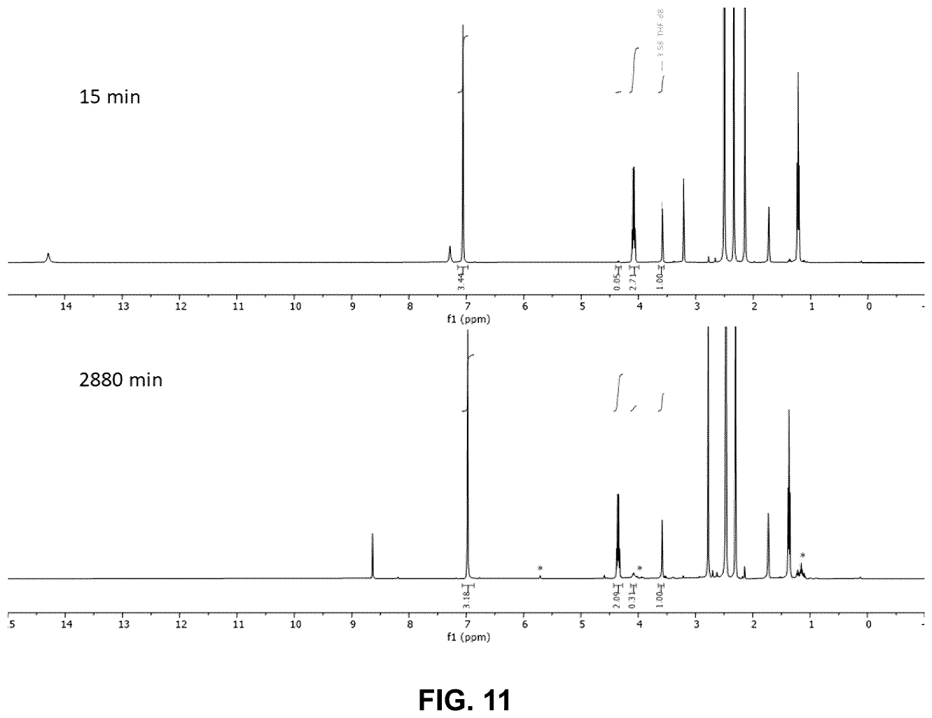

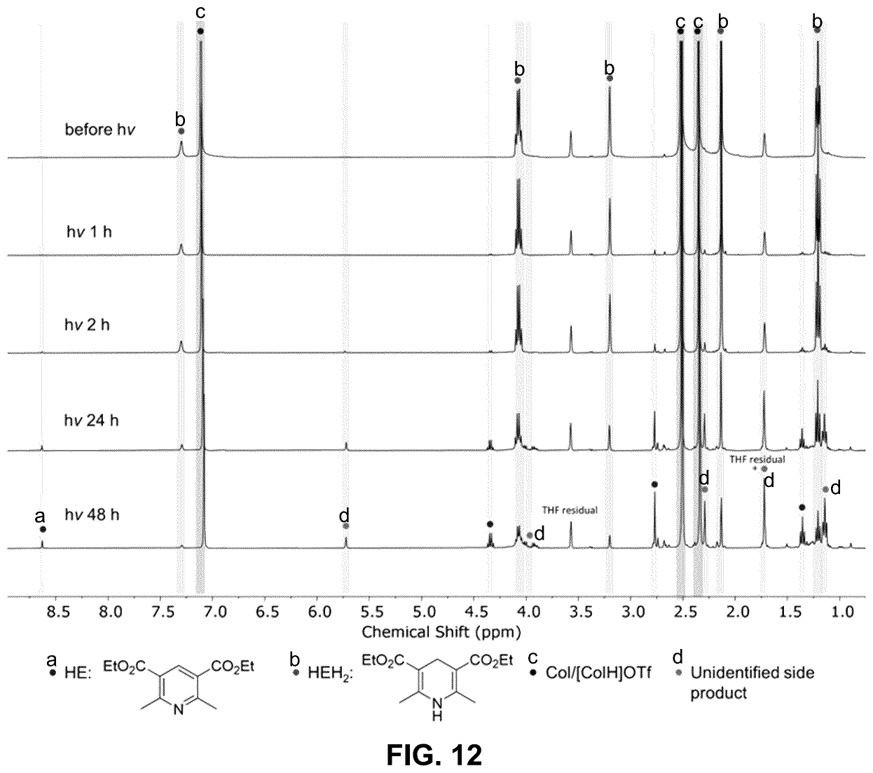

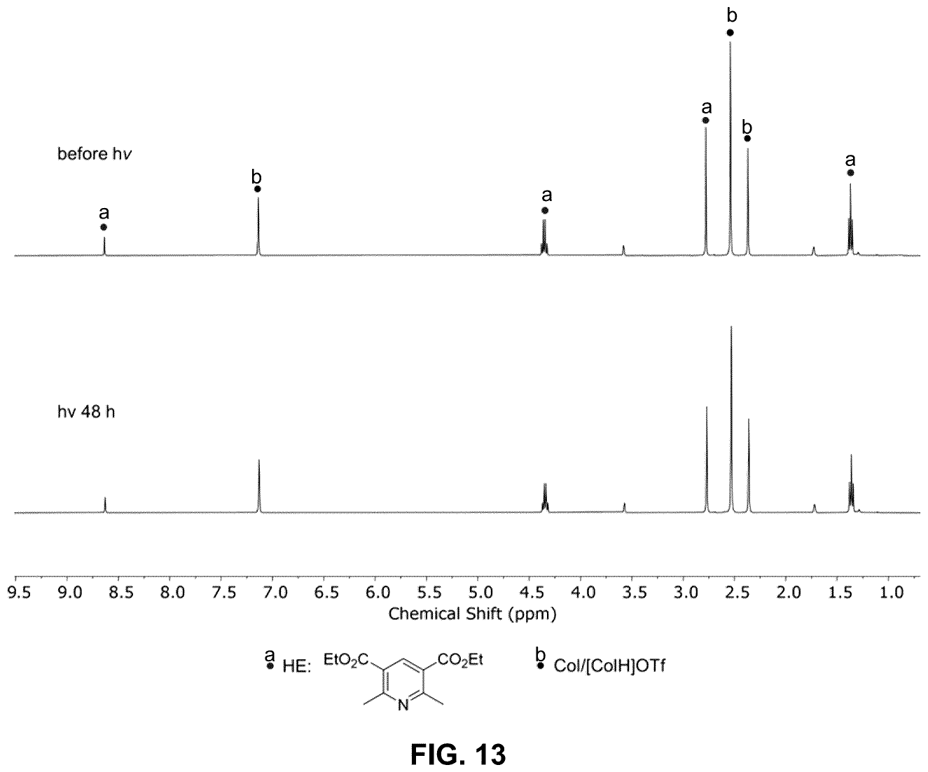

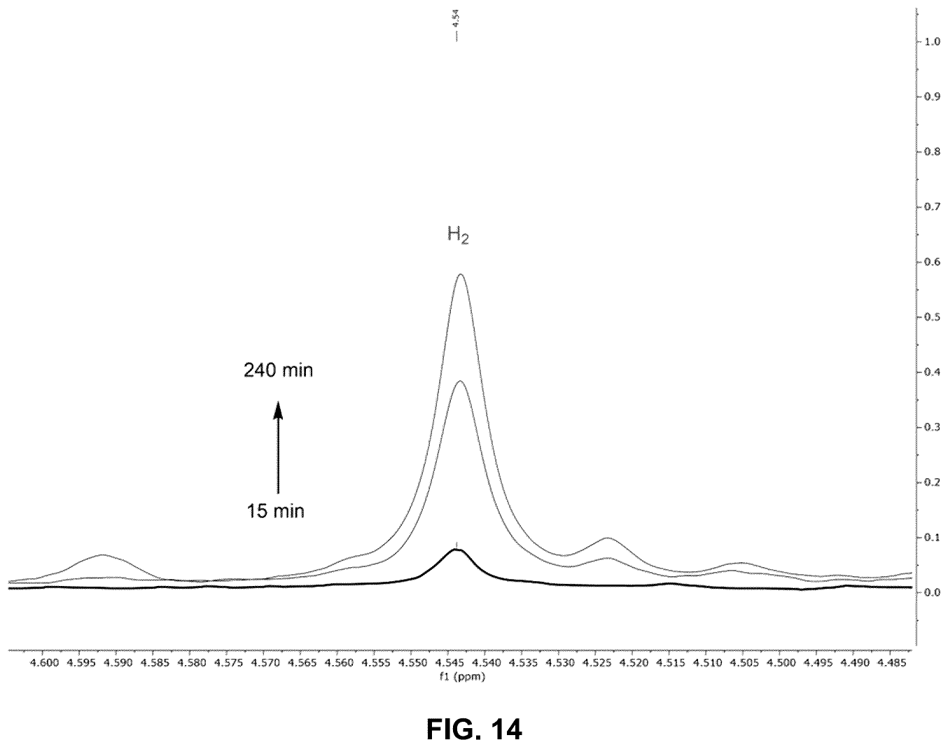

It is found that [Mo]Br₃ (1 equiv at 2.3 mM) in the presence of 54 equiv each of HEH₂, [ColH]OTf (OTf=triflate), and Col in THF, under an N₂ atmosphere and blue LED irradiation at 23° C. for 12 hours, yields 9.5±1 equiv NH₃/Mo (FIG. 2, entry 1). Assuming HEH₂ is a 2e⁻ donor in this process provides an NH₃ yield with respect to HEH₂ of −25%. Use of ¹⁵N₂ confirmed N₂ as the source of the NH₃ produced (FIGS. 6A-6D). To cement this interpretation, using either ¹⁵N-labeled HEH₂ or ¹⁵N-labeled Col/[ColH]OTf produced only ¹⁴NH₃. Analysis of the organic products following catalysis revealed complete consumption of HEH₂, with the fully oxidized Hantzsch ester pyridine (HE) as the major organic biproduct, consistent with HEH₂ acting as a 2e⁻/2 H⁺ donor. We note that the yield of HE is ˜90%; similarly, ˜10% of the initial buffer loading is not recovered (FIG. 11). In addition to HE and recovered buffer, a complex mixture of organic species is observed following catalysis. A significant component of this mixture is generated independently via irradiation of HEH₂ and buffer in the absence of metal catalysts (FIG. 12), possibly as a result of light-induced reductive coupling as has been previously observed upon irradiation of HE in the presence of amine reductants.(24) Another factor limiting NH₃ selectivity per HEH₂ concerns background hydrogen evolution under blue light irradiation (see FIG. 14).

Higher yields of NH₃ per Mo center could be obtained by decreasing the [Mo]Br₃ loading (21.8±0.8 equiv/Mo; entry 2), but with a loss in the yield of NH₃ with respect to HEH₂. The Mo-catalyst and irradiation were required to generate NH₃, and yields were substantially lower without the added buffer (entries 3-5). Attempts to use catalytic amounts of Col/[ColH]OTf (5 equiv per [Mo]Br₃) substantially lowered the NH₃ yields (entry 6). The reaction run in benzene instead of THF solvent remained catalytic but gave attenuated yields (4.7±0.1 equiv NH₃/Mo; entry 7), likely due to the lower solubility of [ColH]OTf in benzene.

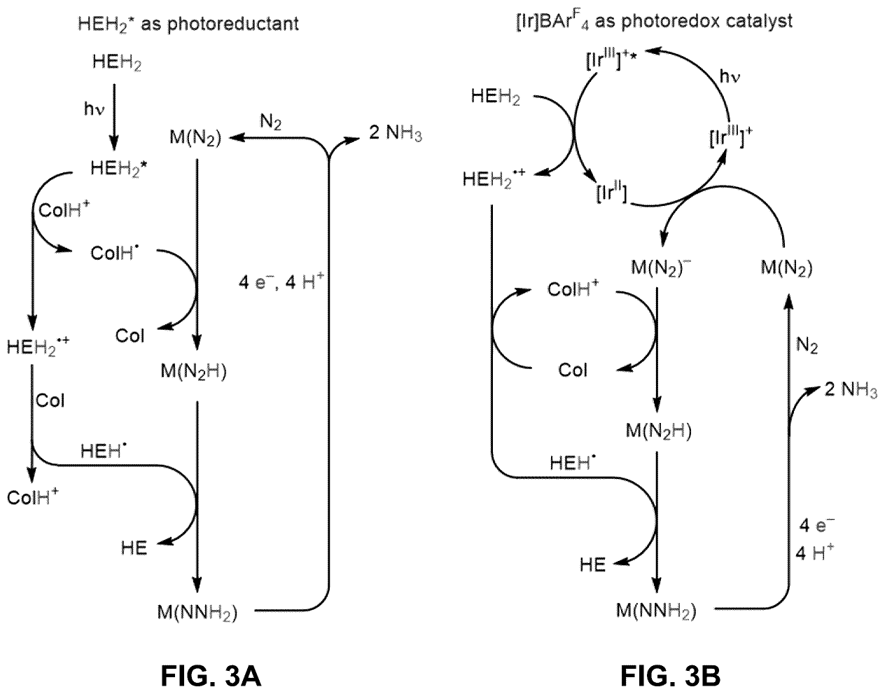

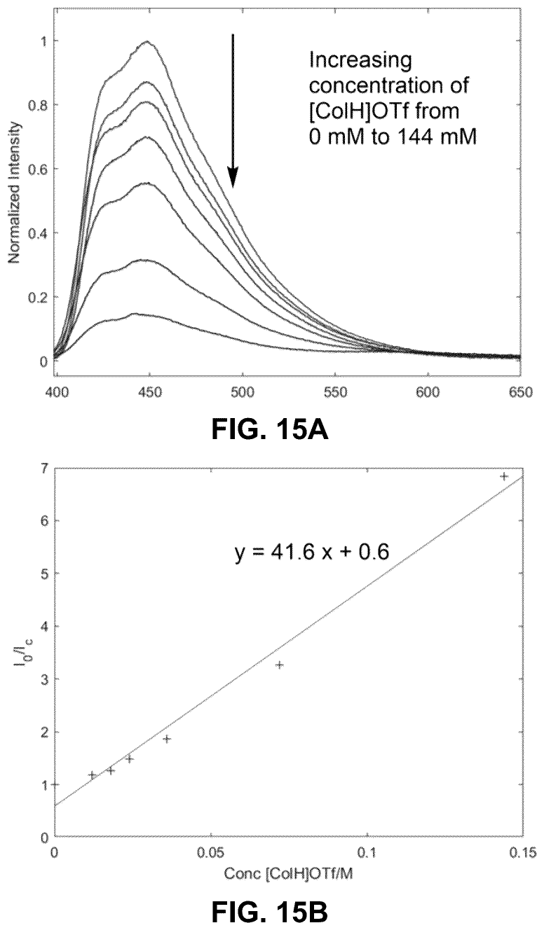

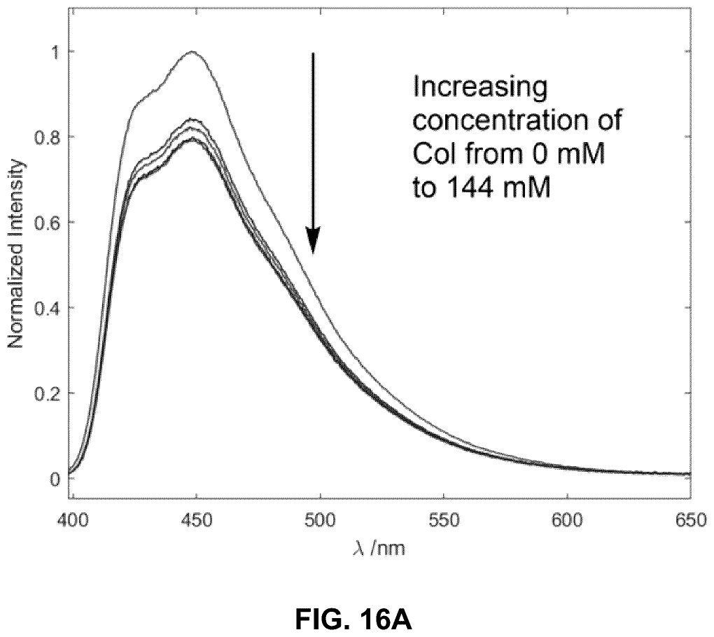

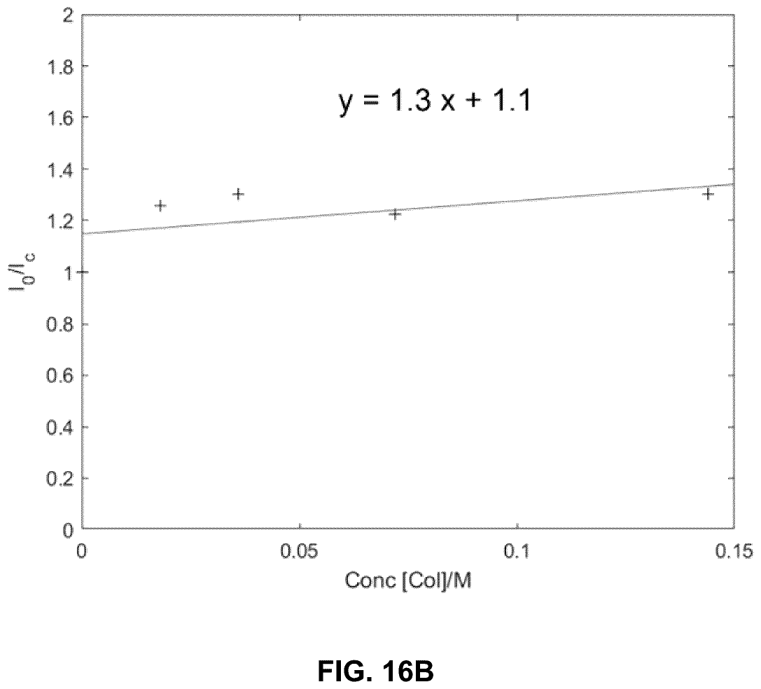

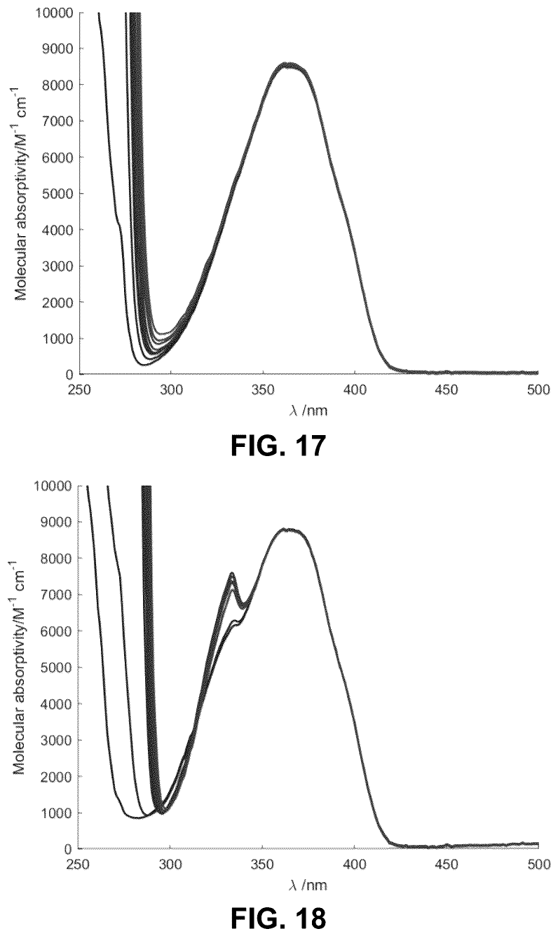

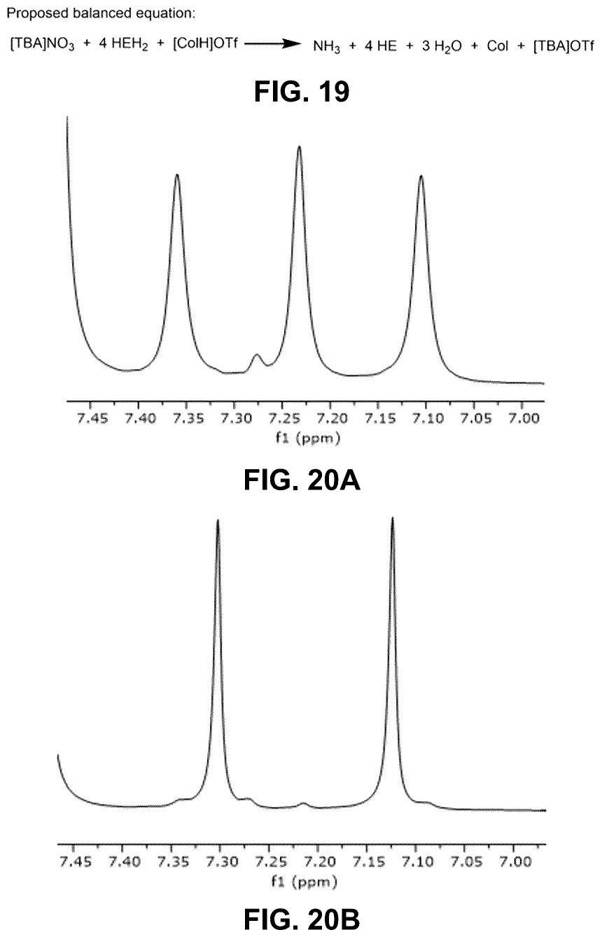

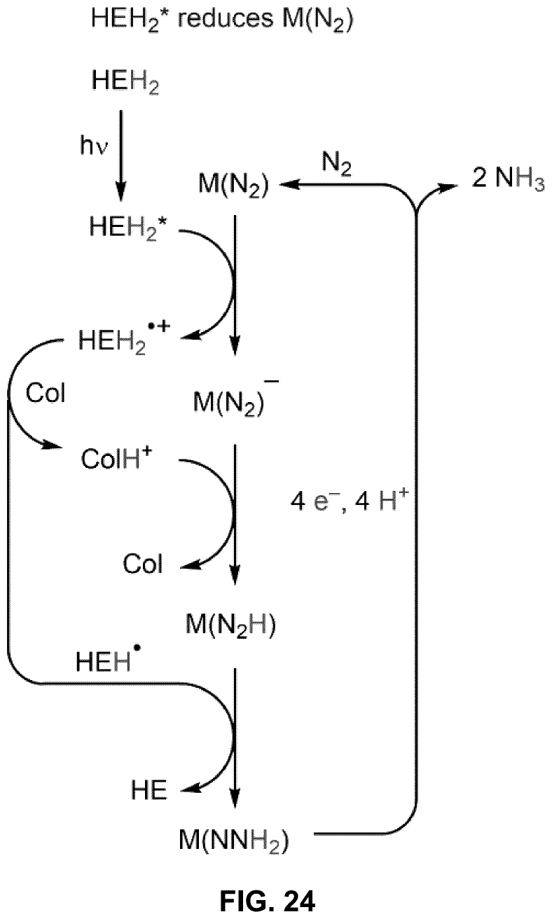

The fate of photoexcited [HEH₂]* is likely key. Two limiting scenarios to consider are the direct reduction of N₂R intermediates by [HEH₂]* (FIG. 24), or the reduction of the [ColH]OTf to [ColH]* radical, which then reacts with M(N₂) (FIG. 3A) to form an N—H bond via M(N₂H). Pyridinyl radicals have been posited as possible intermediates of N₂R in thermally driven catalysis with molecular systems.(25) Increasing the buffer concentration to 216 equiv/Mo boosted the NH₃ yield to 20.3±1.1 equiv NH₃/Mo (entry 7). This observation points to a pathway whereby reduction of [ColH]OTf by [HEH₂]* dominates (FIG. 3A), consistent with the high reactivity expected of [HEH₂]* (Eₒₓ˜−2.6 V; pKₐ˜−20; BDFE_{C—H}˜−8.5 kcal mol⁻¹), as well as its short solution lifetime (0.419 ns in DMSO solvent at 25° C.).(Error! Bookmark not defined, Error! Bookmark not defined.) Accordingly, steady state-fluorimetry studies show efficient quenching of [HEH₂]* upon titrating in [ColH]OTf (FIGS. 15A-15B). Similar titrations of Col revealed less efficient quenching (FIGS. 16A-16B). However, as some NH₃ can be detected under irradiation even in the absence of buffer (entry 4), other photoinduced pathways for N—H bond formation via HEH₂ are clearly accessible. The addition of 10 equiv of tetrabutylammonium bromide (TBABr) had no effect on the NH₃ yield (entry 8), suggesting that reductive Br⁻ loss from the precatalyst is not a limiting factor.

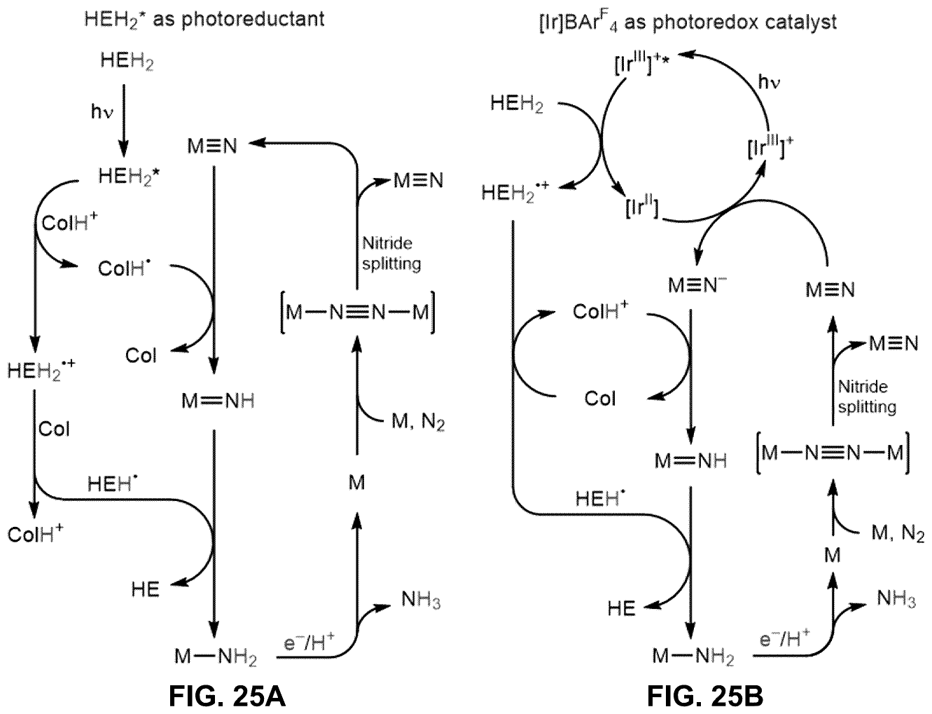

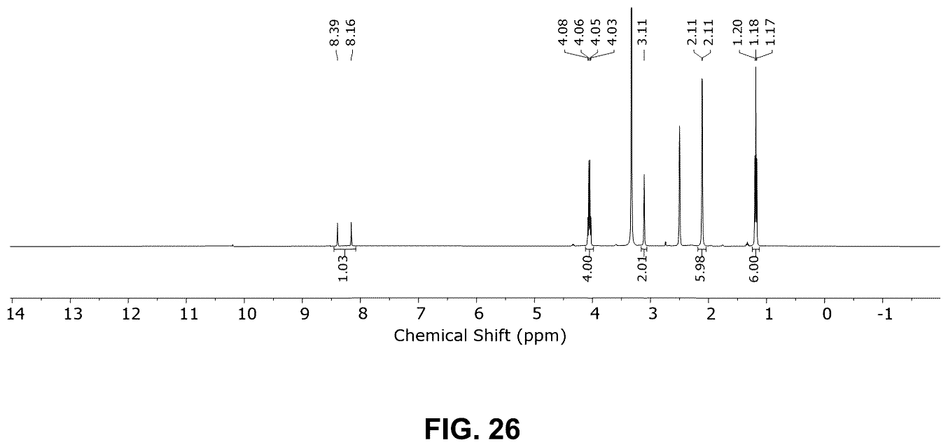

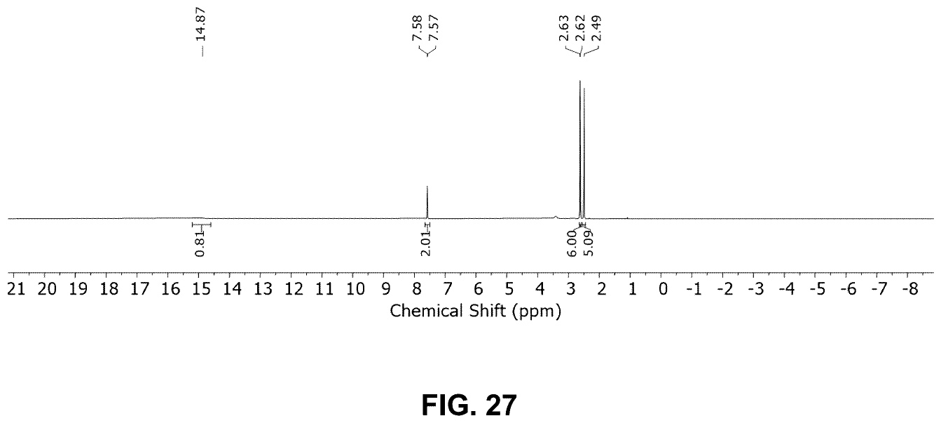

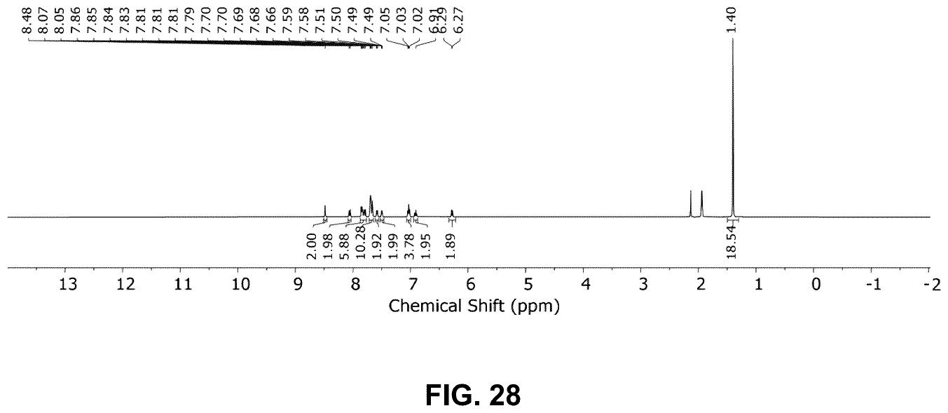

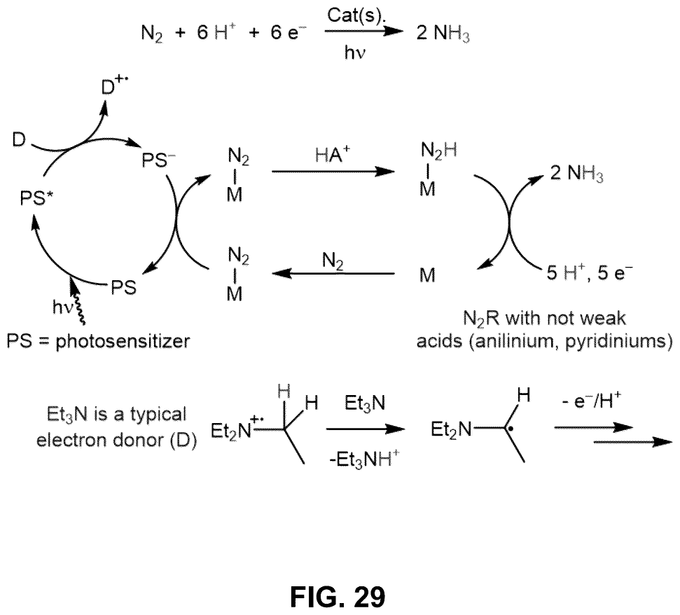

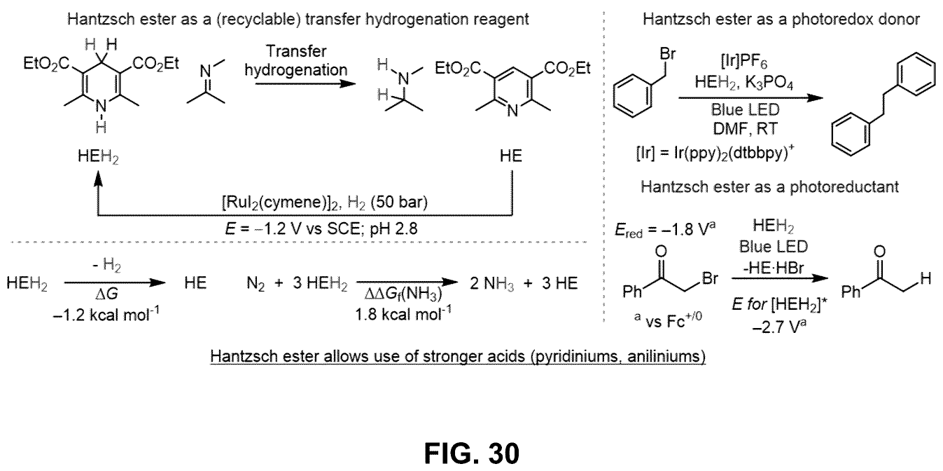

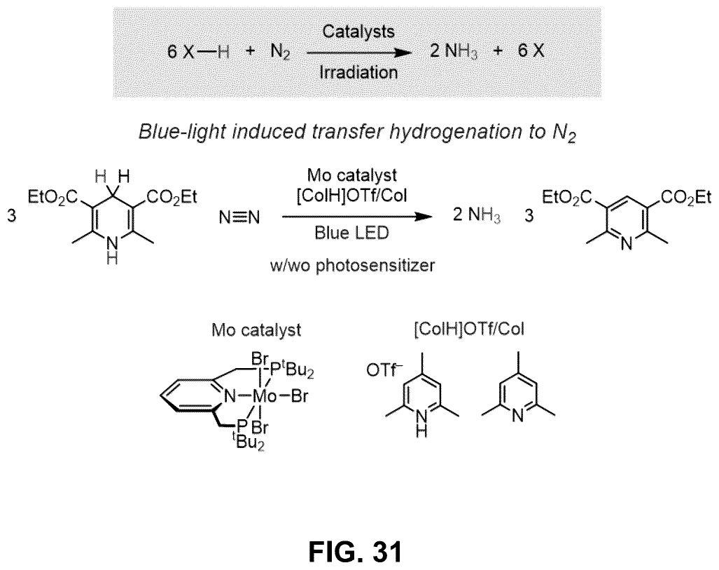

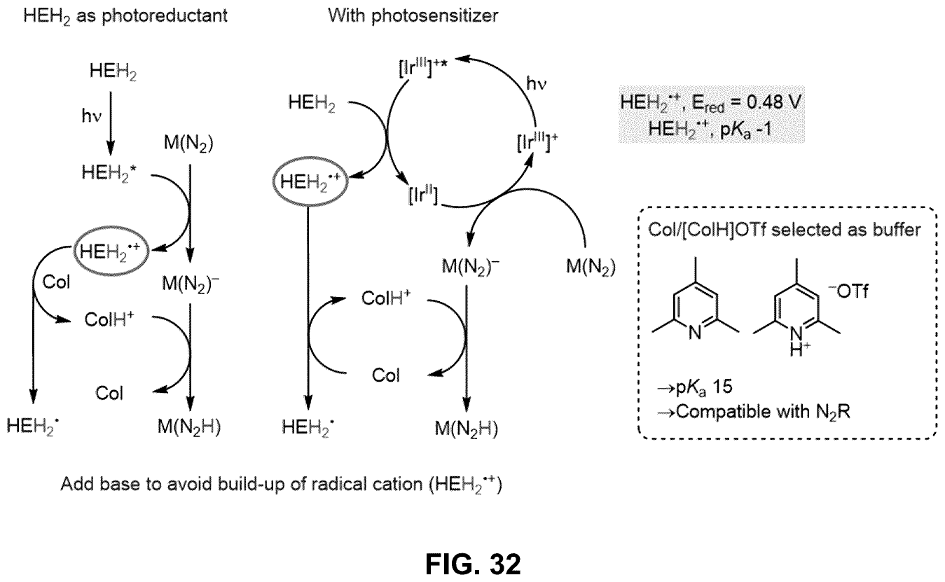

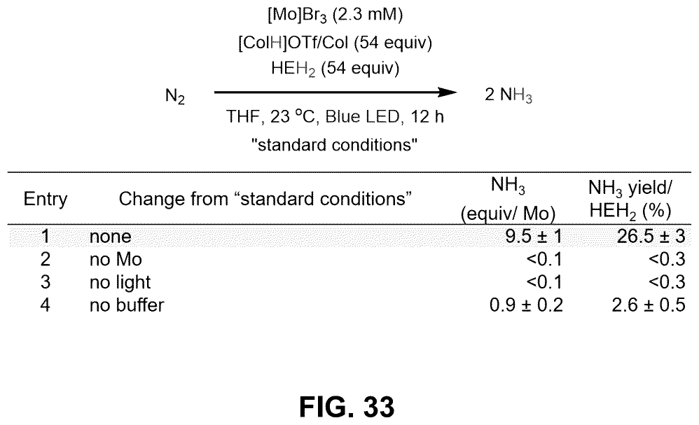

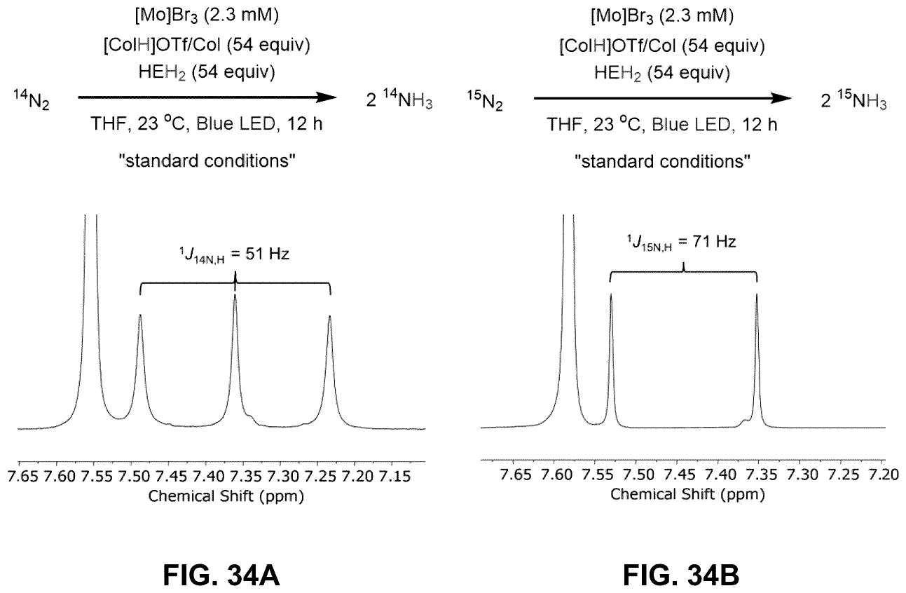

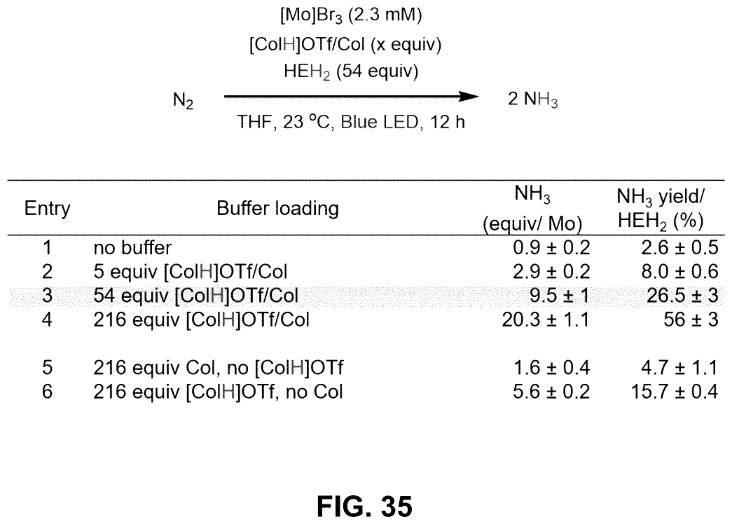

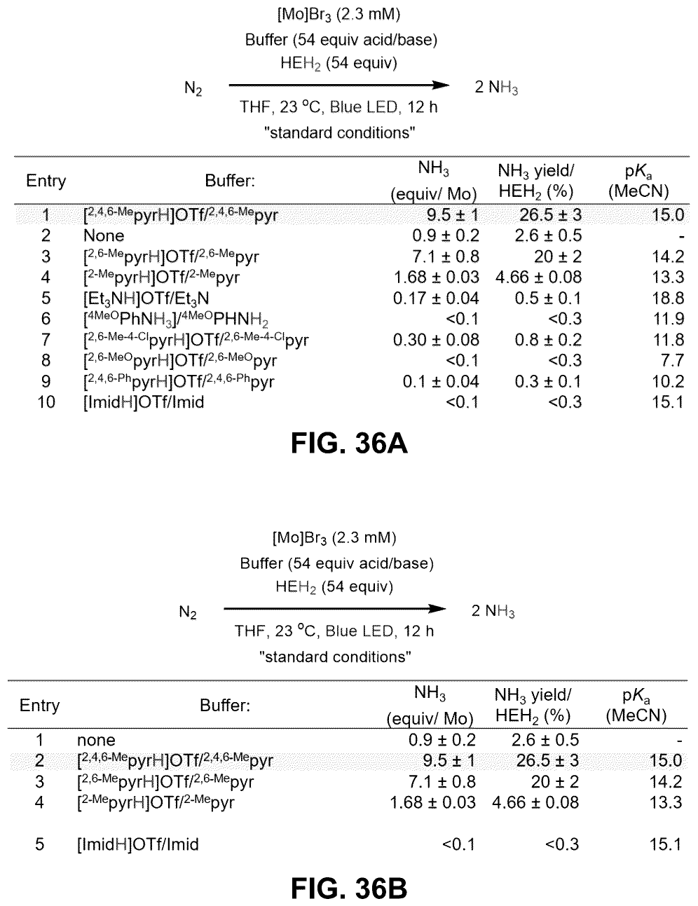

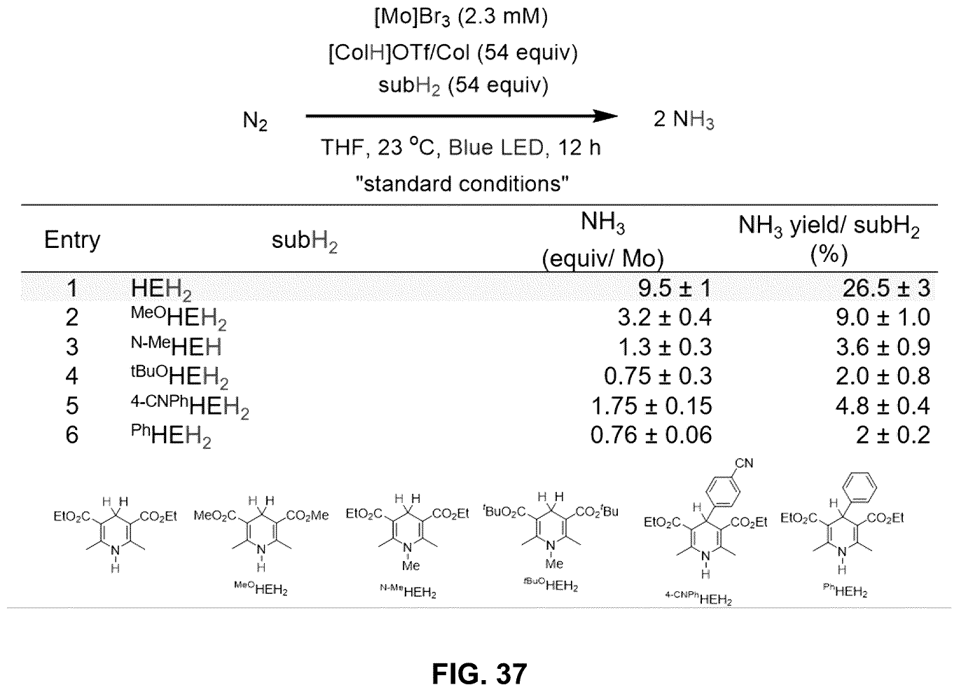

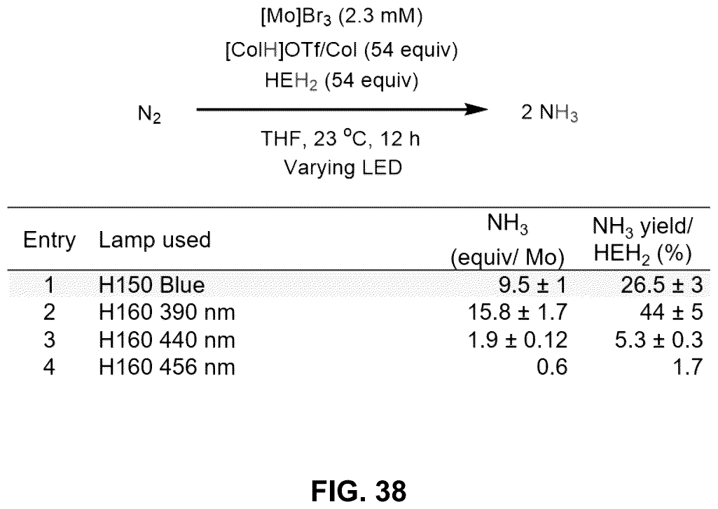

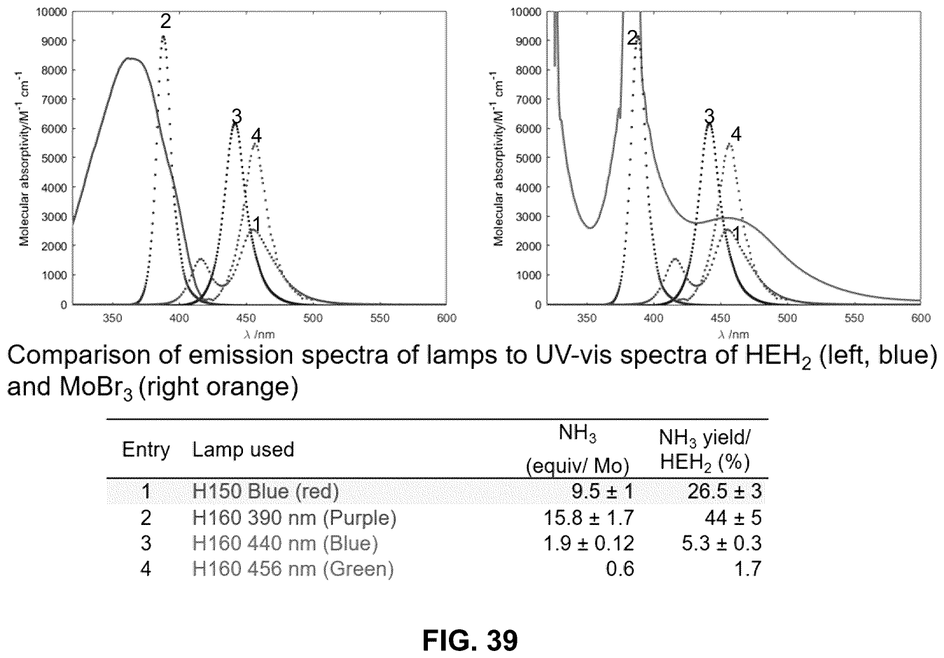

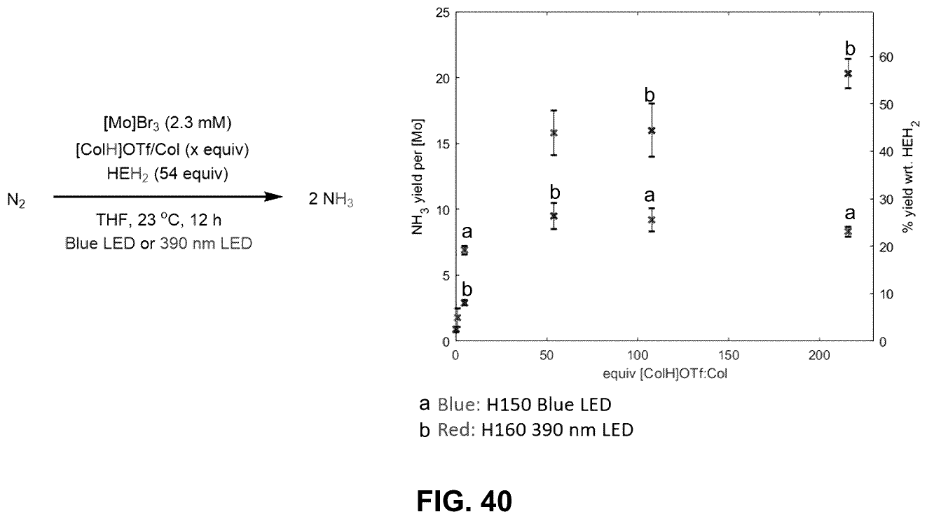

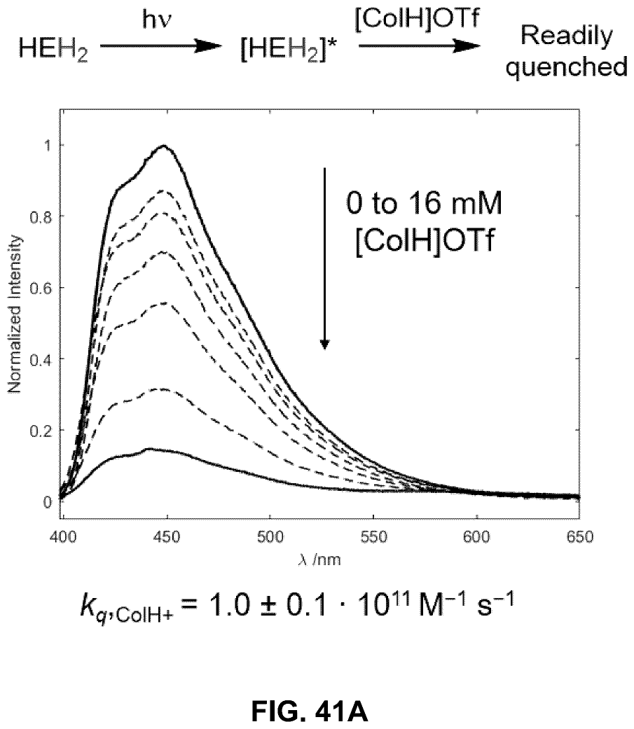

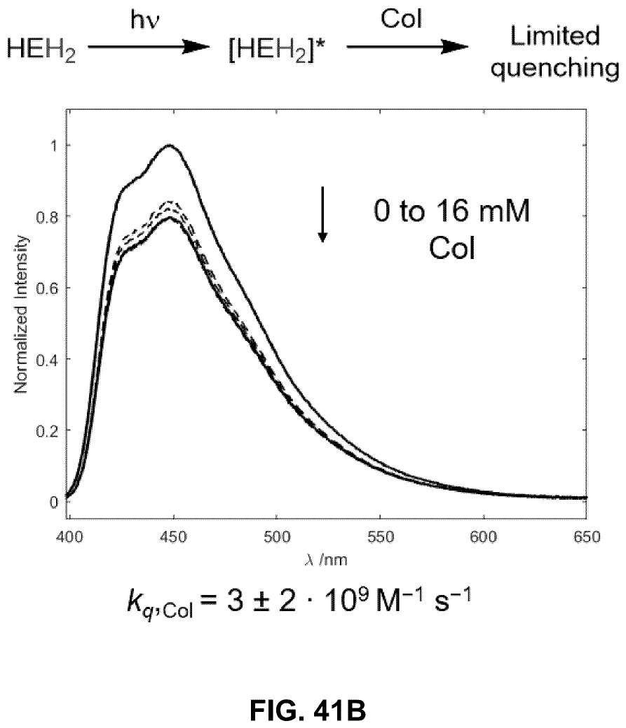

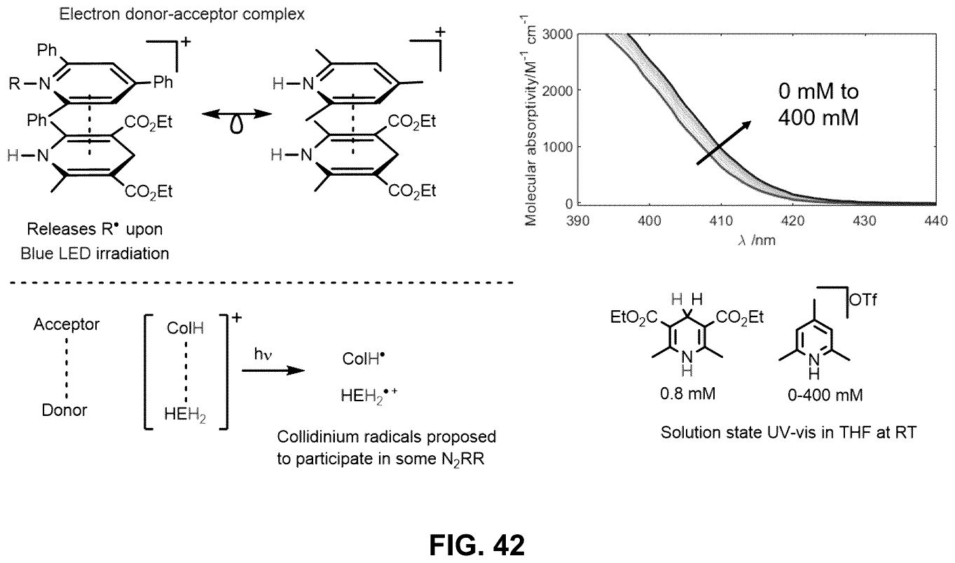

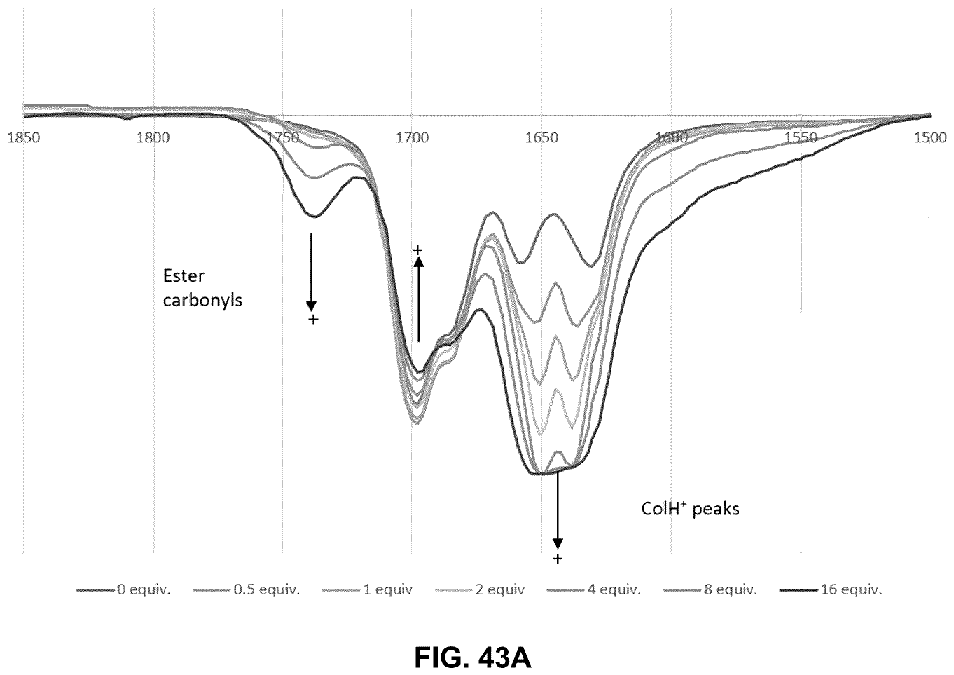

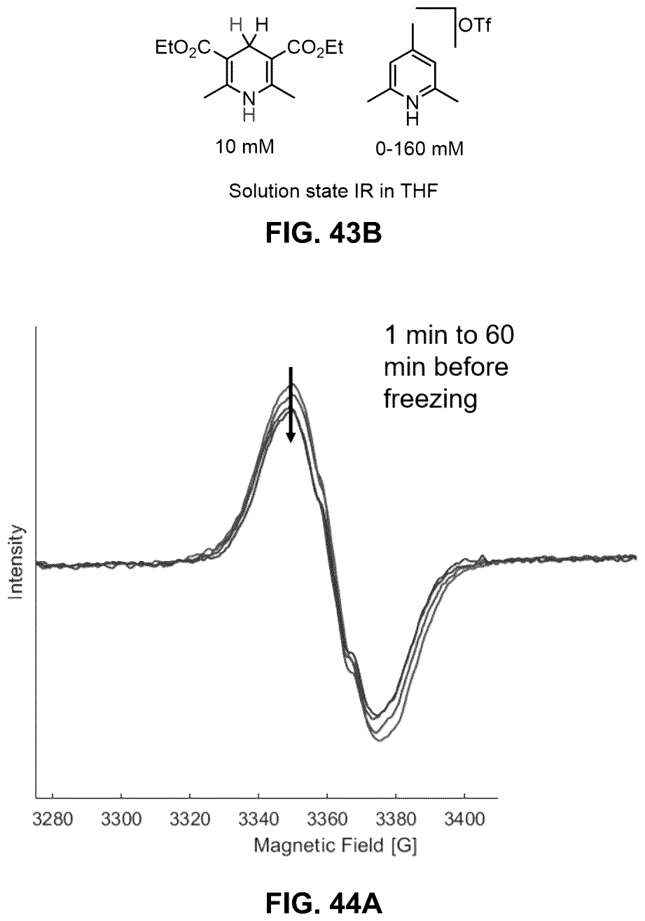

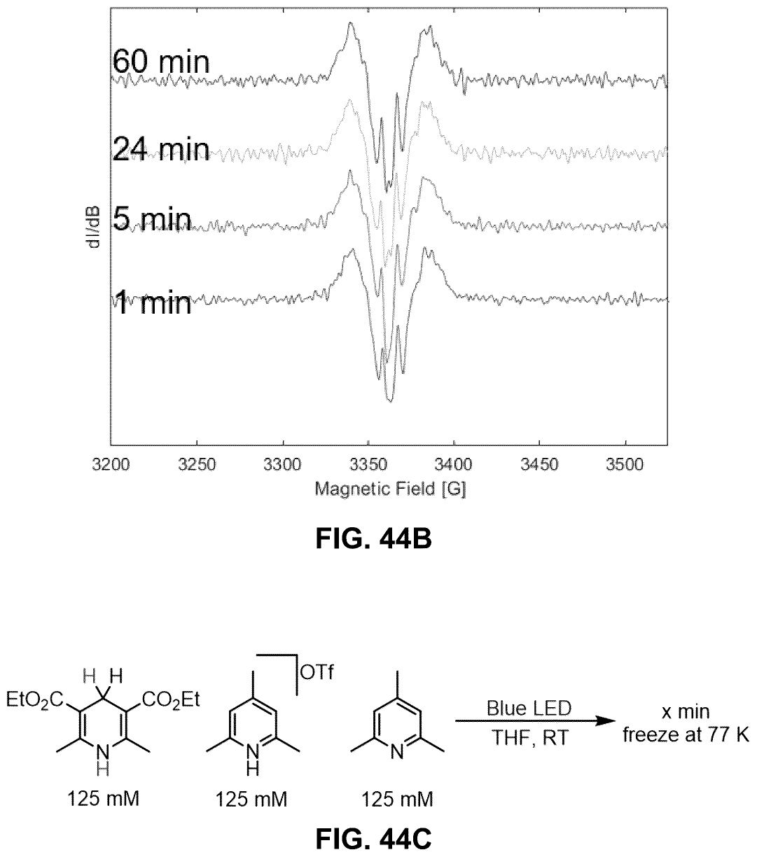

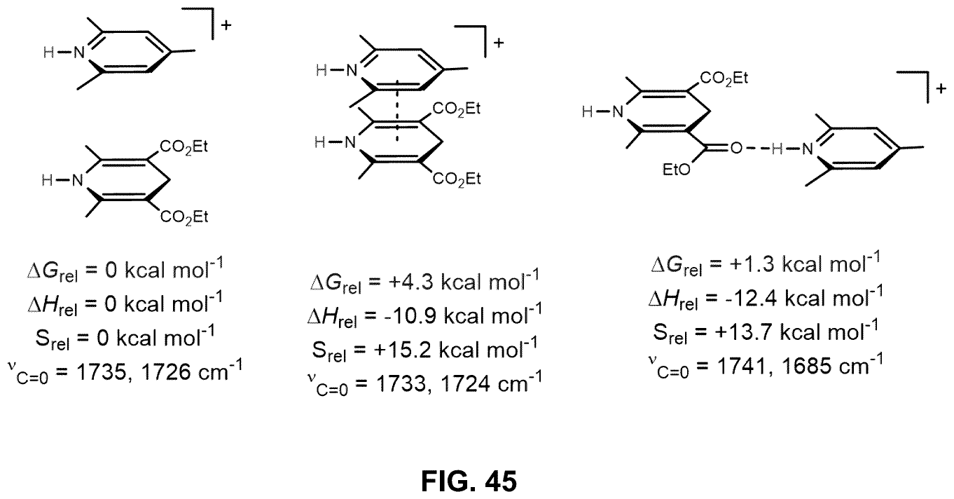

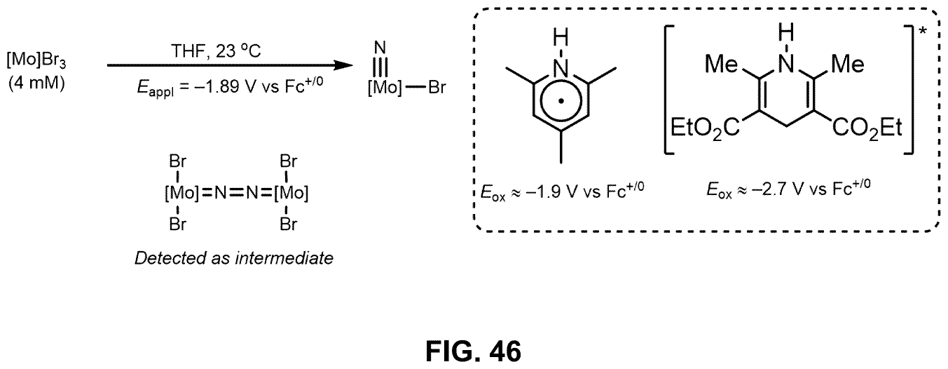

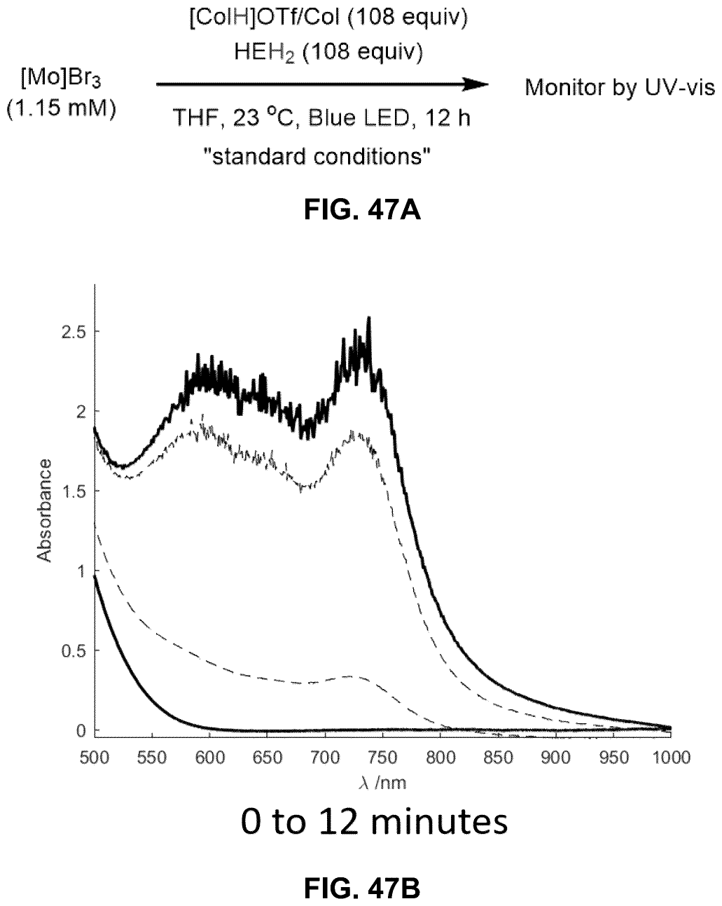

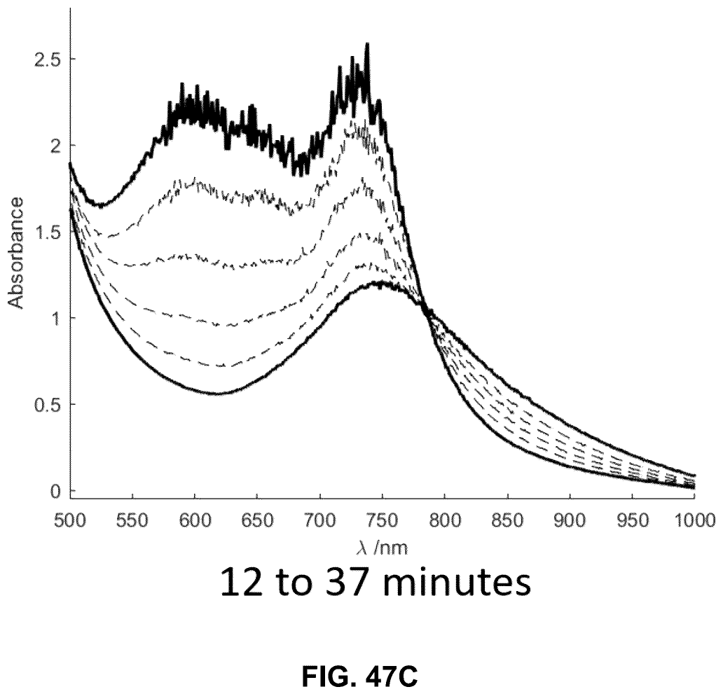

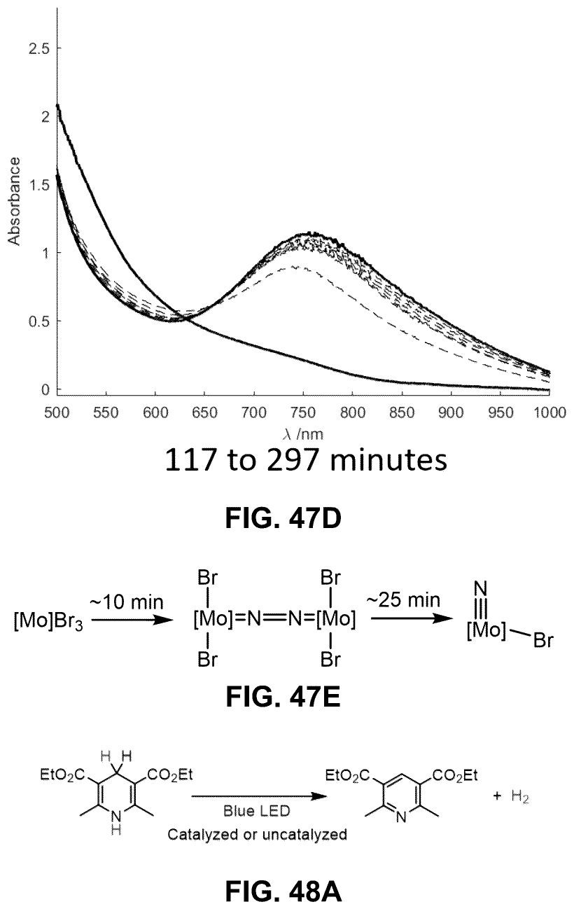

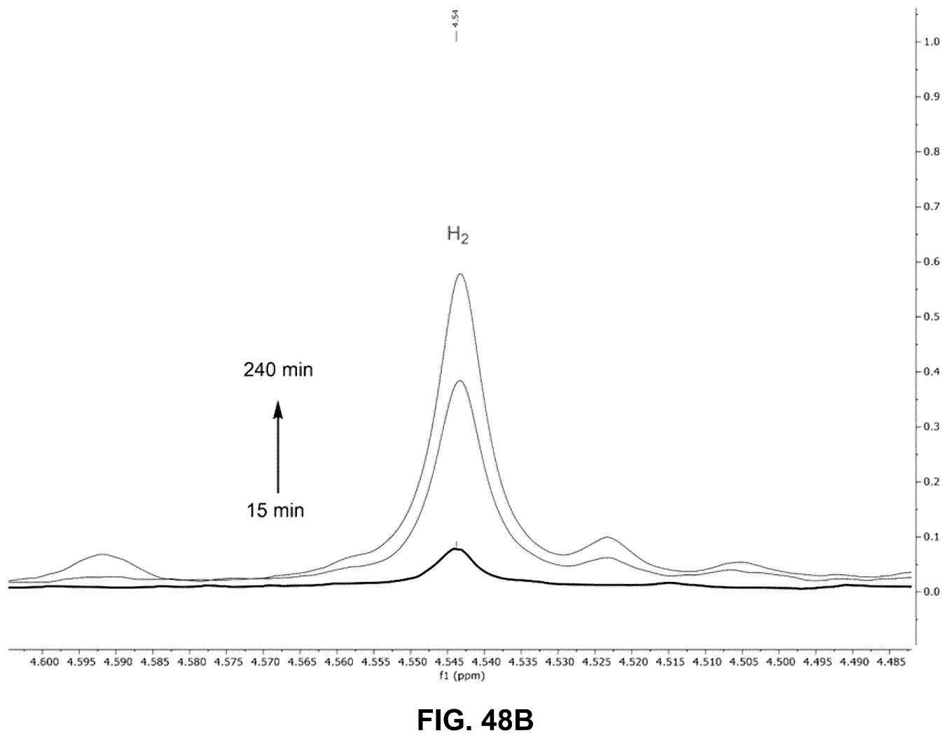

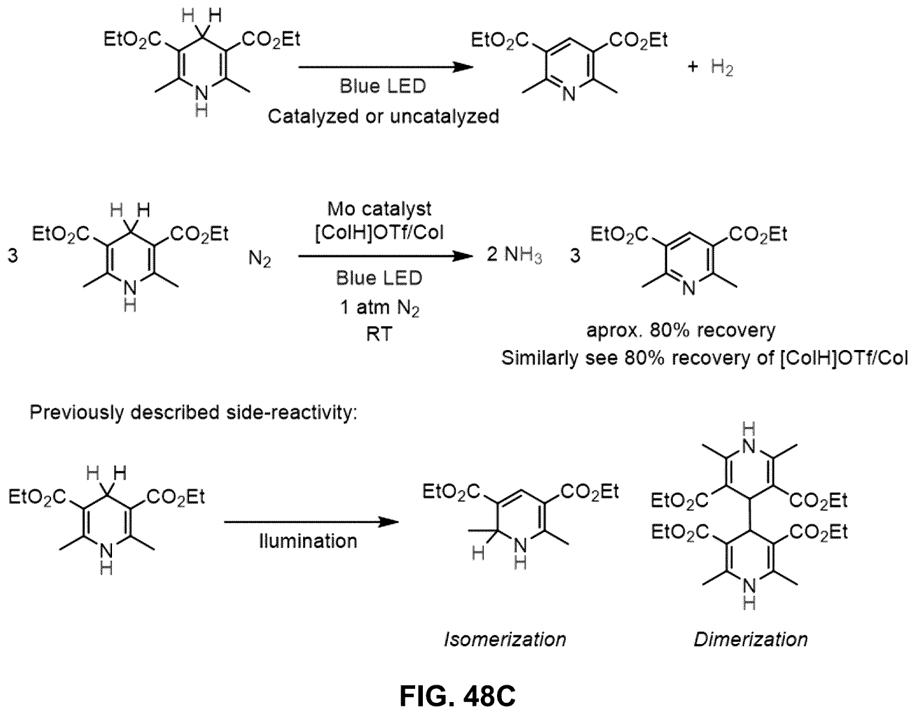

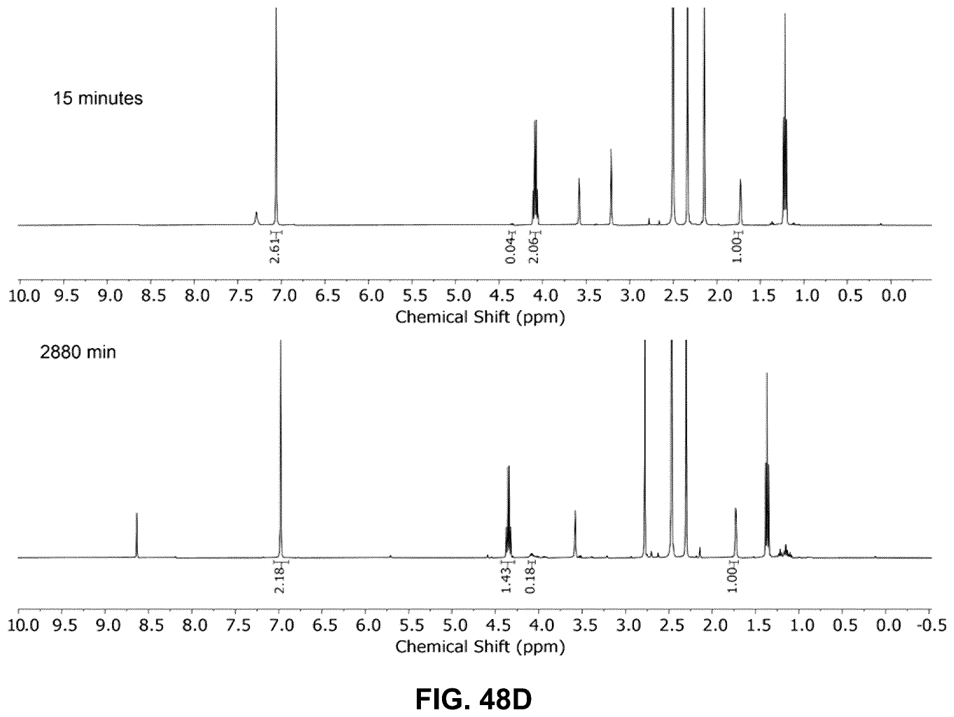

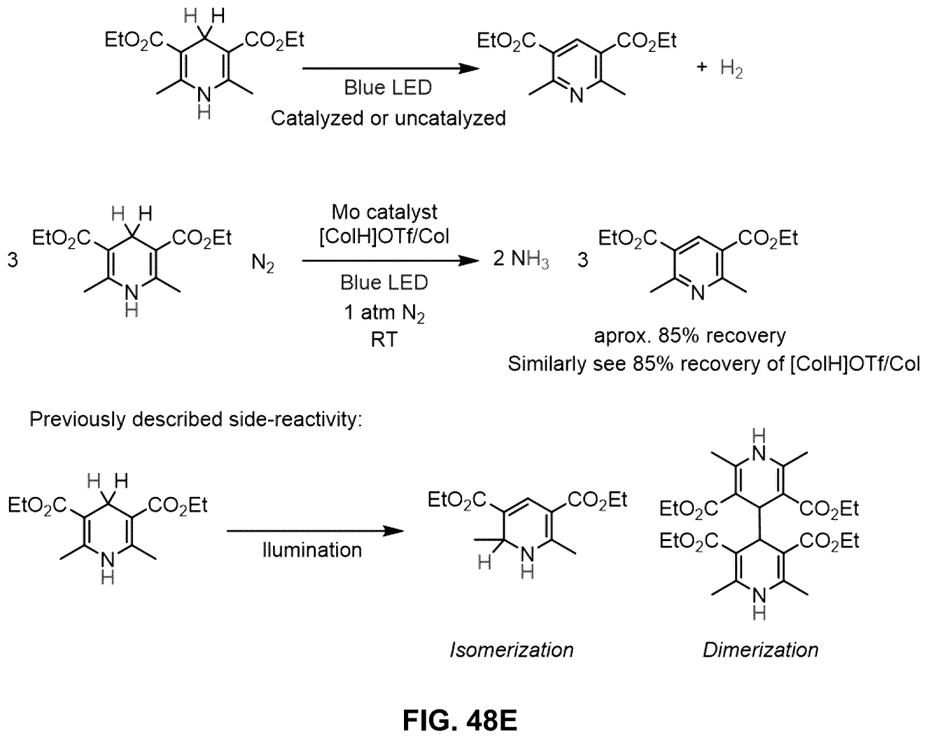

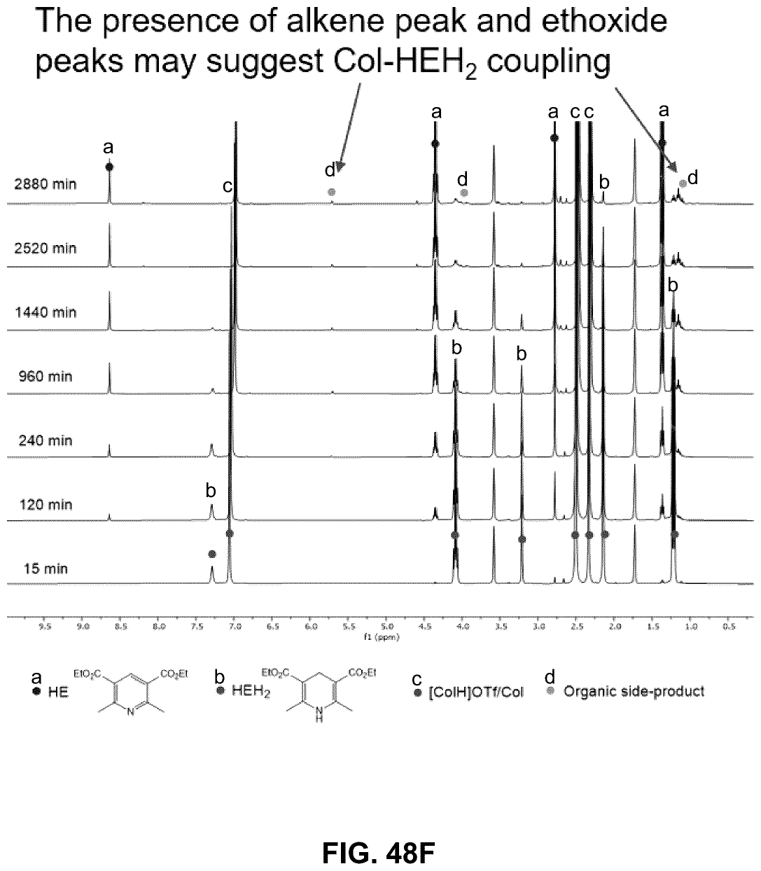

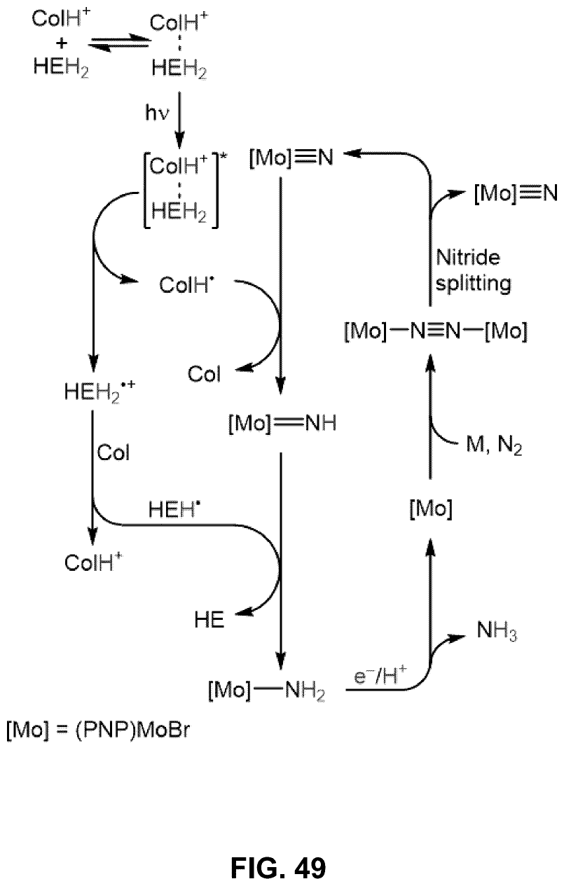

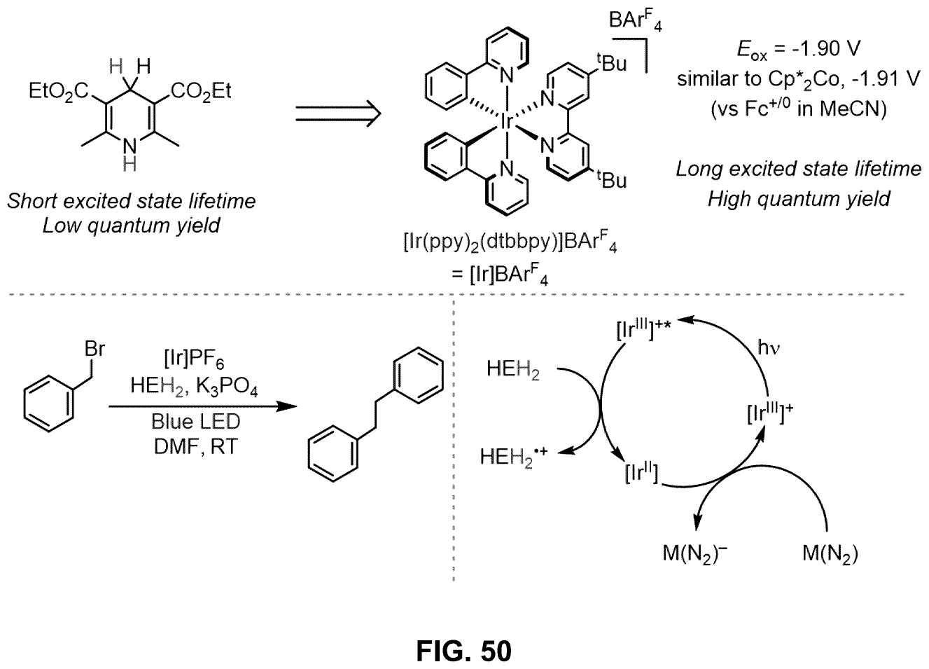

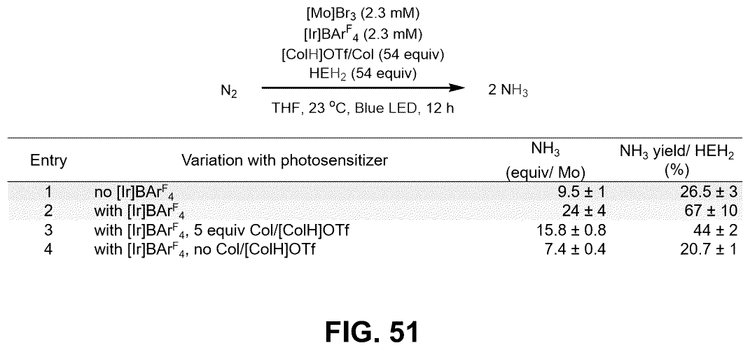

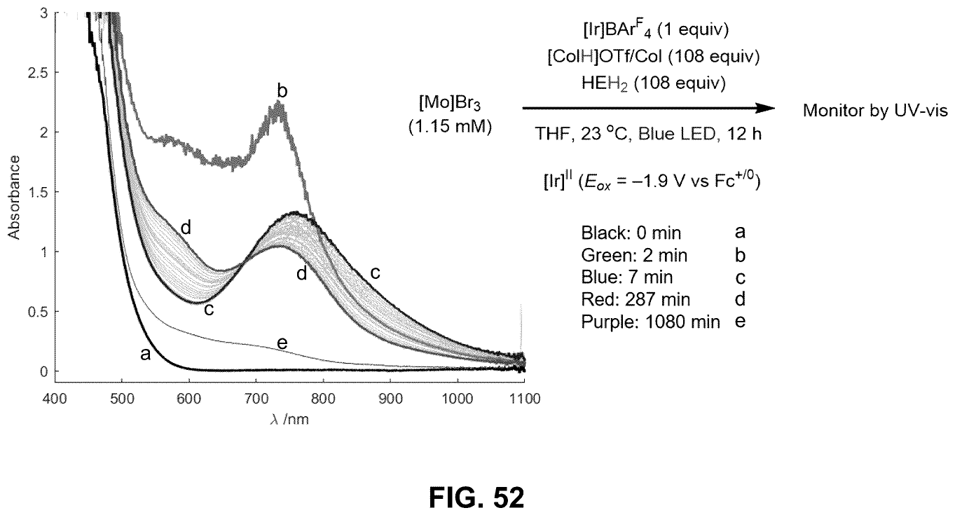

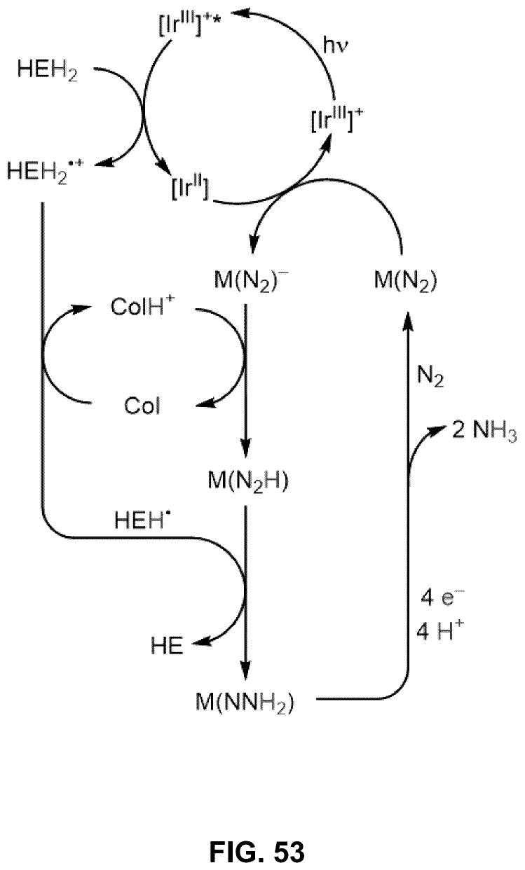

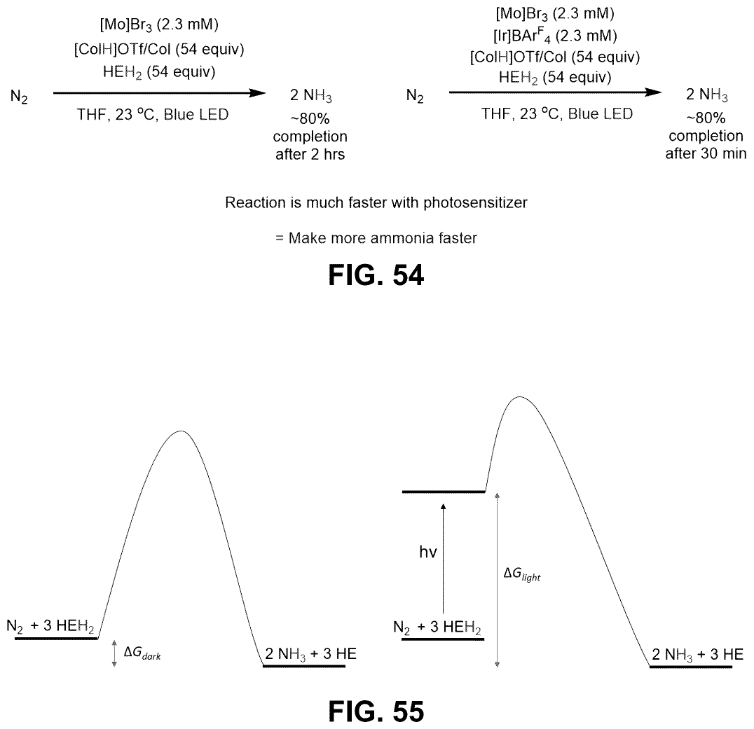

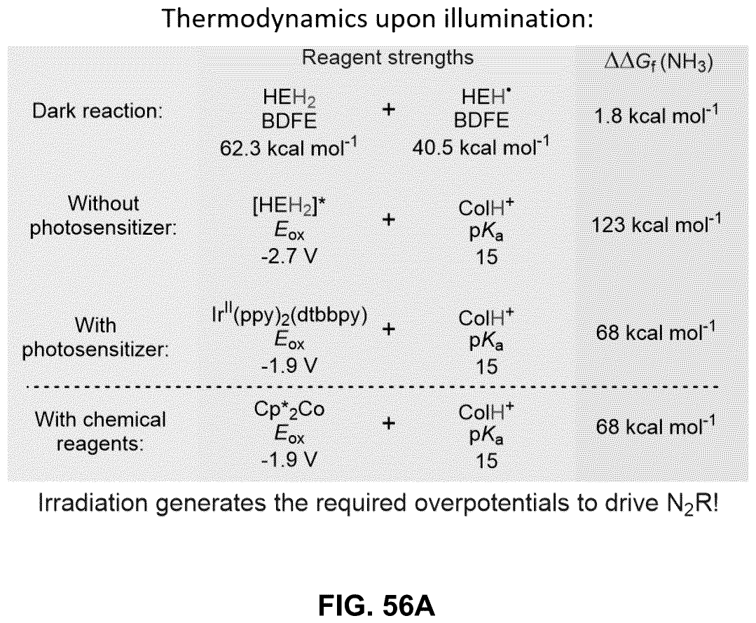

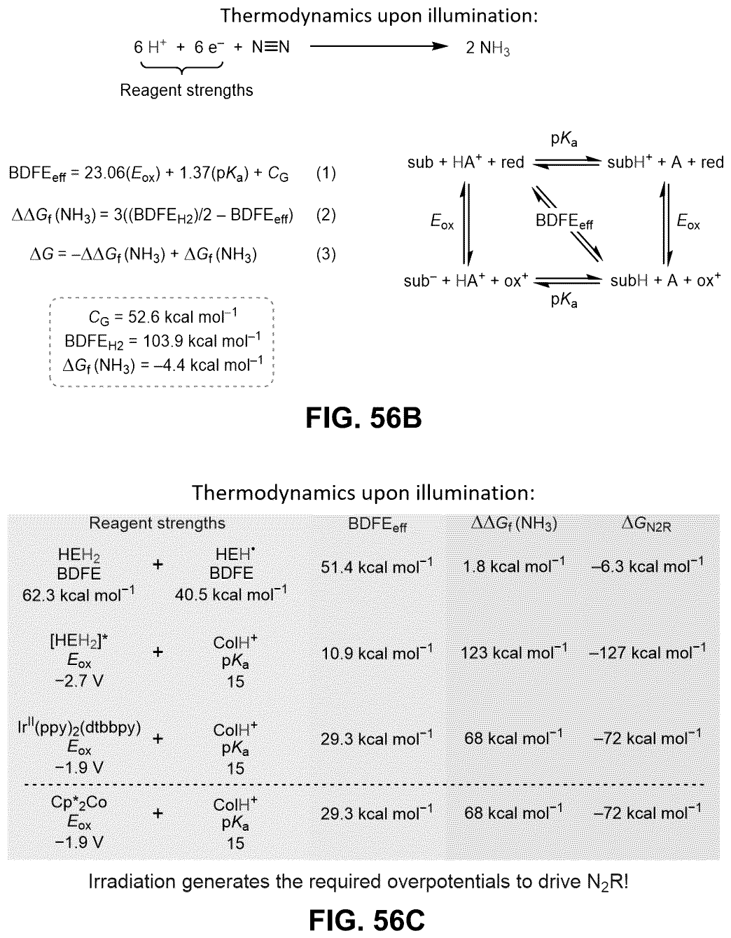

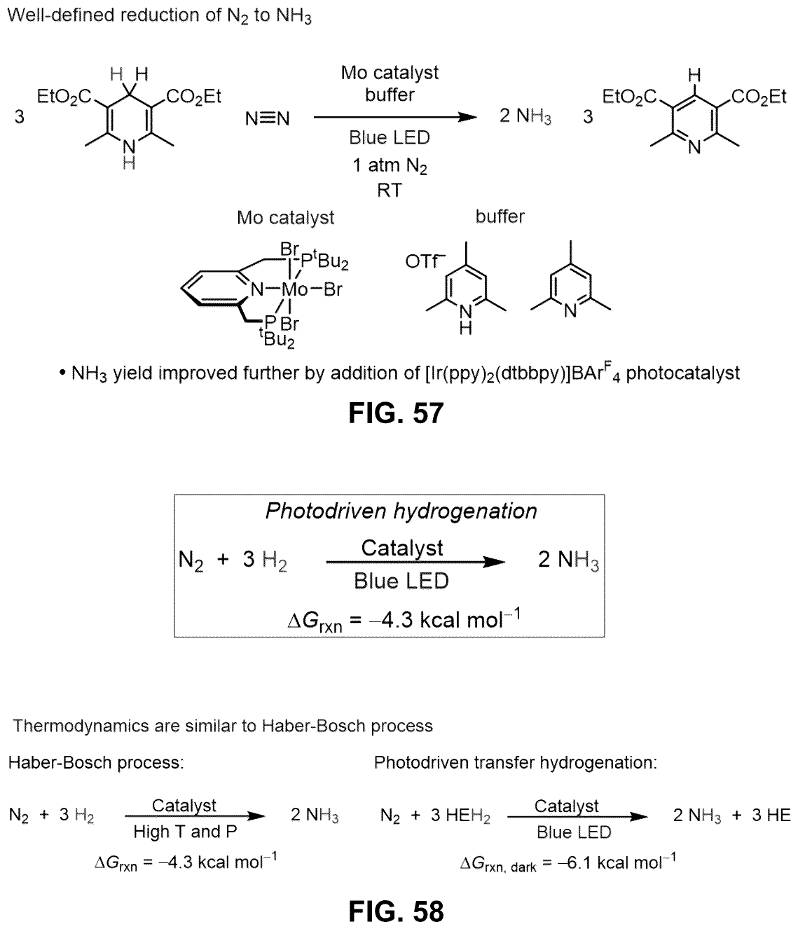

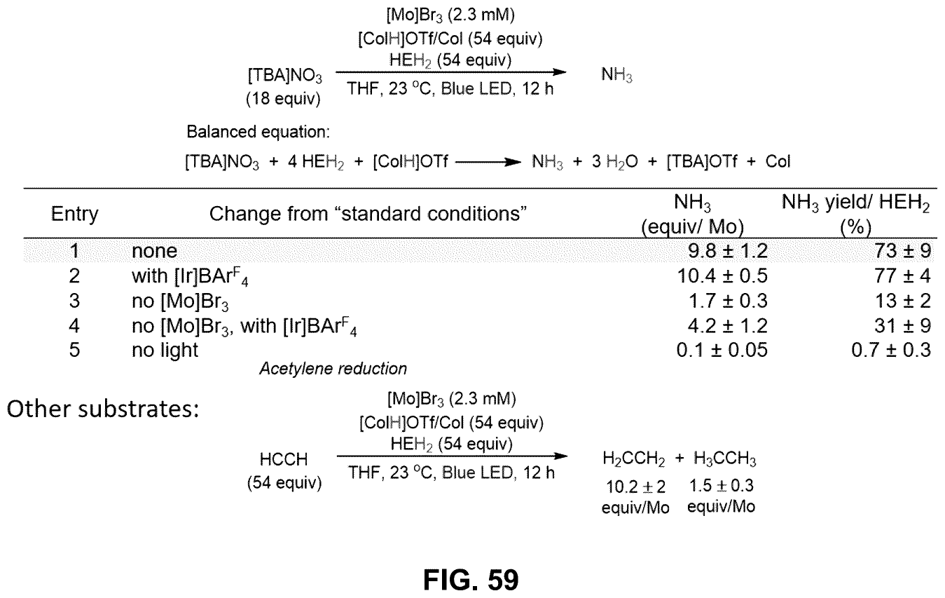

FIG. 3A provides a generalized mechanistic outline to help illustrate how a photon might facilitate delivery of H₂ from HEH₂ to M(N₂), to first generate an M(NNH₂) intermediate, and ultimately NH₃ via successive H₂-transfers. For simplicity we show only this one scenario in FIG. 3A but emphasize that other scenarios, including the early generation and then reduction of a terminal nitride intermediate (Mo≡N+HEH₂→Mo(NH₂)+HE) (FIGS. 25A-25B), are also very plausible.(26) A recent study showed that a Mn^{v}≡N can be photoreduced by 9,10-dihydroacridine to liberate NH₃.(27)

Limitations stemming from a short [HEH₂]* excited-state lifetime and low quantum yield (0.031)(Error! Bookmark not defined.) for HEH₂ motivates exploring a photosensitizer to enhance this photodriven catalysis. To test this idea, [Ir(ppy)₂(dtbbpy)]BAr^{F}₄ ([Ir]BAr^{F}₄; E_{1/2}(Ir^{III/II})˜−1.90 V) is chosen as its reduction potential is close to that of Cp*₂Co and hence should be compatible with N₂R using [Mo]Br₃.(Error! Bookmark not defined,28)

Including [Ir]BAr^{F}₄ with [Mo]Br₃ (1 equiv, both at 2.3 mM), in addition to 54 equiv each of HEH₂ and Col/[ColH]OTf in THF, under an N₂ atmosphere and blue LED irradiation for 12 hours at room temperature, yields 24±4 equiv of NH₃/Mo (entry 10). Assuming HEH₂ is a 2e⁻/2 H⁺ donor, these conditions correspond to an overall NH₃ yield of 67±10% with respect to HEH₂. Furthermore, in the presence of the Ir photosensitizer, catalytic amounts of buffer can be used, producing 15.8±0.8 equiv NH₃/Mo (entry 11). In addition to higher yields, the inclusion of [Ir]BAr^{F}₄ enhances the photocatalytic rate; the catalysis is ˜80% complete after 30 minutes (entry 12). By contrast, under Ir-free conditions, 2 hour reaction times are required to achieve ˜80% completion (entry 13). Comparing this photodriven Mo-catalyzed N₂R via HEH₂ with thermally driven Mo-catalyzed N₂R using (Cp*)₂Co and [ColH]OTf as reported by Nishibayashi, we find the NH₃ yields with respect to reductant to be quite similar (69% for the latter case).(Error! Bookmark not defined.)

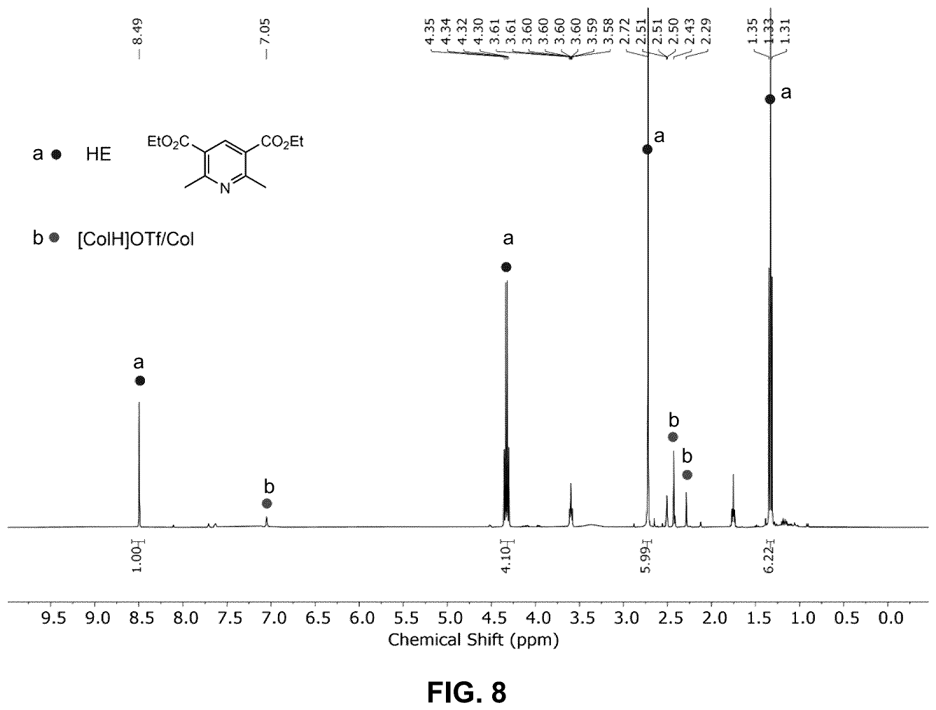

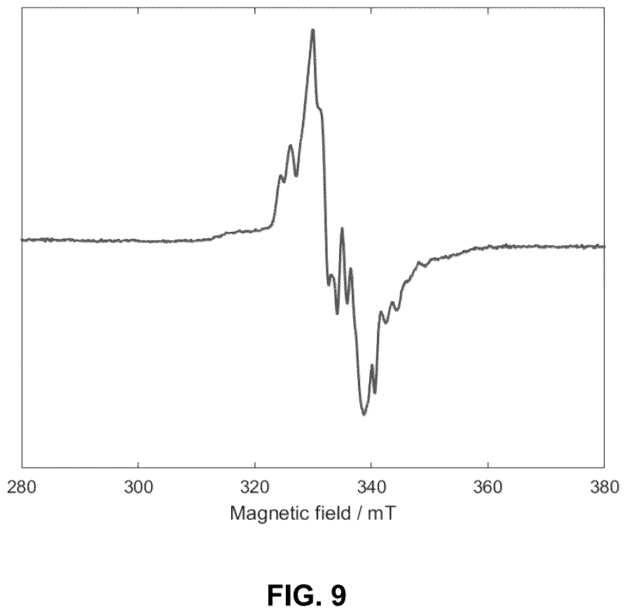

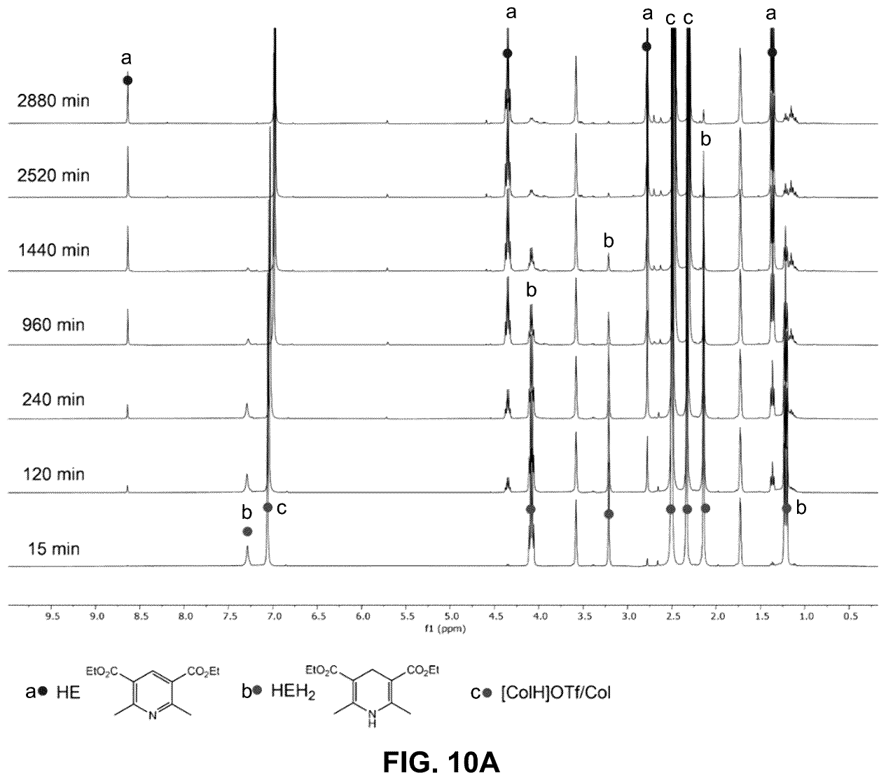

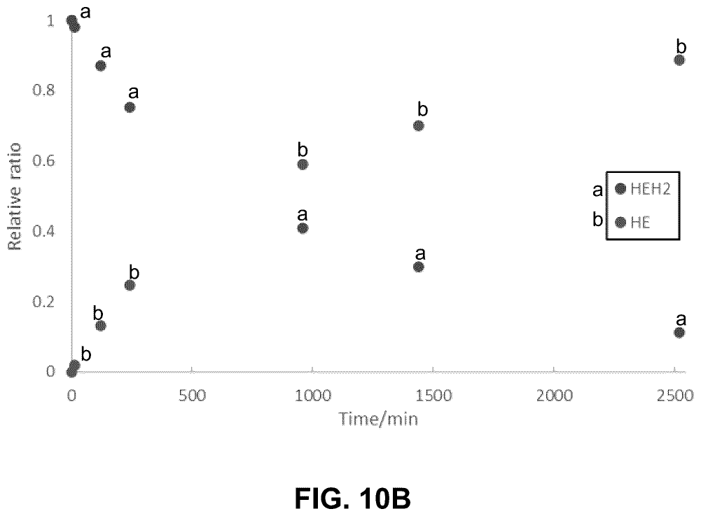

As in the Ir-free process, lowering the [Mo]Br₃ loading increased turnover for NH₃ with catalytic buffer (26.0±0.4 equiv NH₃/Mo, entry 14), but with decreased total yield. No NH₃ is produced without irradiation (Entry 16), and the presence of [Mo]Br₃ and HEH₂ are likewise essential (Entries 16-17). Similar to the Ir-free reaction, HE was found to be the major organic product (>80%) and complete consumption of HEH₂ was observed (FIG. 8). Solvent screening suggests that the reaction is most efficient when all components are soluble (see Table 5). By contrast, other catalytic N₂R methods rely on low solubility of either the acid or reductant to attenuate competing H₂ evolution, demonstrating an advantage to using a terminal H-atom source which is not competent for H₂ release in the ground state.(Error! Bookmark not defined.)

A range of candidate H₂ carriers, subH₂, should be explored in future studies to identify donors whose spent products can be recycled efficiently, perhaps in situ, via hydrogenation with H₂ or electrochemically (2e⁻/2 H⁺). In an initial survey, the Ir-photosensitizer cocatalyst enables catalytic production of NH₃ under irradiation with 9,10-dihydroacridine or 5,6-dihydrophenanthridine as the H₂ donor (6.4±0.3 equiv NH₃/Mo and 4.6±0.8 equiv NH₃/Mo, respectively, entries 18-19). While non-catalytic, N₂-to-NH₃ conversion is also achieved with [Ir]BAr^{F}₄ and the hydride donor 1-benzyl-1,4-dihydronicotinamide (1.2±0.1 equiv NH₃/Mo, entry 20). In the absence of [Ir]BAr^{F}₄, none of these H₂ or H⁻ carriers are competent for the photoinduced N₂RR (see Table 2). The reaction with HEH₂ tolerates a 1:1 mixture of N₂ and H₂ (1 atm total pressure, 14±4 equiv NH₃/Mo, entry 21), indicating that the Mo-catalyst is not (at least irreversibly) poisoned by H₂ under these conditions, important for considering downstream recycling of the spent donor.

In addition to varying the subH₂ we have examined the effect of varying the Ir-photosensitizer. [Ir(dF(CF₃)ppy)₂(dtbbpy)]PF₆ yielded substantially less NH₃ (entry 22) than [Ir]PF₆ (entry 23) or [Ir]BAr^{F}₄ (entries 10 and 12, FIG. 2). [Ir^{II}(dF(CF₃)ppy)₂(dtbpy)] is also less reducing (E_{1/2}(Ir^{III/II})=−1.75 V), possibly pointing to a redox based cut-off for photodriven N₂R. Accordingly, [Ir(p-F(Me)ppy)₂(dtbbpy)]PF₆ (E_{1/2}(Ir^{III/II})˜−1.88 V) restores the yields observed in the parent system (entry 24).(30) However, Ir(ppy)₃, despite having the strongest reduction potential (E_{1/2}(Ir^{III/II})=−2.57 V), gave attenuated NH₃ yields (entry 25) and therefore suggests multiple factors may be at play.

FIG. 3B provides a working model to account for the role of [Ir]BAr^{F}₄. Upon excitation of [Ir^{III}]⁺ to [Ir^{III}]⁺*, reductive quenching by HEH₂ would generate [Ir^{II}], as has been established in related reductions of organic substrates (FIG. 3B).(Error!Bookmark not defined.) This proposed pathway is consistent with the lack of enhancement observed with Ir(ppy)₃, with which reductive quenching by HEH₂ is very uphill(E_{1/2}(*Ir^{III/II})˜−0.08 V, (E_{1/2}(HEH₂⁰/*)=0.48 V).(Error! Bookmark not defined.) The resulting radical cation HEH₂*⁺ is then deprotonated by Col, mitigating back-electron transfer from [Ir^{II}]. As noted above, [Ir^{II}] is assumed to be sufficiently reducing to generate an M(N₂)— species from M(N₂). The former would then undergo protonation by [ColH]⁺ to form an N—H bond via M(N₂H), which itself can be reduced further by diffusing HEH* to generate M(NNH₂). As noted for FIG. 3A, this series of steps is plausible but is only one of several related scenarios that may be viable (e.g., [Ir^{II}] might be oxidized by [ColH]⁺ instead of a [Mo]-species) and future mechanistic studies are needed.

In contrast to the Ir-free conditions, the system with the photosensitizer remains catalytically competent even without added buffer, albeit with an attenuation in turnover (7.4±0.4 equiv NH₃/Mo, entry 22). Presumably, under a Col/[ColH]⁺-free cycle, the liberated radical cation HEH₂*⁺ (formed via reductive quenching) can be consumed via proton or H-atom transfer with a [Mo]NₓH_{y} intermediate.

Having established photodriven transfer hydrogenation as a viable strategy for N₂R, we have begun to explore the deep reduction of other substrates. While success here will ultimately be best realized by exploring a broader array of transition metal catalysts, promising early results with the [Mo]Br₃ catalyst discussed herein include the complete reduction of nitrate to ammonia (8e⁻/9 H⁺) and acetylene to ethylene (major product, 2e⁻/2 H⁺) and ethane (minor product, 4e⁻/4 H⁺). These transformations have been previously explored by photochemical methods, including with semiconductors as for N₂. (31,32) Also of relevance is the photoinduced hydroalkylation of alkynes using Hantzsch ester derivatives, though transfer hydrogenation from HEH₂ to acetylene has not to our knowledge been previously reported. (33)

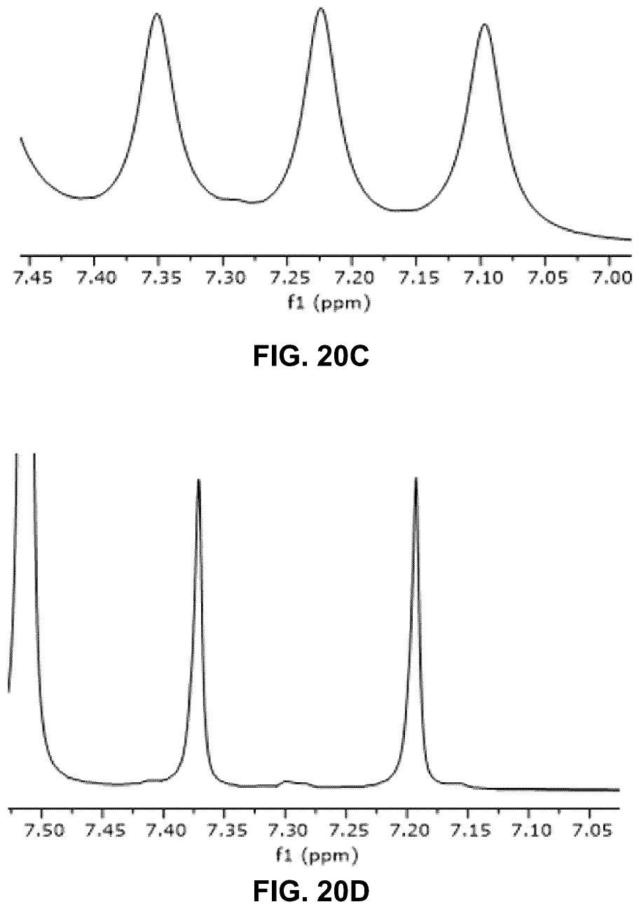

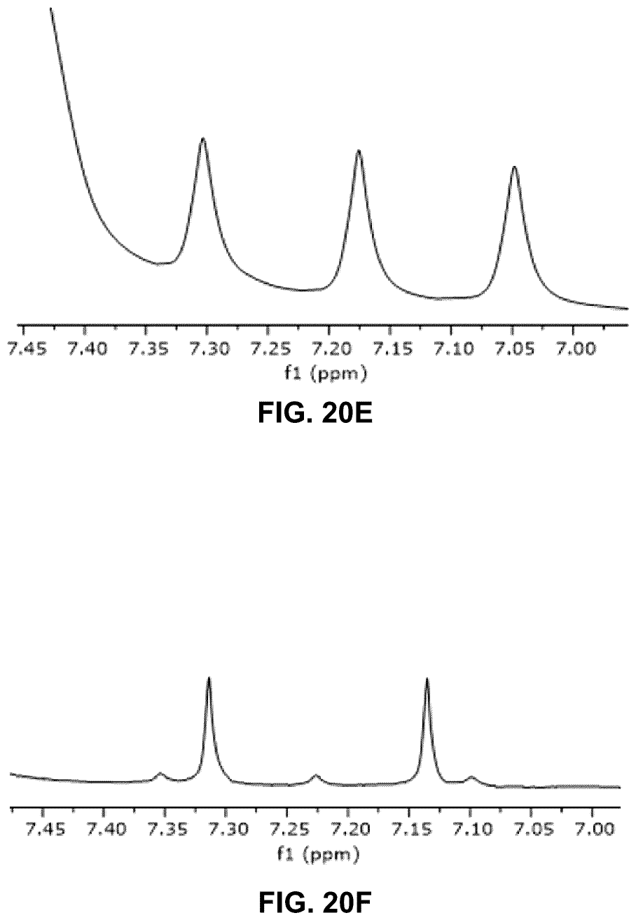

Reduction of [TBA]NO₃ with HEH₂ in the presence of buffer and [Mo]Br₃ under blue LED irradiation and argon atmosphere yields 9.8±1.2 equiv NH₃/Mo, representing a 73±9% yield with respect to HEH₂ (FIG. 2, entry 27). The reaction carried out with [TBA]¹⁵NO₃ yielded ¹⁵NH₃ (FIGS. 20A-20F), confirming NO₃ as the source of N-atoms. In contrast to N₂R, addition of [Ir]BAr^{F}₄ did not enhance catalysis (entry 28). Distinct from N₂ as the substrate where no background reactivity is observed (entry 3), there is some background reactivity for NO₃ even in the absence of the Mo-catalyst; this reactivity is enhanced by the Ir-photocatalyst (entries 29-30). Only trace NH₃ was detected in the absence of light (entry 31).

The reduction of acetylene under the same conditions (HEH₂, Col/[ColH]OTf buffer, and [Mo]Br₃ under blue LED irradiation and argon atmosphere) provides a mixture of ethylene and ethane in a ˜6:1 ratio and a total yield of 24±5% with respect to HEH₂ (entry 32). Addition of [Ir]BAr^{F}₄ to this reaction marginally decreases the yield (entry 33). However, as in the NO₃ reduction reaction, [Ir]BAr^{F}₄ enhances Mo-free reactivity (entries 34-35). Again, no reduced products could be detected in the absence of light (entry 36). In sum, each of these three substrates (N₂, NO₃—, HCCH) illustrate the capacity of HEH₂ to deliver H₂ equivalents via photodriven transfer hydrogenation.

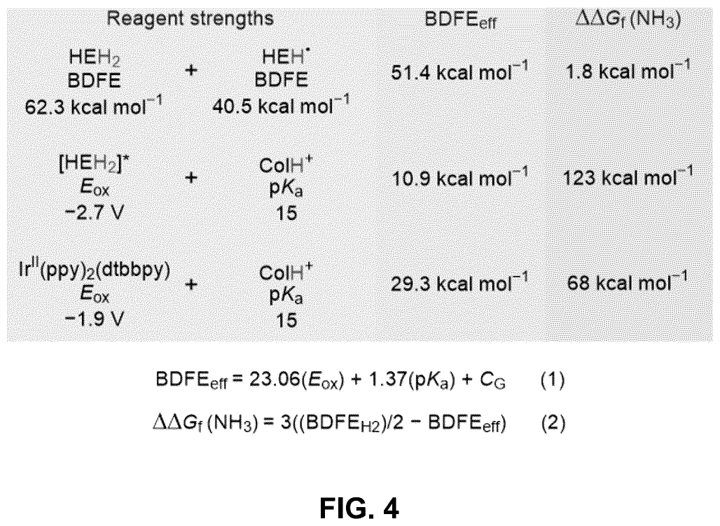

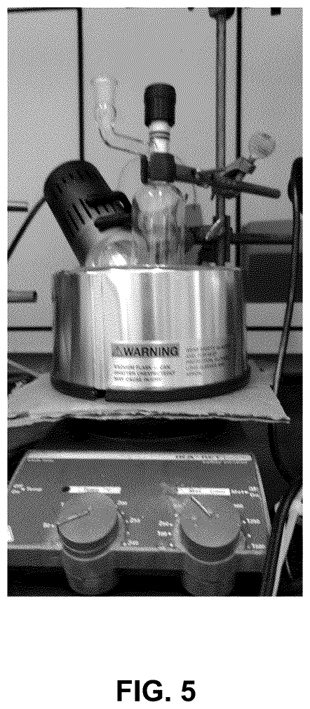

To close, it is instructive to consider the thermodynamics of the photodriven N₂R system described here and its hypothetical dark reaction (FIG. 1C). To do this one can compare the BDFE_{eff} (FIG. 4, eqn 1), a measure of the thermodynamics of H-atom transfer from a set of reagents, to the BDFE of H₂ (103.9 kcal mol⁻¹). (34,35,36) The difference between these values provides an overpotential for N₂ hydrogenation, expressed as ΔΔG_{f}(NH₃) (eqn 2). (37) For the dark reaction, the BDFE_{eff} is the average of the first (C—H) and second (N—H) BDFE's for HEH₂ and HEH⁺, respectively, correlating to a very small overpotential (ΔΔG_{f}(NH₃)=1.8 kcal mol⁻¹).(Error! Bookmark not defined.) NH₃ synthesis via transfer hydrogenation from HEH₂ to N₂ is therefore thermodynamically comparable to N₂ hydrogenation by the Haber-Bosch process. Where the latter uses high temperature and pressure to overcome the high kinetic barrier, the photodriven process described here obtains excess driving force directly from visible light. More specifically, under conditions that exclude the photosensitizer, using the estimated excited-state reduction potential of [HEH₂]* and the pKₐ of [ColH]* to estimate BDFE_{eff}, blue light affords access to a large added driving force (ΔΔG_{f}(NH₃)=123 kcal mol-1; FIG. 4) to push the transfer hydrogenation forward. In the presence of the Ir-photosensitizer, a smaller but still significant driving force (ΔΔG_{f}(NH₃)=68 kcal mol-1) is available. Regardless, the key point is that light generates an overpotential from an otherwise unreactive source of 2e⁻/2 H⁺ stored within HEH₂ that is sufficient to perform, via successive transfers, a net 6e⁻/6 H⁺ reduction of N₂ in the presence of an appropriate catalyst and cocatalyst buffer, with additional benefit gained from inclusion of a photoredox cocatalyst. Important future goals for the work presented here include extensive mechanistic studies as well as studies aimed at in situ recycling of the spent HE back to HEH₂.

Exemplary materials, techniques, steps, methods, and other aspects: Materials and Methods

To develop and study photodriven N₂R we conducted catalytic experiments and quantified the NH₃ products and used additional mechanistic experiments to better understand the mechanism.

Optionally, the experiments described above are carried out under an N₂ atmosphere, such as in a glovebox. Solvents are optionally deoxygenated and dried by thoroughly sparging with N₂ followed by passage through an activated alumina column in a solvent purification system. Nonhalogenated solvents are optionally tested with sodium benzophenone ketyl in tetrahydrofuran (THF) to confirm the absence of oxygen and water. Deuterated solvents are optionalled degassed, and dried over activated 3-A molecular sieves prior to use.

HEH₂, (38) PNPMoBr₃, (Error! Bookmark not defined.) [ColH]OTf(Error!Bookmark not defined.), [P₃BFe]BAr^{F}₄ (p₃^{B}=tris[2-(diisopropylphosphino)phenyl]borane)(39), BTH₂, (Error! Bookmark not defined.) NaBAr^{F}₄, (40)¹⁵N-Col, (41) phenH₂, (42) phenazH₂, (43) [TBA]¹⁵NO₃ (44) are optionally prepared according to literature procedures. Triflic acid, ethylacetoacetate, and 37% aqueous formaldehyde were purchased from Sigma Aldrich and used without further purification. Ir(ppy)₃, Ir(ppy)₂(dtbbpy)[PF₆], [Ir(dF(CF₃)ppy)₂(dtbbpy)]PF₆, [Ir(p-F(Me)ppy)₂(dtbbpy)]PF₆ are optionally purchased and used without further purification. [TBA]NO₃ is optionally purchased and dissolved in THF, filtered over activated alumina to dry and purify prior to use. Collidine is optionally distilled prior to use. 9,10-dihydroacridine (98%). Tetrahydrofuran (THF) used in the experiments herein is optionally stirred over Na/K (12 hours) and filtered over activated alumina or vacuum-transferred before use unless otherwise stated.

An exemplary source of blue light is Kessil® 34 W 150 Blue lamp.

Spectroscopy: NMR: Nuclear Magnetic Resonance (NMR) measurements are recorded with a Varian 400 MHz spectrometer. ¹H NMR chemical shifts are reported in ppm relative to tetramethylsilane, using ¹H resonances from residual solvent as internal standards. (45) EPR Spectroscopy

UV-Vis: Ultraviolet-visible (UV-vis) absorption spectroscopy measurements were collected with a Cary 50 UV-vis spectrophotometer using a 1 cm path length quartz cuvette. All samples had a blank sample background subtraction applied.

EPR Spectroscopy: All X-band continuous-wave electron paramagnetic resonance (CW-EPR) spectra were obtained on a Bruker EMX spectrometer using a quartz liquid nitrogen immersion dewar on solutions prepared as frozen glasses in 2-MeTHF, unless otherwise noted.

Steady-state fluorimetry. Steady-state fluorimetry was performed in the Beckman Institute Laser Resource Center (BILRC; California Institute of Technology). Samples for luminescence measurements were prepared in dry THF and transferred to a 1-cm pathlength fused quartz cuvette sealed with a high-vacuum Teflon valve (Kontes). Steady-state emission spectra were collected on a Jobin S4 Yvon Spec Fluorolog-3-11 with a Hamamatsu R₉₂₈P photomultiplier tube detector with photon counting.

Exemplary NH₃ Generation Reaction Procedure: All solvents are stirred with Na/K for 2 hours and filtered prior to use. In a nitrogen-filled glovebox, the precatalysts ([Mo]Br₃ and/or [Ir]BAr^{F}₄) (2.3 μmol) are weighed in individual vials. The precatalysts are then transferred quantitatively into a Schlenk tube using THF and the THF is then evaporated to provide a thin film of precatalyst. The tube is then charged with a stir bar and the acid and Hantzsch ester (HEH₂) are added. The tube is cooled to 77 K in a cold well. The base ([Col]) is dissolved in 1 mL solvent. To the cold tube is added the 1 mL solution of base and solvent to produce a concentration of precatalyst of 2.3 mM. The temperature of the system is allowed to equilibrate for 5 minutes and then the tube is sealed with a Teflon screw-valve. This tube is passed out of the box into a liquid N₂ bath and transported to a fume hood. For experiments run at −78° C. the tube is then transferred to a dry ice/isopropanol bath where it thaws and is allowed to stir under blue LED irradiation at −78° C. for minimum three hours before warming. For experiments run at 23° C. the tube is instead transferred to a water bath where it thaws and is allowed to stir for 12 hours. To ensure reproducibility, all experiments were conducted in 200 mL Schlenk tubes (50 mm OD) using 10 mm eggshaped-stir bars and stirring was conducted at ˜600 rpm. Both the water bath and the dry ice/isopropanol bath were contained in highly reflective dewars. The Blue LED was placed above the bath as close to the stirring reaction as possible.

NH₃ detection by optical methods: Reaction mixtures are cooled to 77 K and allowed to freeze. The reaction vessel is then opened to atmosphere and to the frozen solution is slowly added excess of a solution of HCl (3 mL of a 2.0 M solution in Et₂O, 6 mmol) over 1-2 minutes. This solution is allowed to freeze, then the headspace of the tube is evacuated and the tube is sealed. The tube is then allowed to warm to RT and stirred at RT for at least 10 minutes. Solvent is removed in vacuo, and the solids are extracted with 1 M HCl(aq) and filtered to give a total solution volume of 10 mL. A 5 mL aliquot is taken and washed repeatedly with n-butanol to remove Hantzsch pyridine (HE) and collidinium. After n-butanol washing additional 1 M HCl(aq) is added to give a final total volume of 5 mL. From these 5 mL solutions, a 100 μL aliquot is analyzed for the presence of NH₃ (present as [NH₄][Cl]) by the indophenol method. Quantification was performed with UV-vis spectroscopy by analyzing the absorbance at 635 nm. (46) When specified a further aliquot of this solution was analyzed for the presence of N₂H₄ (present as [N₂H₅][Cl]) by a standard colorimetric method. (47) Quantification was performed with UV-vis spectroscopy by analyzing the absorbance at 458 nm.

NH₃ detection by ¹H NMR: Reaction mixtures are cooled to 77 K and allowed to freeze. The reaction vessel is then opened to atmosphere and to the frozen solution is slowly added an excess (with respect to acid) solution of a NaO^{t}Bu solution in MeOH (0.25 mM) over 1-2 minutes. This solution is allowed to freeze, then the headspace of the tube is evacuated and the tube is sealed. The tube is then allowed to warm to RT and stirred at RT for at least 10 minutes. An additional Schlenk tube is charged with HCl (3 mL of a 2.0 M solution in Et₂O, 6 mmol) to serve as a collection flask. The volatiles of the reaction mixture are vacuum transferred at RT into this collection flask. After completion of the vacuum transfer, the collection flask is sealed and warmed to RT. Solvent is removed in vacuo, and the remaining residue is dissolved in 0.7 mL of DMSO-d₆ containing 20 mM 1,3,5-trimethoxybenzene as an internal standard. Integration of the ¹H NMR peak observed for NH₄⁺ is then integrated against the two peaks of trimethoxybenzene to quantify the ammonium present. This ¹H NMR detection method was also used to differentiate [¹⁴NH₄][Cl] and [¹⁵NH₄][Cl] produced in the control reactions conducted with ¹⁵N₂, ¹⁵N-Col/[ColH]OTf, or ¹⁵N—HEH₂.

Exemplary [TBA]NO₃ reduction reaction procedure: Catalytic experiments for the reduction of [TBA]NO₃ were conducted in a manner similar to the reduction of N₂. The precatalysts, solids and stir-bar are added in the same way, with [TBA]NO₃ included with the other solids. The tube is cooled to 77 K in a cold well and the base ([Col]) is added as well. The tube is then passed out of the glovebox without warming and thoroughly degassed. 1 mL of degassed THF solvent was vacuum transferred into the catalytic tube. The tube was allowed to warm briefly, and was back-filled with argon. The tube is instead transferred to a water bath and completed like the N₂ reduction reaction.

Exemplary acetylene reduction reaction procedure: Catalytic experiments for the reduction of acetylene were conducted in a manner similar to the reduction of N₂. The precatalysts, solids and stir-bar are added in the same way. The tube is wrapped in aluminum foil and Col and THF-d₈ (0.7 mL) are added. The tube is sealed, passed out of the glovebox, and degassed (three freeze-pump thaw cycles). The desired volume of acetylene gas is added using a calibrated bulb while the tube is cooled in liquid nitrogen. The headspace of the tube is then backfilled to 1 atm with argon while cooled in a dry ice/acetone bath. The tube is transferred to a water bath and is irradiated with Blue LED for the time specified.

After 12 hours of irradiation, the volatiles of the reaction mixture are vacuum transferred into a J. Young NMR tube of known volume containing a known amount of 1,3,5-trimethoxybenzene. In the ¹H NMR spectrum of the resulting sample, the peaks corresponding to ethylene (5.36 ppm) and ethane (0.85 ppm) are clearly distinguishable when present.(Error! Bookmark not defined.) Integration to the internal standard provides the yield of dissolved gases. Henry's constant for each gas in THF(48) was used to estimate their partial pressures in the headspace.

Exemplary Synthetic Aspects:

¹⁵N-labelled 2,6-Dimethyl-3,5-dicarboethoxy-1,4-dihydropyridine (¹⁵N—HEH₂). Adapted from ref Error! Bookmark not defined. Aqueous formaldehyde (37%, 78 μL) and ethylacetoacetate (280 μL, 2.19 mmol) were placed in a 10 mL round-bottom flask equipped with a stir bar and fitted with a reflux condenser. ¹⁵NH₄Cl (305 mg, 5.7 mmol) in 1 mL H₂O was added to a 1 mL aqueous solution of NaOH (228.3 mg, 5.7 mmol). The resulting solution of ¹⁵NH₄₀H was added to the flask through the neck of the condenser. The condenser neck was rinsed into the flask with 0.5 mL ethanol. The reaction mixture was heated at reflux for 1.5 hrs and then chilled in an ice bath. The resulting precipitate was collected by filtration and washed with cold ethanol (˜3 mL) and Et₂O to yield the title compound as a pale yellow powder (60 mg, 22% yield). ¹H NMR (400 MHz, DMSO-d₆) δ 8.28 (d, ¹J_{H,N}=94.6 Hz, 1H), 4.05 (q, J=7.1 Hz, 4H), 3.11 (s, 2H), 2.11 (d, J=2.9 Hz, 6H), 1.19 (t, J=7.1 Hz, 6H) ppm.

¹⁵N-labelled 2,4,6-Dimethylpyridinium (¹⁵N—[ColH]OTf). Identical procedure to what has previously been reported with unlabeled Col was employed.(Error! Bookmark not defined.)¹H NMR (400 MHz, DMSO-d₆) δ 14.87 (broad s, 1H), 7.57 (d, ³J_{H,N}=2.8 Hz, 2H), 2.62 (d, ³J_{H,N}=2.9 Hz, 6H), 2.49 (s, 3H) ppm.

[4,4′-Bis(1,1-dimethylethyl)-2,2′-bipyridine-N1,N1′]bis[2-(2-pyridinyl-N)phenyl-C]iridium(III) Tetrakis(3,5-bis(trifluoromethyl)phenyl)borate ([Ir]BAr^{F}₄). Ir(ppy)₂(dtbbpy)[PF₆] (100 mg, 0.11 mmol) and Na[BAr^{F}₄] (92.2 mg, 0.10 mmol, 0.95 eq) were stirred in 5 mL Et₂O at room temperature for 1 hour. The solution was filtered through celite, layered with pentane and stored at −40° C. overnight to yield the title compound as yellow crystals (161 mg, 90% yield). ¹H NMR (400 MHz, MeCN-d₃) δ 8.48 (s, 2H), 8.06 (d, 2H, J=8.2 Hz), 7.93-7.76 (m, 6H), 7.74-7.64 (m, 10H), 7.58 (d, J=5.8 Hz, 2H), 7.50 (dd, J=5.9, 1.9 Hz, 2H), 7.03 (t, J=6.8 Hz, 2H), 6.91 (t, J=6.8 Hz, 2H), 6.28 (d, J=6.3 Hz, 2H), 1.40 (s, 18H) ppm.

### REFERENCES

1. M. J. Chalkley, M. W. Drover, J. C. Peters, Catalytic N₂-to-NH₃ (or —N₂H₄) conversion by well-defined molecular coordination complexes. Chem. Rev. 120, 5582-5636 (2020).
2. Y. Nishibayashi, Development of catalytic nitrogen fixation using transition metal-dinitrogen complexes under mild reaction conditions. Dalton Trans. 47, 11290-11297 (2018).
3. R. R. Schrock, Catalytic reduction of dinitrogen to ammonia by molybdenum: theory versus experiment. Angew. Chem. Int. Ed. 47, 5512-5522 (2008).
4. L. C. Seefeldt, B. M. Hoffman, J. W. Peters, S. Raugei, D. N. Beratan, E. Antony, D. R. Dean, Energy transduction in Nitrogenase. Acc. Chem. Res. 51, 2179-2186 (2018).
5. V. Smil, Enriching the Earth: Fritz Haber, Carl Bosch, and the Transformation of World Food Production (MIT Press, Cambridge, M A, 2000).
6. T. Shima, S. Hu, G. Luo, X. Kang, Y. Luo, Z. Hou, Dinitrogen cleavage and hydrogenation by a trinuclear titanium polyhydride complex. Science 340, 1549-1552 (2013).
7. Y. Yamazaki, H. Takeda, O. Ishitani, Photocatalytic reduction of CO₂ using metal complexes. J. Photochem. Photobiol. C: Photochem. Rev. 25,106-137 (2015).
8. N. Elgrishi, M. B. Chambers, X. Wang, M. Fontecave, Molecular polypyridine-based metal complexes as catalysts for the reduction of CO₂. Chem. Soc. Rev. 46, 761-796 (2017).
9. P.-Z. Wang, J.-R. Chen, W.-J. Xiao, Hantzsch esters: an emerging versatile class of reagents in photoredox catalyzed organic synthesis. Org. Biomol. Chem. 17, 6936-6951 (2019).
10. Q.-A. Chen, M.-W. Chen, C.-B. Yu, L. Shi, D.-S. Wang, Y. Yang, Y.-G. Zhou, Biomimetic asymmetric hydrogenation: in situ regenerable Hantzsch esters for asymmetric hydrogenation of benzoxazinones. J. Am. Chem. Soc. 133, 16432-16435 (2011).
11. G. M. Abou-Elenein, N. A. Ismail, Z. F. Mohammed, H. M. Fahmy, Electroreduction of 2,6-dimethyl-3,4,5-trisubstituted pyridine derivatives in aqueous buffered media at carbon electrode. Egypt. J. Pharmaceutical Sci. 33, 953-962 (1992).
12. B. M. Comer, P. Fuentes, C. O. Dimkpa, Y.-H. Liu, C. A. Fernandez, P. Arora, M. Realff, U. Singh, M. C. Hatzell, A. J. Medford, Prospects and challenges for solar fertilizers. Joule 3, 1578-1605 (2019).
13. G. N. Schrauzer, T. D. Guth, Photolysis of water and photoreduction of nitrogen on titanium dioxide. J. Am. Chem. Soc. 99, 7189-7193 (1977).
14. J. G. Edwards, J. A. Davies, D. L. Boucher, A. Mennad, An opinion on the heterogeneous photoreactions of N₂ with H₂O. Angew. Chem. Int. Ed. 31, 480-482 (1992).
15. A. J. Medford, M. C. Hatzell, Photon-driven nitrogen fixation: current progress, thermodynamic considerations, and future outlook. ACS Catal. 7, 2624-2643 (2017).
16. K. A. Brown, D. F. Harris, M. B. Wilker, A. Rasmussen, N. Khadka, H. Hamby, S. Keable, G. Dukovic, J. W. Peters, L. C. Seefeldt, P. W. King, Light-driven dinitrogen reduction catalyzed by a CdS:nitrogenase MoFe protein biohybrid. Science 352, 448-450 (2016).
17. K. A. Brown, J. Ruzicka, H. Kallas, B. Chica, D. W. Mulder, J. W. Peters, L. C. Seefeldt, G. Dukovic, P. W. King, Excitation-rate determines product stoichiometry in photochemical ammonia production by CdS quantum dot-nitrogenase MoFe protein complexes. ACS Catal. 10, 11147-11152 (2020).
18. G.-B. Shen, Y.-H. Fu, X.-Q. Zhu, Thermodynamic network cards of Hantzsch ester benzothiazoline, and dihydrophenanthridine releasing two hydrogen atoms or ions on 20 elementary steps. J. Org. Chem. 85, 12535-12543 (2020).
19. J. Jung, J. Kim, G. Park, Y. You, E. J. Cho, Selective debromination and α-hydroxylation of α-bromo ketones Using Hantzsch esters as photoreductants. Adv. Synth. Catal. 358, 74-80 (2016).
20. D.-L. Zhu, Q. Wu, H.-Y. Li, H.-X. Li, J.-P. Lang, Hantzsch ester as a visible-light photoredox catalyst for transition-metal-free coupling of arylhalides and arylsulfinates. Chem.—Eur. J. 26, 3484-3488 (2020).
21. K. Arashiba, A. Eizawa, H. Tanaka, K. Nakajima, K. Yoshizawa, Y. Nishibayashi, Catalytic nitrogen fixation via direct cleavage of nitrogen-nitrogen triple bond of molecular dinitrogen under ambient reaction conditions. Bull. Chem. Soc. Jpn. 90, 1111-1118 (2017).
22. S. Tshepelevitsh, A. Kütt, M. Lökov, I. Kaljurand, J. Saame, A. Heering, P. G. Plieger, R. Vianello, I. Leito, On the basicity of organic bases in different media. Eur. J. Org. Chem. 2019, 6735-6748 (2019).
23. N. G. Connelly, W. E. Geiger, Chemical redox agents for organometallic chemistry. Chem. Rev. 96, 877-910 (1996).
24. K. Kano, T. Matsuo, Photoinduced one-electron reduction of 1-benzyl-3-carbamoylpyridinium chloride and 3,5-bis(ethoxycarbonyl)-2,6-dimethylpyridine. Bull. Chem. Soc. Jpn. 49, 3269-3273 (1976).
25. T. Munisamy, R. R. Schrock, An electrochemical investigation of intermediates and processes involved in the catalytic reduction of dinitrogen by [HIPTN₃N]Mo (HIPTN₃N=(3,5-(2,4,6-i-Pr₃C₆H₂)₂C₆H₃NCH₂CH₂)₃N). Dalton Trans. 41, 130-137 (2011).
26. H. Tanaka, K. Arashiba, S. Kuriyama, A. Sasada, K. Nakajima, K. Yoshizawa, Y. Nishibayashi, Unique behaviour of dinitrogen-bridged dimolybdenum complexes bearing pincer ligand towards catalytic formation of ammonia. Nature Commun. 5, 3737-3787 (2014).
27. D. Wang, F. Loose, P. J. Chirik, R. R. Knowles, N—H bond formation in a manganese(V) nitride yields ammonia by light-driven proton-coupled electron transfer. J. Am. Chem. Soc. 141, 4795-4799 (2019).
28. J. D. Slinker, A. A. Gorodetsky, M. S. Lowry, J. Wang, S. Parker, R. Rohl, S. Bernhard, G. G. Malliaras, Efficient yellow electroluminescence from a single layer of a cyclometalated iridium complex. J. Am. Chem. Soc. 126, 2763-2767 (2004).
29. T. Koike, M. Akita, Visible-light radical reaction designed by Ru- and Ir-based photoredox catalysis. Inorg. Chem. Front. 1, 562-576 (2014).
30. A. G. Capacci, J. T. Malinowski, N. J. McAlpine, J. Kuhne, D. W. C. MacMillan, Direct, enantioselective α-alkylation of aldehydes using simple olefins. Nat. Chem. 9, 1073-1077 (2017).
31. H. Hirakawa, M. Hashimoto, Y. Shiraishi, T. Hirai, Selective nitrate-to-ammonia transformation on surface defects of titanium dioxide photocatalysts. ACS Catal. 7, 3713-3720 (2017).
32. A. H. Boonstra, C. A. H. A. Mutsaers, Photohydrogenation of ethyne and ethene on the surface of titanium dioxide. J. Phys. Chem. 79, 2025-2027 (1975).
33. Y. Zhang, Y. Tanabe, S. Kuriyama, Y. Nishibayashi, Photoredox- and nickel-catalyzed hydroalkylation of alkynes with 4-alkyl-1,4-dihydropyridines: ligand-controlled regioselectivity. Chem.—Eur. J. 28, e202200727 (2022).
34. F. G. Bordwell, J. P. Cheng, J. A. Harrelson, Homolytic bond dissociation energies in solution from equilibrium acidity and electrochemical data. J. Am. Chem. Soc. 110, 1229-1231 (1988).
35. M. Tilset, V. D. Parker, Solution homolytic bond dissociation energies of organotransition-metal hydrides. J. Am. Chem. Soc. 111, 6711-6717 (1989).
36. R. G. Agarwal, S. C. Coste, B. D. Groff, A. M. Heuer, H. Noh, G. A. Parada, C. F. Wise, E. M. Nichols, J. J. Warren, J. M. Mayer, Free energies of proton-coupled electron transfer reagents and their applications. Chem. Rev. 122, 1-49 (2022).
37. M. J. Chalkley, J. C. Peters, Relating N—H bond strengths to the overpotential for catalytic nitrogen fixation. Eur. J. Inorg. Chem. 2020, 1353-1357 (2020).
38. B. E. Norcross, G. Clement, M. Weinstein, The Hantzsch pyridine synthesis: A factorial design experiment for the introductory organic laboratory. J. Chem. Educ. 46, 694 (1969).
39. J. S. Anderson, M. E. Moret, J. C. Peters, Conversion of Fe—NH₂ to Fe—N₂ with release of NH₃. J. Am. Chem. Soc. 135, 534-537 (2013).
40. T. J. Del Castillo, N. B. Thompson, J. C. Peters, A synthetic single-site Fe nitrogenase: high turnover, freeze-quench ⁵⁷Fe Mössbauer data, and a hydride resting state. J. Am. Chem. Soc. 138, 5341-5350 (2016).
41. N. S. Golubev, S. N. Smirnov, P. Schah-Mohammedi, I. G. Shenderovich, G. S. Denisov, V. A. Gindin, H. H. Limbach, Study of acid-base interaction by means of low-temperature NMR spectra. Structure of salicylic acid complexes. Russ. J. Gen. Chem. 67,1082-1087 (1997).
42. L. Matesic, J. M. Locke, K. L. Vine, M. Ranson, J. B. Bremner, D. Skropeta, Synthesis and anti-leukaemic activity of pyrrolo[3,2,1-hi]indole−1,2-diones, pyrrolo[3,2,1-ij]quinoline−1,2-diones and other polycyclic isatin derivatives. Tetrahedron 68, 6810-6819 (2012).
43. R. Bri§ ar, F. Unglaube, D. Hollmann, H. Jiao, E. Mejia, Aerobic oxidative homo- and cross-coupling of amines catalyzed by phenazine radical cations. J. Org. Chem. 83, 13481-13490 (2018).
44. L. T. Elrod, E. Kim, Lewis acid assisted nitrate reduction with biomimetic molybdenum oxotransferase Complex. Inorg. Chem. 57, 2594-2602 (2018).
45. G. R. Fulmer, A. J. M. Miller, N. H. Sherden, H. E. Gottlieb, A. Nudelman, B. M. Stoltz, J. E. Bercaw, K. I. Goldberg, NMR Chemical Shifts of trace impurities: common laboratory solvents, organics, and gases in deuterated solvents relevant to the organometallic chemist. Organometallics. 29, 2176-2179 (2010).
46. M. W. Weatherburn, Phenol-hypochlorite reaction for determination of ammonia. Anal. Chem. 39, 971-974 (1967).
47. G. W. Watt, J. D. Chrisp, Spectrophotometric method for determination of hydrazine. Anal. Chem. 24, 2006-2008 (1952).
48. F. Gibanel, M. C. Lopez, F. M. Royo, J. Santafe, J. S. Urieta, Solubility of nonpolar gases in tetrahydrofuran at 0 to 30° C. and 101.33 kPa partial pressure of gas. J. Solution Chem. 22, 211-217 (1993).
49. S. Xu, D. C. Ashley, H.-Y. Kwon, G. R. Ware, C.-H. Chen, Y. Losovyj, X. Gao, E. Jakubikova, J. M. Smith, A flexible, redox-active macrocycle enables the electrocatalytic reduction of nitrate to ammonia by a cobalt complex. Chem. Sci. 9, 4950-4958 (2018).
50. B. M. Lindley, A. M. Appel, K. Krogh-Jespersen, J. M. Mayer, A. J. M. Miller, Evaluating the thermodynamics of electrocatalytic N₂ reduction in acetonitrile. ACS Energy Lett. 1, 698-704 (2016).
51. X.-Q. Zhu, H.-R. Li, Q. Li, T. Ai, J.-Y. Lu, Y. Yang, J.-P. Cheng, Determination of the C4-H bond dissociation energies of NADH models and their radical cations in acetonitrile. Chem. —Eur. J. 9, 871-880 (2003).
52. E. S. Wiedner, M. B. Chambers, C. L. Pitman, R. M. Bullock, A. J. M. Miller, A. M. Appel, Thermodynamic hydricity of transition metal hydrides. Chem. Rev. 116, 8655-8692 (2016).
53. S. Ilic, U. Pandey Kadel, Y. Basdogan, J. A. Keith, K. D. Glusac, Thermodynamic hydricities of biomimetic organic hydride donors. J. Am. Chem. Soc. 140, 4569-4579 (2018).

The invention can be further understood by the following non-limiting examples.

### Example 1: Ammonia Production and Quantification Studies

Exemplary NH₃ Generation Reaction Procedure:

All solvents are stirred with Na/K for 2 hours and filtered prior to use. In a nitrogen-filled glovebox, the precatalysts ([Mo]Br₃ and/or [Ir]BAr^{F}₄) (2.3 μmol) are weighed in individual vials.* The precatalysts are then transferred quantitatively into a Schlenk tube using THF. The THF is then evaporated to provide a thin film of precatalyst at the bottom of the Schlenk tube. The tube is then charged with a stir bar and the acid and Hantzsch ester (HEH₂) are added as solids. The tube is cooled to 77 K in a cold well. The base ([Col]) is dissolved in 1 mL solvent. To the cold tube is added the 1 mL solution of base and solvent to produce a concentration of precatalyst of 2.3 mM. The temperature of the system is allowed to equilibrate for 5 minutes and then the tube is sealed with a Teflon screw-valve. This tube is passed out of the box into a liquid N₂ bath and transported to a fume hood. For experiments run at −78° C. the tube is then transferred to a dry ice/isopropanol bath where it thaws and is allowed to stir under blue LED irradiation at −78° C. for minimum three hours before warming. For experiments run at 23° C. the tube is instead transferred to a water bath where it thaws and is allowed to stir for 12 hours. To ensure reproducibility, all experiments were conducted in 200 mL Schlenk tubes (50 mm OD) using 10 mm eggshaped-stir bars and stirring was conducted at −600 rpm. Both the water bath and the dry ice/isopropanol bath were contained in highly reflective dewars. The Blue LED was placed above the bath as close to the stirring reaction as possible.

In cases where less than 2.3 μmol of precatalyst were used, stock solutions were used to avoid having to weigh very small amounts.

NH₃ Generation Reaction Procedure Under Partial H₂ Atmosphere:

Catalytic runs done under a mixture of H₂ and N₂ were conducted similarly to those under N₂ atmosphere, with a few differences described below. The loadings were the same as in FIG. 2, Entry 10.

Catalysis is performed in the same Schlenk tubes as under N₂, which are charged with precatalyst, HEH₂, [ColH]OTf, and a stirbar in a nitrogen-filled glovebox as described above. After addition of the solids, the tube is wrapped in aluminum foil and the base (Col) is added in 1 mL of Na/K dried THF at room temperature. Half of the headspace volume is then removed using a calibrated bulb and then backfilled with H₂ which has been passed through a liquid nitrogen trap. The aluminum foil is removed and the reaction is allowed to stir under Blue LED irradiation for 12 hours. Variation from the standard procedure (addition of THF/Col at room temperature and allowing to stir without irradiation for 30 min before exposing to blue LED) were found to not perturb the yield of NH₃.

NH₃ Detection by Optical Methods:

Reaction mixtures are cooled to 77 K and allowed to freeze. The reaction vessel is then opened to atmosphere and to the frozen solution is slowly added excess of a solution of HCl (3 mL of a 2.0 M solution in Et₂O, 6 mmol) over 1-2 minutes. This solution is allowed to freeze, then the headspace of the tube is evacuated and the tube is sealed. The tube is then allowed to warm to RT and stirred at RT for at least 10 minutes. Solvent is removed in vacuo, and the solids are extracted with 1 M HCl(aq) and filtered to give a total solution volume of 10 mL. A 5 mL aliquot is taken and washed repeatedly with n-butanol to remove Hantzsch pyridine (HE) and collidinium. After n-butanol washing additional 1 M HCl(aq) is added to give a final total volume of 5 mL. From these 5 mL solutions, a 100 μL aliquot is analyzed for the presence of NH₃ (present as [NH₄][Cl]) by the indophenol method. Quantification was performed with UV-vis spectroscopy by analyzing the absorbance at 635 nm. (46) When specified a further aliquot of this solution was analyzed for the presence of N₂H₄ (present as [N₂H₅][Cl]) by a standard colorimetric method. (47) Quantification was performed with UV-vis spectroscopy by analyzing the absorbance at 458 nm.

NH₃ Detection by ¹H NMR:

Reaction mixtures are cooled to 77 K and allowed to freeze. The reaction vessel is then opened to atmosphere and to the frozen solution is slowly added an excess (with respect to acid) solution of a NaO^{t}Bu solution in MeOH (0.25 mM) over 1-2 minutes. This solution is allowed to freeze, then the headspace of the tube is evacuated and the tube is sealed. The tube is then allowed to warm to RT and stirred at RT for at least 10 minutes. An additional Schlenk tube is charged with HCl (3 mL of a 2.0 M solution in Et₂O, 6 mmol) to serve as a collection flask. The volatiles of the reaction mixture are vacuum transferred at RT into this collection flask. After completion of the vacuum transfer, the collection flask is sealed and warmed to RT. Solvent is removed in vacuo, and the remaining residue is dissolved in 0.7 mL of DMSO-d₆ containing 20 mM 1,3,5-trimethoxybenzene as an internal standard. Integration of the ¹H NMR peak observed for NH₄⁺ is then integrated against the two peaks of trimethoxybenzene to quantify the ammonium present. This ¹H NMR detection method was also used to differentiate [¹⁴NH₄][Cl] and [¹⁵NH₄][GI] produced in the control reactions conducted with ¹⁵N₂, ¹⁵N-Col/[ColH]OTf, or ¹⁵N—HEH₂.

NH₃ Detection Results

Catalytic Results Corresponding to Entries in FIG. 2:

TABLE 1
Catalytic yields for photodriven transfer hydrogenation of N₂ to NH₃.

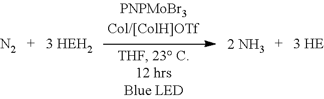

| | | | | | | | | | |
|---|---|---|---|---|---|---|---|---|---|
| | | [Mo] | | | | HEH₂ | NH₃ | N₂H₄ | |
| | | load | acid | base | Ir | equiv/ | equiv/ | equiv/ | NH₃ yield/ |
| Run | Conditions | (μmol) | (μmol) | (μmol) | (μmol) | Mo | Mo | Mo | HEH₂ (%) |

FIG. 2, entry 1: Standard conditions

| | | | | | | | | | |
|---|---|---|---|---|---|---|---|---|---|
| A1 | THF, 23° C. | 2.3 | 124.2 | 124.2 | 0 | 54 | 9.5 | — | |
| B1 | THF, 23° C. | 2.3 | 124.2 | 124.2 | 0 | 54 | 8.3 | — | |
| C1 | THF, 23° C. | 2.3 | 124.2 | 124.2 | 0 | 54 | 10.8 | — | |
| | THF, 23° C. | 2.3 | 124.2 | 124.2 | 0 | 54 | 9.5 ± 1 | | 26.5 ± 3 |

FIG. 2, entry 2: 0.575 mM [Mo]Br₃

| | | | | | | | | | |
|---|---|---|---|---|---|---|---|---|---|
| D1 | THF, 23° C. | 0.575 | 124.2 | 124.2 | 0 | 216 | 22.6 | — | |
| E1 | THF, 23° C. | 0.575 | 124.2 | 124.2 | 0 | 216 | 20.9 | — | |
| | THF, 23° C. | 0.575 | 124.2 | 124.2 | 0 | 216 | 21.8 ± 0.8 | | 15.1 ± 06 |

FIG. 2, entry 3: No Mo

| | | | | | | | | | |
|---|---|---|---|---|---|---|---|---|---|
| F1 | THF, 23° C. | 0 | 124.2 | 124.2 | 0 | 54 | <0.1 | <0.1 | |
| G1 | THF, 23° C. | 0 | 124.2 | 124.2 | 0 | 54 | <0.1 | <0.1 | |
| | THF, 23° C. | 2.3 | 124.2 | 124.2 | 0 | 54 | <0.1 | <0.1 | <0.3 |

FIG. 2, entry 4: No light

| | | | | | | | | | |
|---|---|---|---|---|---|---|---|---|---|
| H1 | THF, 23° C. | 2.3 | 124.2 | 124.2 | 0 | 54 | <0.1 | <0.1 | |
| | no light | | | | | | | | |
| I1 | THF, 23° C. | 2.3 | 124.2 | 124.2 | 0 | 54 | <0.1 | <0.1 | |
| | no light | | | | | | | | |
| | THF, 23° C. | 2.3 | 124.2 | 124.2 | 0 | 54 | <0.1 | <0.1 | <0.3 |
| | no light | | | | | | | | |

FIG. 2, entry 5: No buffer

| | | | | | | | | | |
|---|---|---|---|---|---|---|---|---|---|
| J1 | THF, 23° C. | 2.3 | 0 | 0 | 0 | 54 | 0.74 | — | |
| K1 | THF, 23° C. | 2.3 | 0 | 0 | 0 | 54 | 1.11 | — | |
| | THF, 23° C. | 2.3 | 0 | 0 | 0 | 54 | 0.9 ± 0.2 | | 2.6 ± 0.5 |

FIG. 2, entry 6: 5 equiv Col/[ColH]OTf

| | | | | | | | | | |
|---|---|---|---|---|---|---|---|---|---|
| L1 | THF, 23° C. | 2.3 | 11.5 | 11.5 | 0 | 54 | 2.7 | <0.1 | |
| M1 | THF, 23° C. | 2.3 | 11.5 | 11.5 | 0 | 54 | 3.2 | <0.1 | |
| N1 | THF, 23° C. | 2.3 | 11.5 | 11.5 | 0 | 54 | 2.8 | — | |
| | THF, 23° C. | 2.3 | 11.5 | 11.5 | 0 | 54 | 2.9 ± 0.2 | <0.1 | 8.1 ± 0.6 |

FIG. 2, entry 7: benzene instead of THF

| | | | | | | | | | |
|---|---|---|---|---|---|---|---|---|---|
| O1 | C₆H₆, | 2.3 | 124.2 | 124.2 | 0 | 54 | 4.8 | — | |
| | 23° C. | | | | | | | | |
| P1 | C₆H₆, | 2.3 | 124.2 | 124.2 | 0 | 54 | 4.6 | — | |
| | 23° C. | | | | | | | | |
| | C₆H₆, | 2.3 | 124.2 | 124.2 | 0 | 54 | 4.7 ± 0.1 | | 13 ± 0.3 |
| | 23° C. | | | | | | | | |

FIG. 2, entry 8: 216 equiv Col/[ColH]OTf

| | | | | | | | | | |
|---|---|---|---|---|---|---|---|---|---|
| Q1 | THF, 23° C. | 2.3 | 496.8 | 496.8 | 0 | 54 | 19.5 | — | |
| R1 | THF, 23° C. | 2.3 | 496.8 | 496.8 | 0 | 54 | 21.1 | — | |
| | THF, 23° C. | 2.3 | 496.8 | 496.8 | 0 | 54 | 20.3 ± 0.8 | | 56 ± 2 |

FIG. 2, entry 9: with 10 equiv TBABr

| | | | | | | | | | |
|---|---|---|---|---|---|---|---|---|---|
| S1 | THF, 23° C. | 2.3 | 124.2 | 124.2 | 0 | 54 | 9 | — | |
| T1 | THF, 23° C. | 2.3 | 124.2 | 124.2 | 0 | 54 | 8.6 | — | |
| | THF, 23° C. | 2.3 | 124.2 | 124.2 | 0 | 54 | 8.8 ± 0.3 | | 23.6 ± 0.8 |

FIG. 2, entry 10: Added [Ir]BAr^{F}₄

| | | | | | | | | | |
|---|---|---|---|---|---|---|---|---|---|
| U1 | THF, 23° C. | 2.3 | 124.2 | 124.2 | 2.3 | 54 | 29.8 | — | |
| V1 | THF, 23° C. | 2.3 | 124.2 | 124.2 | 2.3 | 54 | 20.6 | — | |
| W1 | THF, 23° C. | 2.3 | 124.2 | 124.2 | 2.3 | 54 | 20.5 | — | |
| X1 | THF, 23° C. | 2.3 | 124.2 | 124.2 | 2.3 | 54 | 25.4 | — | |
| | THF, 23° C. | 2.3 | 124.2 | 124.2 | 2.3 | 54 | 24 ± 4 | | 67 ± 10 |

FIG. 2, entry 11: Added [Ir]BAr^{F}₄, 5 equiv Col/[ColH]OTf

| | | | | | | | | | |
|---|---|---|---|---|---|---|---|---|---|
| Y1 | THF, 23° C. | 2.3 | 11.5 | 11.5 | 2.3 | 54 | 16.02 | <0.1 | |
| Z1 | THF, 23° C. | 2.3 | 11.5 | 11.5 | 2.3 | 54 | 16.6 | <0.1 | |
| AA1 | THF, 23° C. | 2.3 | 11.5 | 11.5 | 2.3 | 54 | 14.7 | | |
| | THF, 23° C. | 2.3 | 11.5 | 11.5 | 2.3 | 54 | 15.8 ± 0.8 | <0.1 | 44 ± 2 |

FIG. 2, entry 12: Added [Ir]BAr^{F}₄, t = 1/2 h

| | | | | | | | | | |
|---|---|---|---|---|---|---|---|---|---|
| AB1 | THF, 23° C. | 2.3 | 124.2 | 124.2 | 2.3 | 54 | 19.5 | — | |
| | t = 1/2 h | | | | | | | | |
| AC1 | THF, 23° C. | 2.3 | 124.2 | 124.2 | 2.3 | 54 | 17.7 | — | |
| | t = 1/2 h | | | | | | | | |
| | THF, 23° C. | 2.3 | 124.2 | 124.2 | 2.3 | 54 | 18.6 ± 0.9 | | 52 ± 3 |
| | t = 1/2 h | | | | | | | | |

~75% completion compared to entry 10
FIG. 2, entry 13: t = 2 h

| | | | | | | | | | |
|---|---|---|---|---|---|---|---|---|---|
| AD1 | THF, 23° C. | 2.3 | 124.2 | 124.2 | 0 | 54 | 4.9 | — | |
| | t = 2 h | | | | | | | | |
| AE1 | THF, 23° C. | 2.3 | 124.2 | 124.2 | 0 | 54 | 7.9 | — | |
| | t = 2 h | | | | | | | | |
| AF1 | THF, 23° C. | 2.3 | 124.2 | 124.2 | 0 | 54 | 10 | — | |
| | t = 2 h | | | | | | | | |
| | THF, 23° C. | 2.3 | 124.2 | 124.2 | 0 | 54 | 7.6 ± 2 | | 21 ± 6 |
| | t = 2 h | | | | | | | | |

~80% completion compared to entry 1
FIG. 2, entry 14: Added [Ir]BAr^{F}₄, 5 equiv Col/[ColH]OTf, 0.575 mM [Mo]Br₃

| | | | | | | | | | |
|---|---|---|---|---|---|---|---|---|---|
| AG1 | THF, 23° C. | 0.575 | 11.5 | 11.5 | 2.3 | 216 | 26.83 | — | |
| AH1 | THF, 23° C. | 0.575 | 11.5 | 11.5 | 2.3 | 216 | 25.96 | — | |
| | THF, 23° C. | 0.575 | 11.5 | 11.5 | 2.3 | 216 | 26 ± 0.4 | | 18.4 ± 0.4 |

FIG. 2, entry 15: Added [Ir]BAr^{F}₄, 5 equiv Col/[ColH]OTf, no light

| | | | | | | | | | |
|---|---|---|---|---|---|---|---|---|---|
| AI1 | THF, 23° C. | 2.3 | 11.5 | 11.5 | 2.3 | 54 | <0.1 | <0.1 | |
| | no light | | | | | | | | |
| AJ1 | THF, 23° C. | 2.3 | 11.5 | 11.5 | 2.3 | 54 | <0.1 | <0.1 | |
| | no light | | | | | | | | |
| | THF, 23° C. | 2.3 | 11.5 | 11.5 | 2.3 | 54 | <0.1 | <0.1 | <0.3 |
| | no light | | | | | | | | |

FIG. 2, entry 16: Added [Ir]BAr^{F}₄, 5 equiv Col/[ColH]OTf, no [Mo]Br₃

| | | | | | | | | | |
|---|---|---|---|---|---|---|---|---|---|
| AK1 | THF, 23° C. | 0 | 11.5 | 11.5 | 2.3 | 54 | <0.1 | <0.1 | |
| AL1 | THF, 23° C. | 0 | 11.5 | 11.5 | 2.3 | 54 | <0.1 | <0.1 | |
| | THF, 23° C. | 0 | 11.5 | 11.5 | 2.3 | 54 | <0.1 | <0.1 | <0.3 |

FIG. 2, entry 17: Added [Ir]BAr^{F}₄, 5 equiv Col/[ColH]OTf, no HEH₂

| | | | | | | | | | |
|---|---|---|---|---|---|---|---|---|---|
| AM1 | THF, 23° C. | 2.3 | 11.5 | 11.5 | 2.3 | 0 | <0.1 | <0.1 | |
| AN1 | THF, 23° C. | 2.3 | 11.5 | 11.5 | 2.3 | 0 | <0.1 | <0.1 | |
| | THF, 23° C. | 2.3 | 11.5 | 11.5 | 2.3 | 0 | <0.1 | <0.1 | <0.3 |

FIG. 2, entry 18: Added [Ir]BAr^{F}₄, subH₂ = 9,10-dihydroacridine

| | | | | | | | | | |
|---|---|---|---|---|---|---|---|---|---|
| AO1 | THF, 23° C. | 2.3 | 124.2 | 124.2 | 2.3 | 54^{a} | 6.7 | — | |
| AP1 | THF, 23° C. | 2.3 | 124.2 | 124.2 | 2.3 | 54^{a} | 6.1 | — | |
| | THF, 23° C. | 2.3 | 124.2 | 124.2 | 2.3 | 54^{a} | 6.4 ± 0.3 | | 17.7 ± 0.8 |

FIG. 2, entry 19: Added [Ir]BAr^{F}₄, subH₂ = 5,6-dihydrophenanthridine

| | | | | | | | | | |
|---|---|---|---|---|---|---|---|---|---|
| AQ1 | THF, 23° C. | 2.3 | 124.2 | 124.2 | 2.3 | 54^{b} | 4.5 | — | |
| AR1 | THF, 23° C. | 2.3 | 124.2 | 124.2 | 2.3 | 54^{b} | 5.1 | — | |
| | THF, 23° C. | 2.3 | 124.2 | 124.2 | 2.3 | 54^{b} | 4.6 ± 0.8 | | 13 ± 2 |

FIG. 2, entry 20: Added [Ir]BAr^{F}₄, subH₂ = 1-benzyl-1,4-dihydronicotinamide

| | | | | | | | | | |
|---|---|---|---|---|---|---|---|---|---|
| AS1 | THF, 23° C. | 2.3 | 124.2 | 124.2 | 2.3 | 54^{c} | 1.31 | — | |
| AT1 | THF, 23° C. | 2.3 | 124.2 | 124.2 | 2.3 | 54^{c} | 1.12 | — | |
| | THF, 23° C. | 2.3 | 124.2 | 124.2 | 2.3 | 54^{c} | 1.2 ± 0.1 | | 3.3 ± 0.3 |

FIG. 2, entry 21: Added [Ir]BAr^{F}₄, 0.5 atm H₂, 0.5 atm N₂

| | | | | | | | | | |
|---|---|---|---|---|---|---|---|---|---|
| AU1 | THF, 23° C. | 2.3 | 124.2 | 124.2 | 2.3 | 54 | 16.1 | — | |
| | P_{N2} = P_{H2} = | | | | | | | | |
| | 0.5 atm | | | | | | | | |
| AV1 | THF, 23° C. | 2.3 | 124.2 | 124.2 | 2.3 | 54 | 11.0 | — | |
| | P_{N2} = P_{H2} = | | | | | | | | |
| | 0.5 atm | | | | | | | | |
| | THF, 23° C. | 2.3 | 124.2 | 124.2 | 2.3 | 54 | 14 ± 4 | | 36 ± 9 |
| | P_{N2} = P_{H2} = | | | | | | | | |
| | 0.5 atm | | | | | | | | |

FIG. 2, entry 22: Added [Ir(dF(CF₃)ppy)₂(dtbbpy)]PF₆, t = 2 h

| | | | | | | | | | |
|---|---|---|---|---|---|---|---|---|---|
| AW1 | THF, 23° C. | 2.3 | 124.2 | 124.2 | 2.3 | 54 | 1.8 | — | |
| | t = 2 h | | | | | | | | |
| AX1 | THF, 23° C. | 2.3 | 124.2 | 124.2 | 2.3 | 54 | 2.6 | — | |
| | t = 2 h | | | | | | | | |
| | THF, 23° C. | 2.3 | 124.2 | 124.2 | 2.3 | 54 | 2.2 ± 0.6 | | 6 ± 1 |
| | t = 2 h | | | | | | | | |

FIG. 2, entry 23: Added [Ir]PF₆, t = 2 h

| | | | | | | | | | |
|---|---|---|---|---|---|---|---|---|---|
| AY1 | THF, 23° C. | 2.3 | 124.2 | 124.2 | 2.3 | 54 | 18.4 | — | |
| | t = 2 h | | | | | | | | |
| AZ1 | THF, 23° C. | 2.3 | 124.2 | 124.2 | 2.3 | 54 | 23.5 | — | |
| | t = 2 h | | | | | | | | |
| | THF, 23° C. | 2.3 | 124.2 | 124.2 | 2.3 | 54 | 21 ± 4 | | 58 ± 10 |
| | t = 2 h | | | | | | | | |

FIG. 2, entry 24: Added [Ir(p-F(Me)ppy)₂(dtbbpy)]PF₆, t = 2 h

| | | | | | | | | | |
|---|---|---|---|---|---|---|---|---|---|
| BA1 | THF, 23° C. | 2.3 | 124.2 | 124.2 | 2.3 | 54 | 21.5 | — | |
| | t = 2 h | | | | | | | | |
| BB1 | THF, 23° C. | 2.3 | 124.2 | 124.2 | 2.3 | 54 | 23.1 | — | |
| | t = 2 h | | | | | | | | |
| | THF, 23° C. | 2.3 | 124.2 | 124.2 | 2.3 | 54 | 22 ± 1 | | 62 ± 3 |
| | t = 2 h | | | | | | | | |

FIG. 2, entry 25: Added Ir(ppy)₃, t = 2 h

| | | | | | | | | | |
|---|---|---|---|---|---|---|---|---|---|
| BC1 | THF, 23° C. | 2.3 | 124.2 | 124.2 | 2.3 | 54 | 7.8 | — | |
| | t = 2 h | | | | | | | | |
| BD1 | THF, 23° C. | 2.3 | 124.2 | 124.2 | 2.3 | 54 | 5.8 | — | |
| | t = 2 h | | | | | | | | |
| | THF, 23° C. | 2.3 | 124.2 | 124.2 | 2.3 | 54 | 7 ± 1 | | 19 ± 4 |
| | t = 2 h | | | | | | | | |

FIG. 2, entry 26: Added [Ir]BAr^{F}₄, no Col/[ColH]OTf

| | | | | | | | | | |
|---|---|---|---|---|---|---|---|---|---|
| BE1 | THF, 23° C. | 2.3 | 124.2 | 124.2 | 2.3 | 54 | 7.03 | — | |
| | t = 2 h | | | | | | | | |
| BF1 | THF, 23° C. | 2.3 | 124.2 | 124.2 | 2.3 | 54 | 7.83 | — | |
| | t = 2 h | | | | | | | | |
| | THF, 23° C. | 2.3 | 124.2 | 124.2 | 2.3 | 54 | 7.4 ± 0.4 | | 20.7 ± 1 |
| | t = 2 h | | | | | | | | |

^{a}9,10-dihydroacridine used instead of HEH₂
^{b}5,6-dihydrophenanthridine used instead of HEH₂
^{c}1-benzyl-1,14-dihydronicotinamide used instead of HEH₂

Additional Catalytic Experiments:

TABLE 2
Canvassing H₂ carriers:

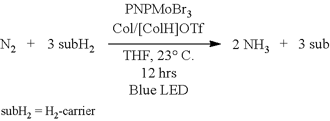

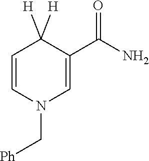 [SMILES: NC(=O)C1=CN(Cc2ccccc2)C=CC1]

BNAH
(1-benzyl-1,4-dihydronicotinamide)

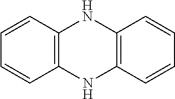 [SMILES: c1ccc2c(c1)Nc1ccccc1N2]

phenazH₂
(5,10-dihydrophenazine)

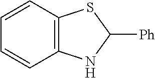 [SMILES: c1ccc(C2Nc3ccccc3S2)cc1]

BTH₂
(2-phenylbenzothiazolin)

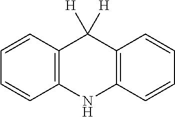 [SMILES: c1ccc2c(c1)Cc1ccccc1N2]

acrH₂
(9,10-dihydroacridine)

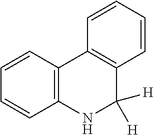 [SMILES: c1ccc2c(c1)CNc1ccccc1-2]

phenH₂
(5,6-dihydrophenanthridine)

| | | [Mo]Br₃ | | | | subH₂ | | | NH₃ yield/ |
|---|---|---|---|---|---|---|---|---|---|
| | | load | acid | base | Ir | equiv/ | NH₃ equiv/ | N₂H₄ | subH₂ |
| Run | subH₂ | (μmol) | (μmol) | (μmol) | (μmol) | Mo | Mo | equiv/Mo | (%) |
| A2 | BNAH | 2.3 | 124.2 | 124.2 | 0 | 54 | 0.55 | — | |
| B2 | BNAH | 2.3 | 124.2 | 124.2 | 0 | 54 | 0.30 | — | |
| | BNAH | 2.3 | 124.2 | 124.2 | 0 | 54 | 0.4 ± 0.1 | | 1.2 ± 0.3 |
| C2 | PhenazH₂ | 2.3 | 124.2 | 124.2 | 2.3 | 54 | <0.1 | — | |
| D2 | PhenazH₂ | 2.3 | 124.2 | 124.2 | 2.3 | 54 | <0.1 | — | |
| | PhenazH₂ | 2.3 | 124.2 | 124.2 | 2.3 | 54 | <0.1 | | <0.1 |
| E2 | BTH₂ | 2.3 | 124.2 | 124.2 | 2.3 | 54 | <0.1 | — | |
| F2 | BTH₂ | 2.3 | 124.2 | 124.2 | 2.3 | 54 | <0.1 | — | |
| | BTH₂ | 2.3 | 124.2 | 124.2 | 2.3 | 54 | <0.1 | | <0.1 |
| G2 | AcrH₂ | 2.3 | 124.2 | 124.2 | 0 | 54 | 0.09 | — | |
| H2 | AcrH₂ | 2.3 | 124.2 | 124.2 | 0 | 54 | 0.24 | — | |
| | AcrH₂ | 2.3 | 124.2 | 124.2 | 0 | 54 | 0.16 ± 0.08 | | 0.5 ± 0.2 |
| I2 | PhenH₂ | 2.3 | 124.2 | 124.2 | 0 | 54 | 0.216 | — | |
| J2 | PhenH₂ | 2.3 | 124.2 | 124.2 | 0 | 54 | 0.205 | — | |
| | PhenH₂ | 2.3 | 124.2 | 124.2 | 0 | 54 | 0.211 ± 0.008 | | 0.66 ± 0.02 |

TABLE 3
Additional time course experiments

| | | Mo | | | | HEH₂ | NH₃ | | NH₃ yield/ |
|---|---|---|---|---|---|---|---|---|---|
| | | loading | acid | base | Ir | equiv/ | equiv/ | N₂H₄ | HEH₂ |
| Run | Conditions | (μmol) | (μmol) | (μmol) | (μmol) | Mo | Mo | equiv/Mo | (%) |
| A3 | THF, 23° C. | 2.3 | 124.2 | 124.2 | 2.3 | 54 | 24.5 | — | |
| | t = 2 h | | | | | | | | |
| B3 | THF, 23° C. | 2.3 | 124.2 | 124.2 | 2.3 | 54 | 25.5 | — | |
| | t = 2 h | | | | | | | | |
| | THF, 23° C. | 2.3 | 124.2 | 124.2 | 2.3 | 54 | 25 ± 0.5 | | 69.4 ± 1.5 |

t = 2 hours

Approximately 100% completion compared to FIG. 2, entry 10

| | | | | | | | | | |
|---|---|---|---|---|---|---|---|---|---|
| C3 | THF, rt, 10 | 2.3 | 124.2 | 124.2 | 2.3 | 54 | 8.2 | — | 22.8 |

min

Approximately 30% completion compared to FIG. 2, entry 10

TABLE 4
Catalysis using [ColH]OTf or Col instead of buffered solution

| | | Mo | | | | HEH₂ | NH₃ | | NH₃ yield/ |
|---|---|---|---|---|---|---|---|---|---|
| | | loading | acid | base | Ir | equiv/ | equiv/ | N₂H₄ | HEH₂ |
| Run | Conditions | (μmol) | (μmol) | (μmol) | (μmol) | Mo | Mo | equiv/Mo | (%) |
| A4 | THF, 23° C. | 2.3 | 496.8 | 0 | 0 | 54 | 5.8 | — | |
| B4 | THF, 23° C. | 2.3 | 496.8 | 0 | 0 | 54 | 5.5 | — | |
| | THF, 23° C. | 2.3 | 496.8 | 0 | 0 | 54 | 5.6 ± .15 | | 15.7 ± 0.4 |
| C4 | THF, 23° C. | 2.3 | 0 | 496.8 | 0 | 54 | 1.2 | — | |
| D4 | THF, 23° C. | 2.3 | 0 | 496.8 | 0 | 54 | 2.0 | — | |
| | THF, 23° C. | 2.3 | 0 | 496.8 | 0 | 54 | 1.6 ± 0.4 | | 4.7 ± 1.1 |

TABLE 5
Solvent screen

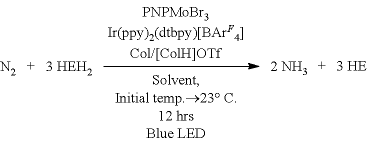

| | | | | | | | | | NH₃ |
|---|---|---|---|---|---|---|---|---|---|
| | | Mo | | | | HEH₂ | | | yield/ |
| | | loading | acid | base | Ir | equiv/ | NH₃ | N₂H₄ | HEH₂ |
| Run | Conditions | (μmol) | (μmol) | (μmol) | (μmol) | Mo | equiv/Mo | equiv/Mo | (%) |
| A5 | THF, −78 | 2.3 | 11.5 | 11.5 | 2.3 | 54 | 15.47 | — | |
| | →23° C. | | | | | | | | |
| B5 | THF, −78 | 2.3 | 11.5 | 11.5 | 2.3 | 54 | 16.06 | — | |
| | →23° C. | | | | | | | | |
| | THF, −78 | 2.3 | 11.5 | 11.5 | 2.3 | 54 | 15.7 ± 0.3 | | 44.8 ± 0.8 |
| | →23° C. | | | | | | | | |
| C5 | Tol, 23° C. | 2.3 | 11.5 | 11.5 | 2.3 | 54 | 7 | — | |
| D5 | Tol, 23° C. | 2.3 | 11.5 | 11.5 | 2.3 | 54 | 7.3 | — | |
| | Tol 23° C. | 2.3 | 11.5 | 11.5 | 2.3 | 54 | 7.15 ± 0.15 | | 19.8 ± 0.8 |
| E5 | Tol, −78 | 2.3 | 11.5 | 11.5 | 2.3 | 54 | 13.01 | — | |
| | →23° C. | | | | | | | | |
| F5 | Tol, −78 | 2.3 | 11.5 | 11.5 | 2.3 | 54 | 14.24 | — | |
| | →23° C. | | | | | | | | |
| | Tol, −78 | 2.3 | 11.5 | 11.5 | 2.3 | 54 | 13.6 ± 0.6 | | 38 ± 2 |
| | →23° C. | | | | | | | | |
| G5 | Et₂O, −78 | 2.3 | 11.5 | 11.5 | 2.3 | 54 | 4.08 | — | |
| | →23° C. | | | | | | | | |
| H5 | Et₂O, −78 | 2.3 | 11.5 | 11.5 | 2.3 | 54 | 3.97 | — | |
| | →23° C. | | | | | | | | |
| | Et₂O, −78 | 2.3 | 11.5 | 11.5 | 2.3 | 54 | 4.0 ± 0.1 | | 11.2 ± 0.2 |
| | →23° C. | | | | | | | | |
| I5 | THF, −78 | 2.3 | 11.5 | 11.5 | 2.3ª | 54 | 7.4 | — | |
| | →23° C. | | | | | | | | |
| J5 | THF, −78 | 2.3 | 11.5 | 11.5 | 2.3ª | 54 | 11.7 | — | |
| | →23° C. | | | | | | | | |
| | THF, −78 | 2.3 | 11.5 | 11.5 | 2.3ª | 54 | 9.6 ± 2 | | 27 ± 7 |
| | →23° C. | | | | | | | | |
| K5 | MeCy, 23° C. | 2.3 | 124.2 | 124.2 | 0 | 54 | <0.1 | — | |
| L5 | MeCy, 23° C. | 2.3 | 124.2 | 124.2 | 0 | 54 | <0.1 | — | |
| | MeCy, 23° C. | | | | | | <0.1 | | <0.3 |

ªIr(ppy)₃ used as photosensitizer
Tol = toluene; MeCy = methylcyclohexane

Solubility Reagents:
Collidine: Soluble in THF, Et₂O, Toluene, C₆H₆, MeCy
Collidinium triflate: Soluble in THF, insoluble in Et₂O, Toluene and C₆H₆, MeCy
[Mo]Br₃: Soluble in THF, Toluene and C₆H₆. Sparingly soluble in Et₂O, MeCy
HEH₂: Partially soluble in THF, Et₂O, Toluene and C₆H₆. Most soluble in THF, MeCy
[Ir]BAr^{F}₄ Soluble in THF, Et₂O, partially soluble in C₆H₆ and Toluene

TABLE 6
Attempted catalysis with [P₃^{B}Fe]BAr^{F}₄

| | | Fe | | | | HEH₂ | NH₃ | | NH₃ yield/ |
|---|---|---|---|---|---|---|---|---|---|
| | | loading | acid | base | Ir | equiv/ | equiv/ | N₂H₄ | HEH₂ |
| Run | Conditions | (μmol) | (μmol) | (μmol) | (μmol) | Fe | Fe | equiv/Fe | (%) |
| A6 | THF, 23° C. | 2.3 | 124.2 | 124.2 | 2.3 | 54 | <0.1 | <0.1 | |
| B6 | THF, 23° C. | 2.3 | 124.2 | 124.2 | 2.3 | 54 | <0.1 | <0.1 | |
| | THF, 23° C. | 2.3 | 124.2 | 124.2 | 2.3 | 54 | <0.1 | <0.1 | <0.1 |
| C6 | THF, 23° C. | 2.3 | 124.2 | 124.2 | 0 | 54 | <0.1 | <0.1 | |
| D6 | THF, 23° C. | 2.3 | 124.2 | 124.2 | 0 | 54 | <0.1 | <0.1 | |
| | THF, 23° C. | 2.3 | 124.2 | 124.2 | 0 | 54 | <0.1 | <0.1 | <0.1 |

NH₃ Detection Results From ¹⁵N—HEH₂, ¹⁵N-Col/¹⁵N—[ColH]OTf and ¹⁵N₂ Experiments

¹⁵N₂ Experiments

Catalytic runs done under a ¹⁵N₂ atmosphere were conducted similarly to those under a ¹⁴N₂ atmosphere, with a few differences described below. The loadings were the same as in FIG. 2, Entry 1.

Catalysis is performed in the same catalytic tubes as natural abundance experiments, which are charged with precatalyst, HEH₂, [ColH]OTf, and a stirbar in a nitrogen-filled glovebox as described above. After addition of the solids, the tube is then cooled to 77 K in a cold well. The base (Col) is added by micropipette to the frozen tube by opening the Kontes. The Kontes was closed and the tube is kept frozen, then passed out of the glovebox into a liquid N₂ bath. The headspace of the tube is evacuated while still submerged in liquid N₂.

Na/K dried THF is filtered and 1 mL placed into a separate Schlenk tube. The solvent undergoes freeze-pump thaw cycles (3 cycles) and is then vacuum transferred into the catalysis tube. This tube is allowed to warm up briefly and charged with ¹⁵N₂ via vacuum bridge. The tube is refrozen at 77 K and then transferred to a water bath where it thaws and is allowed to stir under Blue LED irradiation for 12 hours.

¹⁵N—HEH₂, ¹⁵N-Col/¹⁵N-[ColH]OTf experiments

Catalytic runs were set-up as described above but using either ¹⁵N—HEH₂ as H₂-carrier or ¹⁵N-Col/[ColH]OTf as buffer using the same conditions as FIG. 2, Entry 1.

### Example 2: Analysis of Non-NH₃ Catalysis Products

After a complete catalytic run, instead of quenching the reaction (with acid or base) the solvent from the reaction mixture was removed in vacuo. Subsequently the resulting film was taken up in minimal solvent (DMSO-d₆, THF-d₈ or 2-MeTHF) and analyzed by NMR or CW-EPR.

¹H NMR Time Course Experiments

Procedure: A J. Young NMR tube was loaded with [Mo]Br₃, HEH₂, [ColH]OTf, Col, and N₂ and irradiated under blue LED. Conditions (concentration, temperature) were the same as in FIG. 2, entry 1, but using THF-d₈ as solvent and 0.5 mL solvent instead of 1 mL. Slightly slower reaction times are attributed to less efficient illumination of and lack of stirring in the NMR tube compared to Schlenk flasks.

### Example 3: Steady-State Fluorescence Measurements

Fluorimetry Studies

Procedure for fluorimetry studies: 1 cm quartz glass cuvettes were loaded with 0.5 mM HEH₂ solutions in dry THF, with varying concentrations of quencher (either Col or [ColH]OTf) in a nitrogen glovebox. Stock solutions were used to assure consistency. Solutions were excited at 390 nm wavelength to avoid interference of the excitation wavelength and steady-state fluorescence spectra. Experiments were conducted at 23° C.

Calculation of Stern-Volmer Quenching Constants

Using the previously measured excited state-lifetime measured (To) for HEH₂ we can calculate the Stern-Vollmer quenching lifetime using the equation:

I₀/I_{c}=1+k_{q}·T₀[Q]

k_{q}=slope/T₀

While T₀ has not been measured in THF at 25° C. the measurements in DMSO at 25° C. (0.419 ns) provide a useful estimate. (20) Accordingly, the quenching constants are:

k_{colH}=1.0±0.1·10¹¹ M⁻¹ s⁻¹

k_{col}=3±2·10⁹ M⁻¹ s⁻¹

While these values have considerable errors, particularly the Col quenching, these nonetheless provide useful order of magnitude estimates. The large rate constant for k_{colH+} suggests the presence of static quenching pathways.

### Example 4: UV-Visible Measurements

Procedure for UV-vis measurements: 1 cm quartz glass cuvettes were loaded with 0.1 mM HEH₂ solutions in dry THF inside the glovebox. The cuvette was taken out of the glovebox, and spectra were collected. Concentrated (50 mM) solutions of Col or [ColH]OTf were titrated into the cuvettes. The Col or [ColH]OTf solutions had 0.1 mM HEH₂ added to maintain the HEH₂ concentration throughout the experiments. Titrations were done under a sparging N₂ atmosphere to maintain an 02 free environment. Experiments were conducted at 23° C.

### Example 5: Reduction of [TBA]NO₃

Standard [TBA]NO₃ Reduction Generation Reaction Procedure

Catalytic experiments for the reduction of [TBA]NO₃ were conducted in a manner similar to the reduction of N₂. All solvents are stirred with Na/K for 2 hours and filtered prior to use. In a nitrogen-filled glovebox, the precatalysts ([Mo]Br₃ and [Ir]BAr^{F}₄) (2.3 μmol) are weighed in individual vials.* The precatalysts are then transferred quantitatively into a Schlenk tube using THF. The THF is then evaporated to provide a thin film of precatalyst at the bottom of the Schlenk tube. The tube is then charged with a stir bar and the [TBA]NO₃, acid and Hantzsch ester (HEH₂) are added as solids. The tube is cooled to 77 K in a cold well and the base ([Col]) is added as well. The tubes were passed out of the glovebox without warming and thoroughly degassed. 1 mL of degassed (three freeze-pump thaw cycles) THF solvent was vacuum transferred into the catalytic tube. The tube was allowed to warm briefly, and was back-filled with argon. The tube is instead transferred to a water bath where it thaws and is allowed to stir for 12 hours. To ensure reproducibility, all experiments were conducted in 200 mL Schlenk tubes (50 mm OD) using 10 mm eggshaped-stir bars and stirring was conducted at ˜600 rpm. The water bath was contained in highly reflective dewars. The Blue LED was placed above the bath as close to the stirring reaction as possible.

NH₃ Detection

NH₃ was detected by ¹H NMR as detailed in S1.4 NH₃ detection by ¹H NMR.

Catalytic Reduction of [TBA]NO₃

TABLE 7
Catalytic yields for photodriven transfer hydrogenation of [TBA]NO₃ to
NH₃

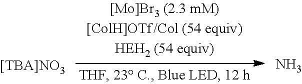

| | | | | | | | | | |
|---|---|---|---|---|---|---|---|---|---|
| | | | | | | | [TBA] | | NH₃ |
| | | [Mo]Br₃ | | | | | NO₃ | NH₃ | yield/ |
| | | load | acid | base | Ir | HEH₂/ | equiv/ | equiv/ | HEH₂ |
| Run | Conditions | (μmol) | (μmol) | (μmol) | (μmol) | Mo | Mo | Mo | (%) |

FIG. 2, entry 27: Standard conditions for reduction of [TBA]NO₃

| | | | | | | | | | |
|---|---|---|---|---|---|---|---|---|---|
| A7 | THF, 23° C. | 2.3 | 124.2 | 124.2 | 0 | 54 | 18 | 8.5 | |
| B7 | THF, 23° C. | 2.3 | 124.2 | 124.2 | 0 | 54 | 18 | 11.0 | |
| | THF, 23° C. | 2.3 | 124.2 | 124.2 | 0 | 54 | 18 | 9.8 ± 1.2 | 73 ± 9 |

FIG. 2, entry 28: with [Mo]Br₃, with [Ir]BAr^{F}₄

| | | | | | | | | | |
|---|---|---|---|---|---|---|---|---|---|
| C7 | THF, 23° C. | 2.3 | 124.2 | 124.2 | 2.3 | 54 | 18 | 9.9 | |
| D7 | THF, 23° C. | 2.3 | 124.2 | 124.2 | 2.3 | 54 | 18 | 10.9 | |
| | THF, 23° C. | 2.3 | 124.2 | 124.2 | 2.3 | 54 | 18 | 10.4 ± 0.5 | 77 ± 4 |

FIG. 2, entry 29: No [Mo]Br₃

| | | | | | | | | | |
|---|---|---|---|---|---|---|---|---|---|
| E7 | THF, 23° C. | 2.3 | 124.2 | 124.2 | 2.3 | 54 | 18 | 2 | |
| F7 | THF, 23° C. | 2.3 | 124.2 | 124.2 | 2.3 | 54 | 18 | 1.4 | |
| | THF, 23° C. | 2.3 | 124.2 | 124.2 | 2.3 | 54 | 18 | 1.7 ± 0.3 | 13 ± 2 |

FIG. 2, entry 30: No [Mo]Br₃, with [Ir]BAr^{F}₄

| | | | | | | | | | |
|---|---|---|---|---|---|---|---|---|---|
| F7 | THF, 23° C. | 2.3 | 124.2 | 124.2 | 2.3 | 54 | 18 | 3.0 | |
| G7 | THF, 23° C. | 2.3 | 124.2 | 124.2 | 2.3 | 54 | 18 | 5.4 | |
| | THF, 23° C. | 2.3 | 124.2 | 124.2 | 2.3 | 54 | 18 | 4.2 ± 1.2 | 31 ± 9 |

FIG. 2, entry 31: no light, with [Mo]Br₃, with [Ir]BAr^{F}₄

| | | | | | | | | | |
|---|---|---|---|---|---|---|---|---|---|
| H7 | THF, 23° C. | 2.3 | 124.2 | 124.2 | 2.3 | 54 | 18 | 0.1 | |
| | No light | | | | | | | | |
| I7 | THF, 23° C. | 2.3 | 124.2 | 124.2 | 2.3 | 54 | 18 | 0.1 | |
| | No light | | | | | | | | |
| | THF, 23° C. | 2.3 | 124.2 | 124.2 | 2.3 | 54 | 18 | 0.1 ± 0.05 | 0.7 ± 0.3 |
| | No light | | | | | | | | |

Catalytic Reduction of [TBA]¹⁵NO₃

Catalytic runs were set-up as described in S5.1 but using [TBA]¹⁵NO₃.

Comment on Nitrate Reduction in the Absence of Light or [Mo]Br₃.

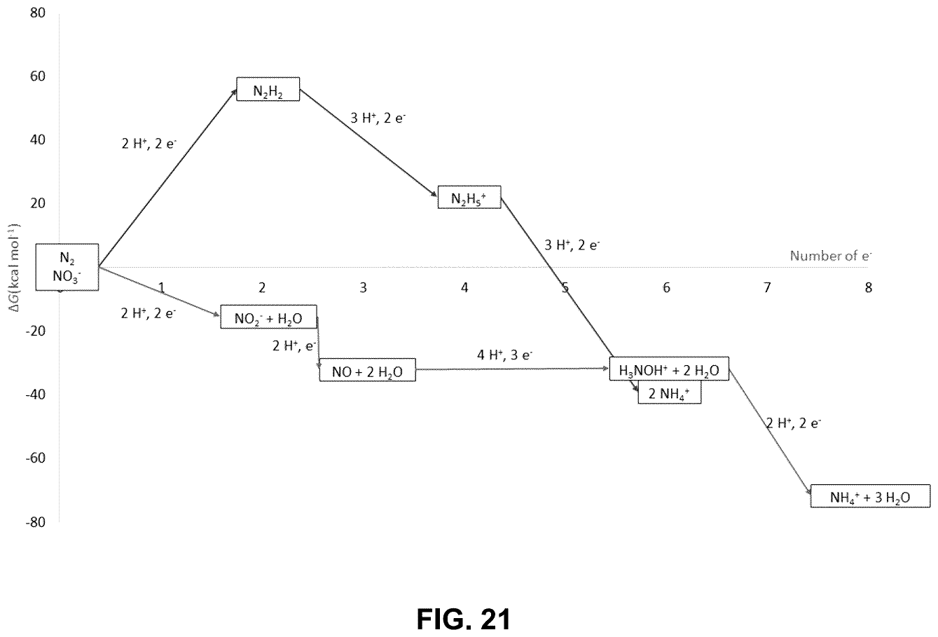

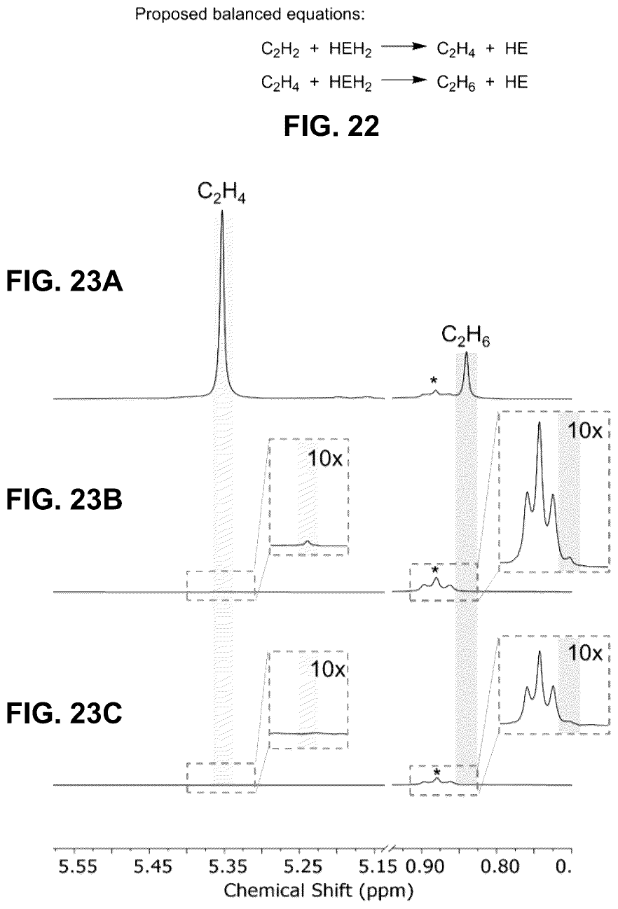

It is worth commenting on the fact that [TBA]NO₃ reduction can occur both in the absence of light and [Mo]Br₃, albeit with diminished yields. This differs from N₂R where both are required and no NH₃ can be detected. Nitrate differs as a substrate from N₂, in that it is more activated, and forms relatively stable intermediates during reduction (NO₂—, NO), and the thermodynamics of reduction are more favorable. This is illustrated in FIG. 21 showing the thermodynamics between different intermediates in the reduction of N₂ and NO₃— (in aqueous solution, vs NHE). Therefore, a molecular catalyst might not be required to activate the substrate prior to reduction/protonation and stabilize intermediates that form during reduction. The role of [Mo]Br₃ might therefore be primarily as a Lewis acid or a solubilizing agent. Ultimately, these results suggest that higher yields/efficiencies and possibly even nitrate reduction without illumination may all be possible with a more careful choice of catalyst and warrant further exploration.

### Example 6: Reduction of Acetylene

Standard Acetylene Reduction Reaction Procedure

Catalytic experiments for the reduction of acetylene were conducted in a manner similar to the reduction of N₂ described above. All solvents are stirred with Na/K for 2 hours and filtered prior to use. In a nitrogen-filled glovebox, the precatalysts ([Mo]Br₃ and [Ir]BAr^{F}₄) (2.5 μmol) are weighed in individual vials. The precatalysts are then transferred quantitatively into a Schlenk tube using THF. The THF is then evaporated to provide a thin film of precatalyst at the bottom of the Schlenk tube. The tube is then charged with a stirbar and [ColH]OTf and Hantzsch ester (HEH₂) are added to the vial as solids. The tube is wrapped in aluminum foil and Col and THF-d₈ (0.7 mL) are added. The tube is sealed, passed out of the glovebox, and degassed (three freeze-pump thaw cycles). The desired volume of acetylene gas is added using a calibrated bulb while the tube is cooled in liquid nitrogen. The headspace of the tube is then backfilled to 1 atm with argon while cooled in a dry ice/acetone bath. The tube is transferred to a water bath and is irradiated with Blue LED for the time specified. The water bath was contained in highly reflective dewars. The Blue LED was placed above the bath as close to the reaction as possible.

After 12 hours of irradiation, the volatiles of the reaction mixture are vacuum transferred into a J. Young NMR tube of known volume containing a known amount of 1,3,5-trimethoxybenzene. In the ¹H NMR spectrum of the resulting sample, the peaks corresponding to ethylene (5.36 ppm) and ethane (0.85 ppm) are clearly distinguishable when present. (45) Integration to the internal standard provides the yield of dissolved gases. Henry's constant for each gas in THF(48) was used to estimate their partial pressures in the headspace.

Ethylene and Ethane Detection Results

TABLE 8
Catalytic yields for photodriven transfer hydrogenation of acetylene to
ethylene and ethane.

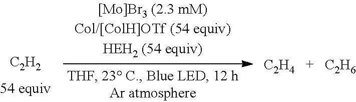

| | | | | | | | | | |
|---|---|---|---|---|---|---|---|---|---|
| | | [Mo] | | | | HEH₂ | C₂H₄ | | |
| | | load | acid | base | Ir | equiv/ | equiv/ | C₂H₆ | Total yield/ |
| Run | Conditions | (μmol) | (μmol) | (μmol) | (μmol) | Mo | Mo | equiv/Mo | HEH₂ (%) |

FIG. 2, entry 32: standard conditions

| | | | | | | | | | |
|---|---|---|---|---|---|---|---|---|---|
| A8 | THF, 23° C. | 2.5 | 135 | 135 | 0 | 54 | 8.2 | 1.3 | |
| B8 | THF, 23° C. | 2.5 | 135 | 135 | 0 | 54 | 11.4 | 1.7 | |
| | THF, 23° C. | 2.5 | 135 | 135 | 0 | 54 | 10 ± 2 | 1.5 ± 0.3 | 24 ± 5 |

FIG. 2, entry 33: with [Mo]Br₃, with [Ir]BAr^{F}₄

| | | | | | | | | | |
|---|---|---|---|---|---|---|---|---|---|
| C8 | THF, 23° C. | 2.5 | 135 | 135 | 2.5 | 54 | 6.4 | 1.3 | |
| D8 | THF, 23° C. | 2.5 | 135 | 135 | 2.5 | 54 | 4.9 | 0.9 | |
| | THF, 23° C. | 2.5 | 135 | 135 | 2.5 | 54 | 6 ± 1 | 1.1 ± 0.3 | 15 ± 3 |

FIG. 2, entry 34: no [Mo]Br₃, no [Ir]BAr^{F}₄

| | | | | | | | | | |
|---|---|---|---|---|---|---|---|---|---|
| E8 | THF, 23° C. | 2.5 | 135 | 135 | 0 | 54 | 0.048 | <0.03 | |
| F8 | THF, 23° C. | 2.5 | 135 | 135 | 0 | 54 | 0.059 | <0.03 | |
| | THF, 23° C. | 2.5 | 135 | 135 | 0 | 54 | 0.054 ± | <0.03 | <0.3 |
| | | | | | | | 0.008 | | |

FIG. 2, entry 35: no [Mo]Br₃, with [Ir]BAr^{F}₄

| | | | | | | | | | |
|---|---|---|---|---|---|---|---|---|---|
| G8 | THF, 23° C. | 0 | 135 | 135 | 2.5 | 54 | 0.8 | 0.02 | |
| H8 | THF, 23° C. | 0 | 135 | 135 | 2.5 | 54 | 3.0 | 0.14 | |
| | THF, 23° C. | 0 | 135 | 135 | 2.5 | 54 | 2 ± 2 | 0.08 ± | 4 ± 3 |
| | | | | | | | | 0.08 | |

FIG. 2, entry 36: with [Mo]Br₃, with [Ir]BAr^{F}₄, no light

| | | | | | | | | | |
|---|---|---|---|---|---|---|---|---|---|
| I8 | THF, 23° C. | 2.5 | 135 | 135 | 2.5 | 54 | <0.01 | <0.01 | |
| | no light | | | | | | | | |
| J8 | THF, 23° C. | 2.5 | 135 | 135 | 2.5 | 54 | <0.01 | <0.01 | |
| | no light | | | | | | | | |
| | THF, 23° C. | 2.5 | 135 | 135 | 2.5 | 54 | <0.01 | <0.01 | <0.04 |
| | no light | | | | | | | | |

### Example 7: Additional Mechanistic Scenarios

Non-limiting exemplary reactions in the hydrogenation of N₂ are shown in the mechanistic schemes of FIGS. 25A and 25B.

### Example 8: Derivation of Thermodynamic Values

Summary of Thermochemistry of Hantzsch Ester (HEH₂) and Derivatives

Table 9 lists BDFE_{x-H}, pKₐ, and Eₒₓ values for various protonation and oxidation states of HEH₂. As has been established by Mayer and coworkers, (36) bond dissociation enthalpies (BDEs) can be converted to BDFEs based on the assumption that the entropies of R—H and R* are similar. Subtraction of TS°(H*)ₛₒₗᵥ (6.37 kcal mol⁻¹ in MeCN) from the BDE values reported in ref. 18 yields the estimated BDFE values in Table 9. With these values and reported potentials of oxidation, relevant pKₐ values were then estimated using the thermodynamic cycles laid out below.

TABLE 9
Reported and estimated thermochemical values for various protonation
and oxidation states of HEH₂ relevant to this study.

| | BDEª | BDFEª | Eₒₓ^{b} | pKₐ |
|---|---|---|---|---|
| 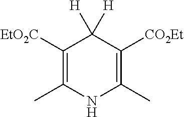 [SMILES: CCOC(=O)C1=C(C)NC(C)=C(C(=O)OCC)C1] | 68.7 (C—H), 86.6 (N—H)^{c} | 62.3 (C—H), 80.2 (N—H) | 0.48^{c} | 31.8 (N—H) |
| HEH₂ | | | | |
| 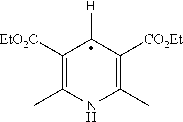 [SMILES: CCOC(=O)C1=C(C)NC(C)=C(C(=O)OCC)C1] | 46.9 (N—H)^{c} | 40.5 (N—H) | | |
| HEH^{•} | | | | |
| 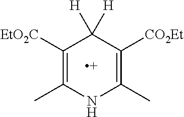 [SMILES: CCOC(=O)C1=C(C)NC(C)=C(C(=O)OCC)C1] | | | | −1.0 (C—H) |
| HEH^{•+} | | | | |
| 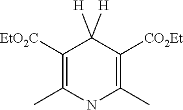 [SMILES: CCOC(=O)C1=C(C)NC(C)=C(C(=O)OCC)C1] | | | −0.695^{c} | |
| HEH⁻ | | | | |
| [HEH₂]* | | −8.5 | −2.6^{d} | −20 |
| | | (C—H)^{d} | | (N—H)^{d} |

Estimation of the N—H pKₐ of HEH₂:

| | |
|---|---|
| HEH^{•} + e⁻ ⇄ HEH⁻ | −23.06(Eₒₓ(HEH⁻)) = 16 kcal mol⁻¹ |
| H^{•} ⇄ H⁺ + e- | −C_{G} = −52.6 kcal mol⁻¹ |
| HEH₂ ⇄ HEH^{•} + H^{•} | BDFE_{N—H}(HEH₂) = 80.2 kcal mol⁻¹ |
| HEH₂ ⇄ HEH⁻ + H⁺ | 1.37(pKₐ) |
| | pK_{a,N—H}(HEH₂) = 31.8 |

Estimation of the C—H pKₐ of HEH₂^{•+}:

| | |
|---|---|
| HEH₂^{•} + e⁻ ⇄ HEH₂ | −23.06(Eₒₓ(HEH⁻)) = 11.1 kcal mol⁻¹ |
| H^{•} ⇄ H⁺ + e- | −C_{G} = −52.6 kcal mol⁻¹ |
| HEH₂ ⇄ HEH^{•} + H^{•} | BDFE_{C—H}(HEH₂) = 62.3 kcal mol⁻¹ |
| HEH₂^{•+} ⇄ HEH⁻ + H⁺ | 1.37(pKₐ) |
| | pK_{a,C—H}(HEH^{•+}) = −1.0 |

Estimation of the N—H pKₐ of [HEH₂]*:

| | |
|---|---|
| HEH₂* ⇄ HEH₂ | −23.06(E₀₀) = −70.8 kcal mol⁻¹ |
| HEH₂ ⇄ HEH⁻ + H⁺ | 1.37(pK_{a,N—H}(HEH₂)) = 43.6 kcal mol⁻¹ |
| HEH₂ ⇄ HEH⁻ + H⁺ | 1.37(pKₐ) |
| | pK_{a,N—H}(HEH₂*) = −20 |

Estimation of the excited-state BDFE_{C—H} of [HEH₂]*:

| | |
|---|---|
| HEH₂* ⇄ HEH₂ | −23.06(E₀₀) = −70.8 kcal mol⁻¹ |
| HEH₂ ⇄ HEH⁻ + H⁺ | BDFE_{C—H}(HEH₂) = 62.3 kcal mol⁻¹ |
| HEH₂* ⇄ HEH⁻ + H⁺ | BDFE_{C—H}(HEH₂*) = −8.5 kcal mol⁻¹ |

ªkcal mol⁻¹ in MeCN at 298 K.
^{b}V vs. Fc^{+/0} in MeCN at 298 K.
^{c}Ref. 18.
^{d}Estimated using the E₀₀ reported in ref. 19.

Derivation of Effective BDFE Values (BDFE_{eff}) Relevant to this Work

Derivation of BDFE_{eff} for subH₂ Donors

Estimation of BDFE_{eff} for HEH₂:

½HEH₂ [symbol] ½HEH*+½H*½BDFE_{C—H}(HEH₂)=31.2 kcal mol⁻¹

½HEH* [symbol] ½HE+½H*½BDFE_{N—H}(HEH*)=20.3 kcal mol⁻¹

½HEH₂ [symbol] ½HE+H* BDFE_{eff}(HEH₂)=51.4 kcal mol⁻¹

Estimation of BDFE_{eff} for acrH₂:

acrH₂ [symbol] acrH₂*⁺+e⁻23.06(Eₒₓ(acrH₂))=11.3 kcal mol⁻¹ (Ref 50)

acrH₂*⁺ [symbol] acrH⁺+H* BDE(acrH₂*⁺)−TS°(H*)ₛₒₗᵥ=43.5−6.37 kcal mol⁻¹=37.1

kcal mol⁻¹ (Ref 51)

e⁻+H* [symbol] H⁻ΔG°=26.0 kcal mol⁻¹ (Ref 52)

acrH₂ [symbol] acrH⁺+H⁻ΔG(acrH₂)_{H-}=74.4 kcal mol⁻¹

½ acrH₂ [symbol] acrH⁺+½ H⁻ ½ ΔG(acrH₂)H⁻=37.2 kcal mol⁻¹

½acrH⁺ [symbol] acr+½H⁺½1.37(pKₐ)=8.7 kcal mol⁻¹ (Ref 22)

½H⁻+½H⁺ [symbol] ½H₂ ½ΔG°=−38 kcal mol⁻¹ (Ref 52)

½ H₂ [symbol] H* ½ BDFE_{N—H}(H₂)=52 kcal mol⁻¹

½BNAH+½[ColH]⁺ [symbol] ½BNA+½Col+H* BDFE_{eff}(acrH₂)=59.9 kcal mol⁻¹

Estimation of BDFE_{eff} for phenH₂:

½phenH₂ [symbol] phenH*+½H*½BDFE_{C—H}(phenH₂)=33.1 kcal mol⁻¹ (Ref 18)

½phenH* [symbol] phen+½H*½BDFE_{N—H}(phenH*)=19.1 kcal mol⁻¹ (Ref 18)

½phenH₂ [symbol] phen+H* BDFE_{eff}(phenH₂)=52.2 kcal mol⁻¹

### Estimation of BDFE_{eff} for BNAH:

BNAH is a 1 H⁺/2e⁻ donor. As such to balance the equation for the 6 H⁺/6e⁻ reduction of N₂ we posit that [ColH]OTf must also be consumed giving a balanced reaction:

N₂+3 BNAH+3[ColH]⁺→NH₃+3[BNA]⁺+3 Col

To estimate BDFE_{eff} we instead combine the hydricity of BNAH and the acidity of [ColH]OTf

½BNAH [symbol] ½BNA+½H⁻½ΔG(BNAH)_{H-}=29.5 kcal mol⁻¹ (Ref 53)

½[ColH]⁺ [symbol] ½Col+½H⁺½1.37(pKₐ)=10.3 kcal mol⁻¹ (Ref 22)

½H⁻+½H⁺ [symbol] ½H₂ ½ΔG°=−38 kcal mol⁻¹ (Ref 52)

½H₂ [symbol] H*½BDFE_{N—H}(H₂)=52 kcal mol⁻¹

½BNAH+½[ColH]⁺ [symbol] ½BNA+½Col+H* BDFE_{eff}(BNAH/ColH⁺)=53.8 kcal mol⁻¹

Derivation of BDFE_{eff} for Reductant (Photosensitizer or *HEH₂) and Acid

Estimation of BDFE_{eff} for [HEH₂]* as reductant and [ColH]* as acid:

HEH₂* [symbol] HEH₂*⁺+e⁻

[ColH]⁺ [symbol] Col+H⁺1.37(pKₐ)=20.6 kcal mol⁻¹ (Ref 22)

H⁺+e⁻H* C_{G}=52.6 kcal mol⁻¹

HEH₂*+[ColH]* [symbol] HEH₂*⁺+Col+H* BDFE_{eff}=10.9 kcal mol⁻¹

Estimation of BDFE_{eff} for Ir^{II}(ppy)₂(dtbbpy) as reductant and [ColH]* as acid:

[Ir^{II}] [symbol] [Ir^{III}]⁺+e⁻23.06(Eₒₓ([Ir^{II}])=−43.8 kcal mol⁻¹ (Ref 28)

[ColH]⁺ [symbol] Col+H⁺1.37(pKₐ)=20.6 kcal mol⁻¹ (Ref 22)

H⁺+e⁻ [symbol] H* C_{G}=52.6 kcal mol⁻¹

HEH₂*+[ColH]⁺ [symbol] HEH₂*⁺+Col+H* BDFE_{eff}=29.3 kcal mol⁻¹

Estimation of BDFE_{eff} for Ir^{II}(p-F(Me)ppy)₂(dtbbpy) as reductant and [ColH]* as acid:

[Ir^{II}] [symbol] [Ir^{III}]⁺+e⁻23.06(Eₒₓ([Ir^{II}])=−43.4 kcal mol⁻¹ (Ref 30)

[ColH]⁺ [symbol] Col+H⁺1.37(pKₐ)=20.6 kcal mol⁻¹ (Ref 22)

H⁺+e⁻H* C_{G}=52.6 kcal mol⁻¹

HEH₂*+[ColH]⁺ [symbol] HEH₂*⁺+Col+H* BDFE_{eff}=29.8 kcal mol⁻¹

Estimation of BDFE_{eff} for Ir^{II}(dF(CF₃)ppy)₂(dtbbpy) as reductant and [ColH]* as acid:

[Ir^{II}] [symbol] [Ir^{III}]⁺+e⁻23.06(Eₒₓ([Ir^{II}])=−40.4 kcal mol⁻¹ (Ref 29)

[ColH]⁺ [symbol] Col+H⁺1.37(pKₐ)=20.6 kcal mol⁻¹ (Ref 22)

H⁺+e⁻ [symbol] H* C_{G}=52.6 kcal mol⁻¹

HEH₂*+[ColH]⁺ [symbol] HEH₂*⁺+Col+H* BDFE_{eff}=32.8 kcal mol⁻¹

Estimation of BDFE_{eff} for [Ir^{II}(ppy)₃]⁻ as reductant and [ColH]⁺ as acid:

[Ir^{II}] [symbol] [Ir^{III}]⁺+e⁻23.06(Eₒₓ([Ir^{II}])=−59.3 kcal mol⁻¹ (Ref 29)

[ColH]⁺ [symbol] Col+H⁺1.37(pKₐ)=20.6 kcal mol⁻¹ (Ref 22)

H⁺+e⁻ [symbol] H* C_{G}=52.6 kcal mol⁻¹

HEH₂*+[ColH]⁺ [symbol] HEH₂*⁺+Col+H* BDFE_{eff}=13.9 kcal mol⁻¹

Estimation of BDFE_{eff} for [Ir^{III}(ppy)₃]* as reductant and [ColH]* as acid:

[Ir^{II}] [symbol] [Ir^{III}]⁺+e⁻23.06(Eₒₓ([Ir^{III}])=−48.7 kcal mol⁻¹ (Ref 29)

[ColH]⁺ [symbol] Col+H⁺1.37(pKₐ)=20.6 kcal mol⁻¹ (Ref 22)

H⁺+e⁻ [symbol] H* C_{G}=52.6 kcal mol⁻¹

HEH₂*+[ColH]⁺ [symbol] HEH₂*⁺+Col+H* BDFE_{eff}=24.5 kcal mol⁻¹

Estimation of Overpotential for Hydrogenation of N₂ with HEH₂ to NH₃

We derive the BDFE of H₂ in MeCN at 298 K explicitly here for clarity, using recently updated thermochemical values (36):

H_{2(g)} [symbol] 2 H⁺+2e⁻2×23.06(E°(H⁺/H₂))=2×23.06(−0.028 V)=−1.29 kcal mol⁻¹ (Ref 36)

2 H⁺+2e⁻ [symbol] 2H* 2(C_{G})=105.2 kcal mol⁻¹

H_{2(g)} [symbol] 2H* BDFE(H₂)=103.9 kcal mol⁻¹

Determination of Overpotential for Dark Reactions

The overpotential ΔΔG_{f}(NH₃) for a source of hydrogen atom equivalents with a given BDFE_{eff} is described by eqn S1:

ΔΔG_{f}(NH₃)=3(BDFE(H₂)/2−BDFE_{eff}) (eqn S1)

For the dark reaction, ½ N₂+ 3/2 HEH₂ [symbol] NH₃+ 3/2 HE:

ΔΔG_{f}(NH₃)=3(103.9/2−51.4)=1.7 kcal mol⁻¹

For the dark reaction, ½ N₂+ 3/2 acrH₂ [symbol] NH₃+ 3/2 acr:

ΔΔG_{f}(NH₃)=3(103.9/2−59.9)=−23.9 kcal mol⁻¹

For the dark reaction, ½ N₂+ 3/2 phenH₂ [symbol] NH₃+ 3/2 phen:

ΔΔG_{f}(NH₃)=3(103.9/2−52.2)=−0.8 kcal mol⁻¹

For the dark reaction, ½ N₂+ 3/2 (BNAH+ColH⁺) [symbol] NH₃+ 3/2 (BNA⁺+Col):

ΔΔG_{f}(NH₃)=3(103.9/2−53.8)=−5.5 kcal mol⁻¹

With the dark reaction values value, we can also estimate the absolute driving force for hydrogenation of N₂ with subH₂.

ΔG_{f}(NH₃) in MeCN at 298 K:

$$1 / 2 {N}_{2} + 3 / 2 {H}_{2 ( g )} ⇌ {NH}_{3}$$

$$Δ {G}_{f} ( {NH}_{3} ) = - 3 \times 23.06 ( E ° ( {N}_{2 ( g )} / {NH}_{3} ) ) = - 3 \times 23.06 ( 0.063 V vs . {H}_{2} ) ( Ref 36 ) = 4.36 kcal {mol}^{- 1}$$

We then estimate the following:

$$1 / 2 {N}_{2} + 3 / 2 {HEH}_{2} ⇌ {NH}_{3} + 3 / 2 HE$$

$$Δ {G}_{r \times n} = Δ {G}_{f} ( {NH}_{3} ) - ΔΔ {G}_{f} ( {NH}_{3} , {HEH}_{2} ) = - 4.4 - 1.7 kcal {mol}^{- 1} = - 6.1 kcal {mol}^{- 1}$$

$$1 / 2 {N}_{2} + 3 / 2 {phenH}_{2} ⇌ {NH}_{3} + 3 / 2 phen$$

$$Δ {G}_{r \times n} = Δ {G}_{f} ( {NH}_{3} ) - ΔΔ {G}_{f} ( {NH}_{3} , {phenH}_{2} ) = - 4.4 + 0.8 kcal {mol}^{- 1} = - 3.6 kcal {mol}^{- 1}$$

$$1 / 2 {N}_{2} + 3 / 2 {acrH}_{2} ⇌ {NH}_{3} + 3 / 2 acr$$

$$Δ {G}_{r \times n} = Δ {G}_{f} ( {NH}_{3} ) - ΔΔ {G}_{f} ( {NH}_{3} , {acrH}_{2} ) = - 4.4 + 23.9 kcal {mol}^{- 1} = 19.5 kcal {mol}^{- 1}$$

$$1 / 2 {N}_{2} + 3 / 2 ( BNAH + {ColH}^{+} ) ⇌ {NH}_{3} + 3 / 2 ( {BNA}^{+} + Col )$$

$$Δ {G}_{r \times n} = Δ {G}_{f} ( {NH}_{3} ) - ΔΔ {G}_{f} ( {NH}_{3} , BNAH + {ColH}^{+} ) = - 4.4 + 5.5 kcal {mol}^{- 1} = + 1.1 kcal {mol}^{- 1}$$

TABLE 10
Summary of driving forces for dark reaction using
different subH₂ (assuming 2 H⁺/ 2 e⁻ reaction). Values are
calculated in MeCN at 25° C.

| | BDFE_{eff} | ΔΔGf(NH3) | ΔGrxn |
|---|---|---|---|
| subH₂ | (kcal mol⁻¹) | (kcal mol−1) | (kcal mol−1) |
| HEH₂ | 51.4 | 1.7 | −6.1 |
| PhenH₂ | 52.2 | −0.8 | −3.6 |
| AcrH₂ | 59.9 | −23.9 | 19.5 |
| BNAH + [ColH]OTf ^{a} | 53.8 | −5.5 | 1.1 |

ª Since BNAH is a H⁻ donor the stoichiometry requires addition iof H⁺, assumed to be supplied from [ColH]OTf

Determination of Overpotential for Light Reactions

For the Ir-free reaction, in which [HEH₂]* is thought to be the strongest reductant accessed and [ColH]* serves as acid:

ΔΔG_{f}(NH₃)=3(103.9/2−10.9)=123.2 kcal mol⁻¹

For the Ir-photosensitized reaction with [Ir(ppy)₂(dtbbpy)]BAr^{F}4, in which [Ir^{II}] is thought to be the strongest reductant accessed and [ColH]* serves as acid:

ΔΔG_{f}(NH₃)=3(103.9/2−29.3)=68.0 kcal mol⁻¹

For the Ir-photosensitized reaction with [Ir(dF(CF₃)ppy)₂(dtbbpy)]PF₆, in which [Ir^{II}] is thought to be the strongest reductant accessed and [ColH]* serves as acid:

ΔΔG_{f}(NH₃)=3(103.9/2−32.8)=58.3 kcal mol⁻¹

For the Ir-photosensitized reaction with [Ir(p-F(Me)ppy)₂(dtbbpy)]PF₆, in which [Ir^{II}] is thought to be the strongest reductant accessed and [ColH]* serves as acid:

ΔΔG_{f}(NH₃)=3(103.9/2−29.8)=67.3 kcal mol⁻¹

For the Ir-photosensitized reaction with Ir(ppy)₃, in which [Ir^{II}] is thought to be the strongest reductant accessed and [ColH]* serves as acid:

ΔΔG_{f}(NH₃)=3(103.9/2−13.9)=115.0 kcal mol⁻¹

For the Ir-photosensitized reaction with Ir(ppy)₃, in which [Ir^{III}]* is thought to be the strongest reductant accessed and [ColH]* serves as acid:

ΔΔG_{f}(NH₃)=3(103.9/2−24.5)=83.2 kcal mol⁻¹

TABLE 11
Summary of driving forces for different photosensitizers. All
BDFEeff and ΔG_{f}(NH₃) measurements made pairing reductant with [ColH]OTf
(pKₐ 15) Values are calculated in MeCN at 25° C.

| | Eox | | |
|---|---|---|---|
| Reductant | (V vs Fc+/0) | BDFE_{eff} (kcal mol⁻¹) | ΔΔGf(NH3) (kcal mol−1) |
| HEH₂* | −2.70 | 10.9 | 123.2 |
| [Ir^{II}] (Ir^{II}(ppy)₂dtbbpy) | −1.90 | 29.3 | 68.0 |
| Ir^{II} (dF(CF₃)ppy)₂(dtbbpy) | −1.75 | 32.8 | 58.3 |
| Ir^{II} (ρ-F(Me)ppy)₂(dtbbpy) | −1.88 | 29.8 | 67.3 |
| Ir^{II}(ppy)₃⁻ | −2.57 | 13.9 | 115.0 |
| Ir^{III}(ppy)₃* | −2.11 | 24.5 | 83.2 |

### Example 9: Recycling Strategies for the Transfer Agent

Recycling of the transfer agent from its spent or oxidized form (referred to herein as “sub”) back to its reduced form, capable of participating in the hydrogenation reaction, (referred to herein as “subH₂”), increases the applicability of the disclosed methods.

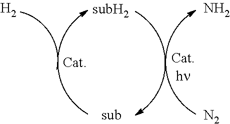

Hydrogenating the sub to subH₂ may require a hydrogenation catalyst, which may be a heterogenous material or a homogenous molecular catalyst, such as a transition metal-based hydrogenation catalyst or a frustrated Lewis pairs organoboranes.

Exemplary Transfer Agent Recycle Strategy #1—One-Pot-Reaction

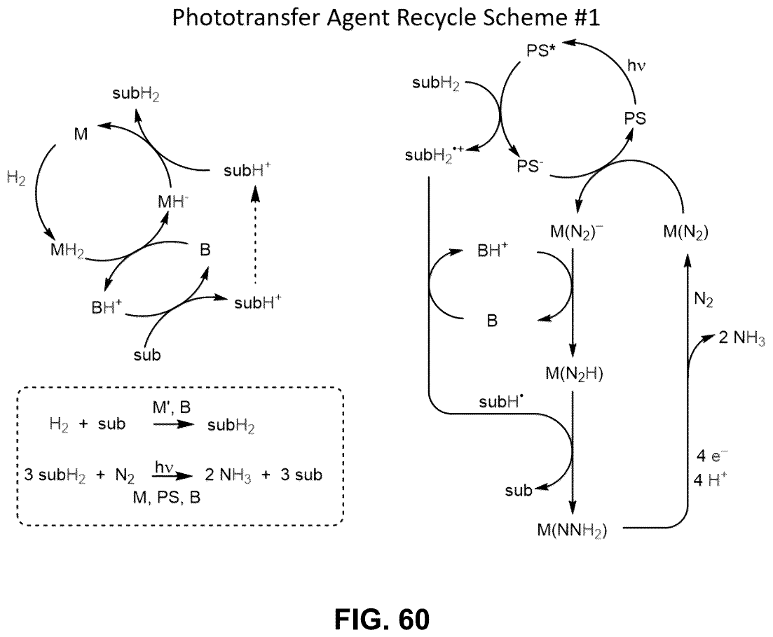

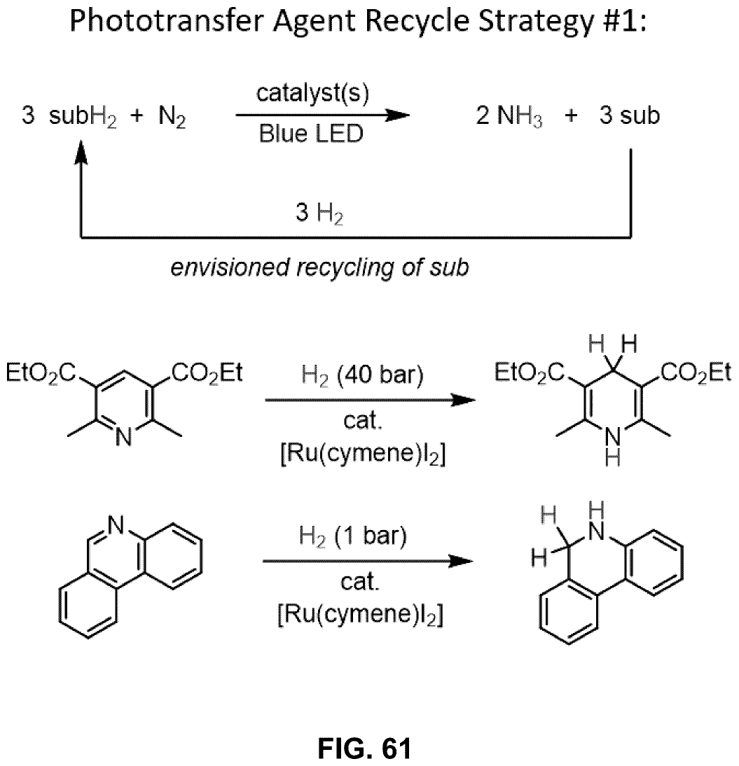

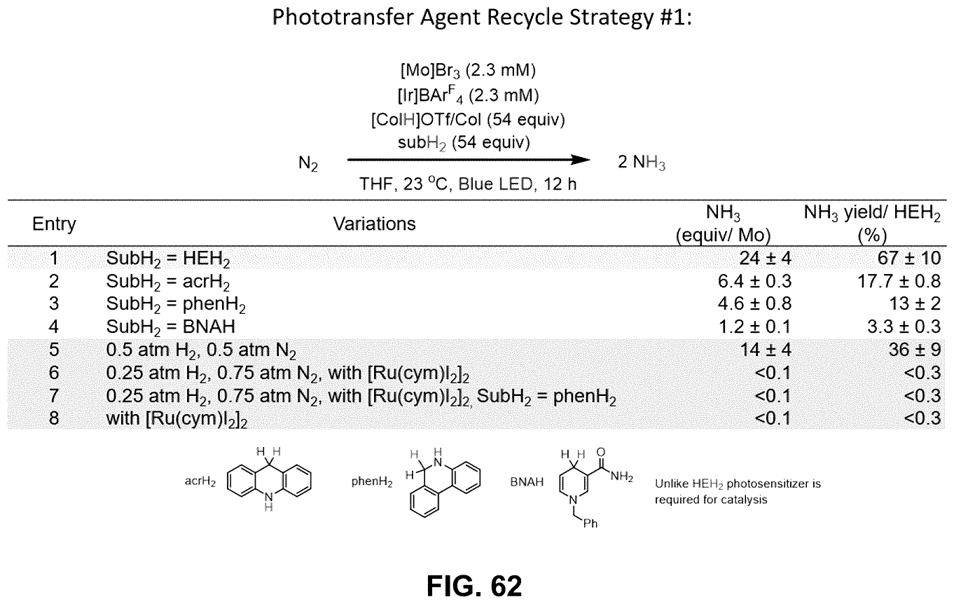

This section is best read in view of FIGS. 60-62. This strategy is to add all the reactants and catalysts in a flask at the same time and perform N₂ reduction (N₂R) and hydrogenation simultaneously. In this scheme one adsd N₂R-catalyst, sub, hydrogenation catalyst, solvent and photocatalyst and buffer with a gas headspace that contains both N₂ gas and H₂ gas the reaction is irradiated. Two chemical cycles are occurring, (1) the hydrogenation of sub to subH₂ and (2) the photodriven reduction of N₂ to NH₃ which simultaneously converts subH₂ to sub. In such a scheme the only reagents consumed are N₂ gas and H₂ gas and the remaining chemical reagents are catalytic. Nonetheless side reactivity of the species, particularly sub/subH₂ will make it a challenge to realize a reaction where these reagents are also present in catalytic amounts. An example of such a reaction is given below, where [MoBr]₃ (2.3 mM), 54 equiv phenanthridine, 54 equiv Col, 54 equiv [ColH]OTf, [Ir(ppy)₂(dtbbpy)]BAr^{F}₄³(1 equiv) and [Ru(cymene)I₂]₂² are added to the reaction and under an atmosphere of 0.5 atm N₂ and 0.5 atm N₂ gas the reaction is irradiated.

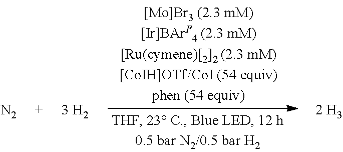

### Example 11: Exemplary Transfer Agent Recycle Strategy #2—Two-Step Reaction

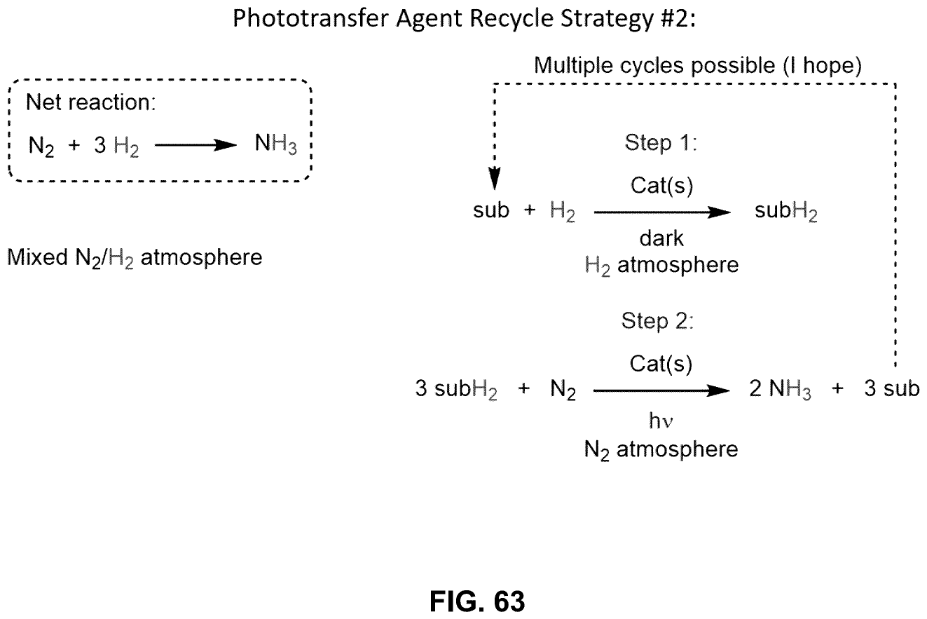

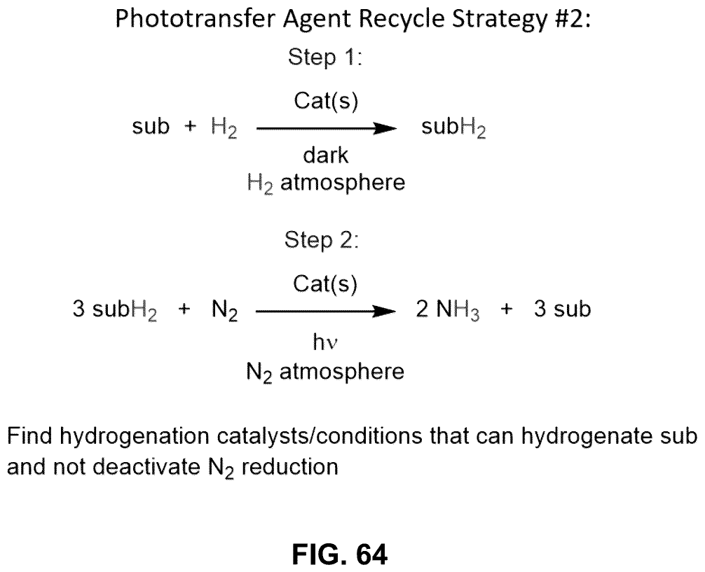

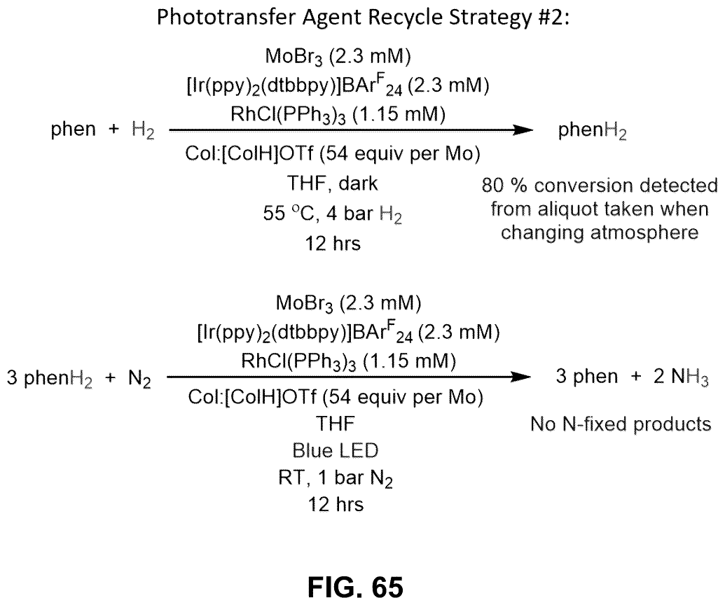

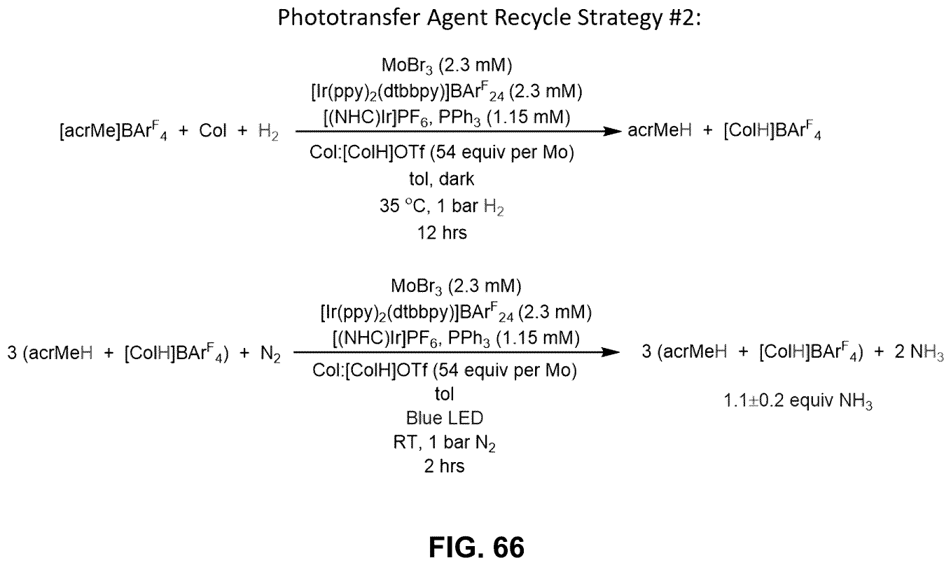

This section is best read in view of FIGS. 63-66. In this strategy, due to frequent deleterious side reactions between the different cycles, the reactions are separated in time. All the same reactants and catalysts are added as in strategy #1 but N₂R and hydrogenation are done in separate steps. In this scheme one adds N₂ reduction catalyst, sub, a hydrogenation catalyst, solvent, photocatalyst and buffer to a flask. First, under an H₂ gas atmosphere sub is hydrogenated to subH₂. The atmosphere is then switched to N₂ gas and the photodriven reduction of N₂ to NH₃ while converting subH₂ to sub. The reaction mixture could then be re-exposed to H₂ gas reconverting sub to subH₂, and multiple cycles of this strategy could be completed. An example of such a reaction is given below, where [MoBr]3 (2.3 mM), 54 equiv phenanthridine, 54 equiv Col, 54 equiv [ColH]OTf, [Ir(ppy)₂(dtbbpy)]BAr^{F}₄ (1 equiv) and Rh(Cl)PPh₃ (1 equiv) are added to the reaction and first under an atmosphere of H₂ gas (4 bar) hydrogenation occurs. Following this the atmosphere is switched to N₂ and the reaction is irradiated.

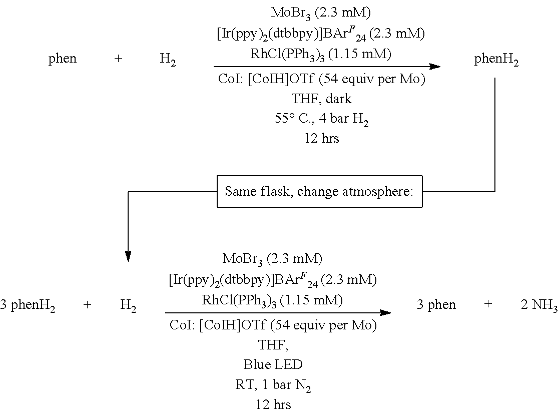

### Example 12: Exemplary Transfer Agent Recycle Strategy #3—Separated Reactions

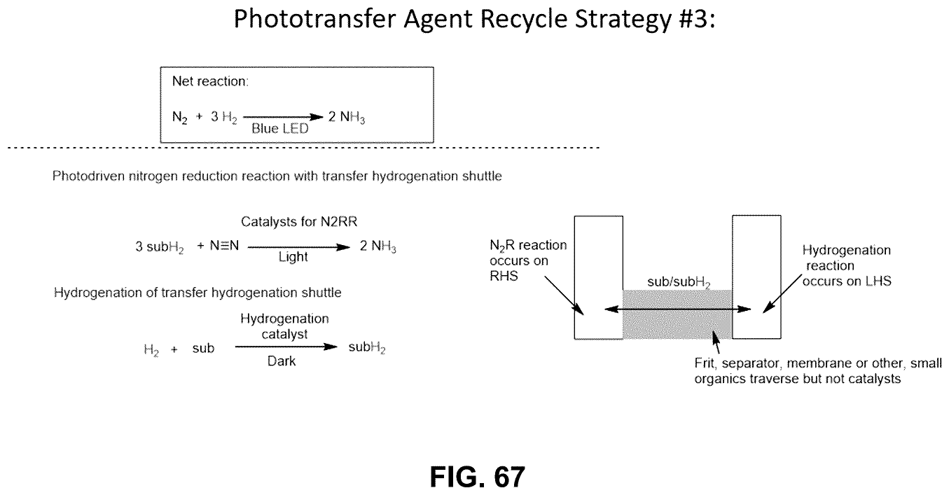

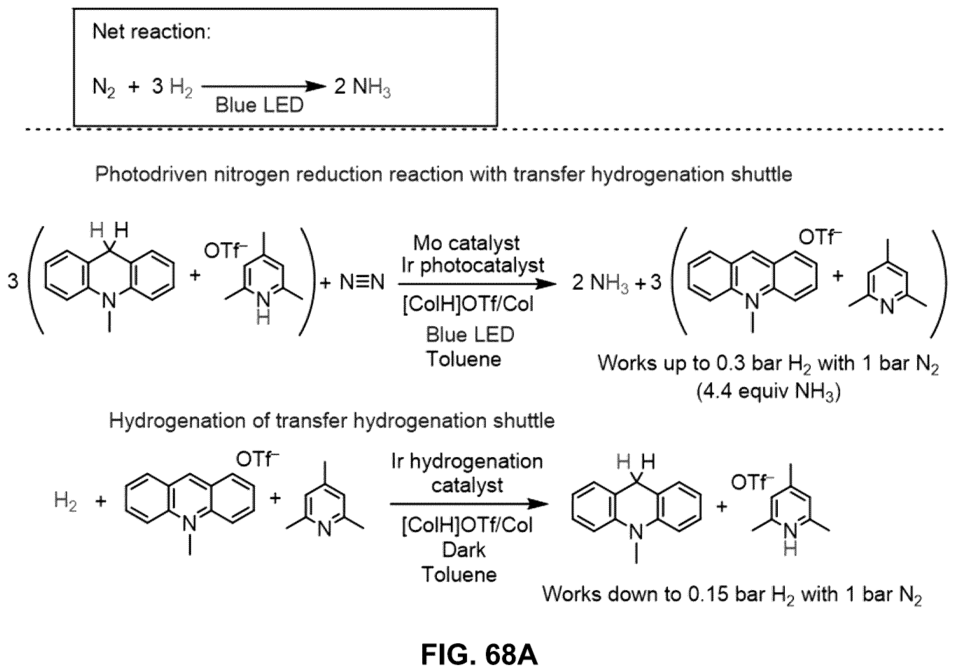

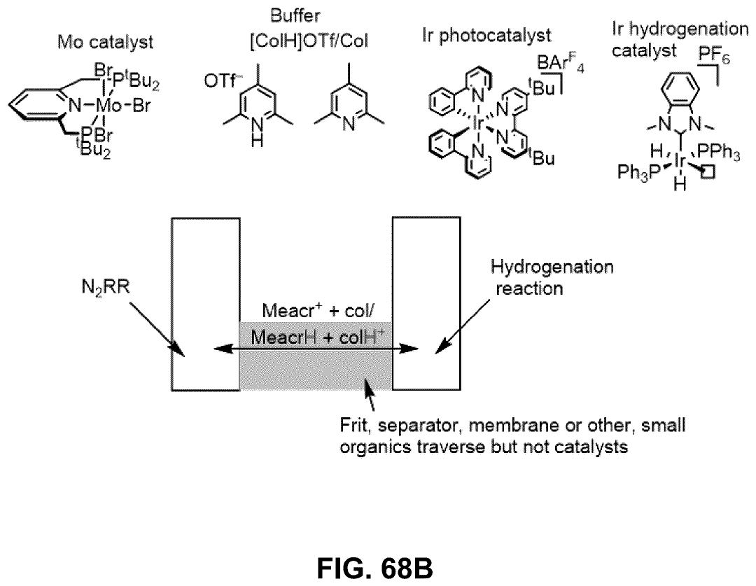

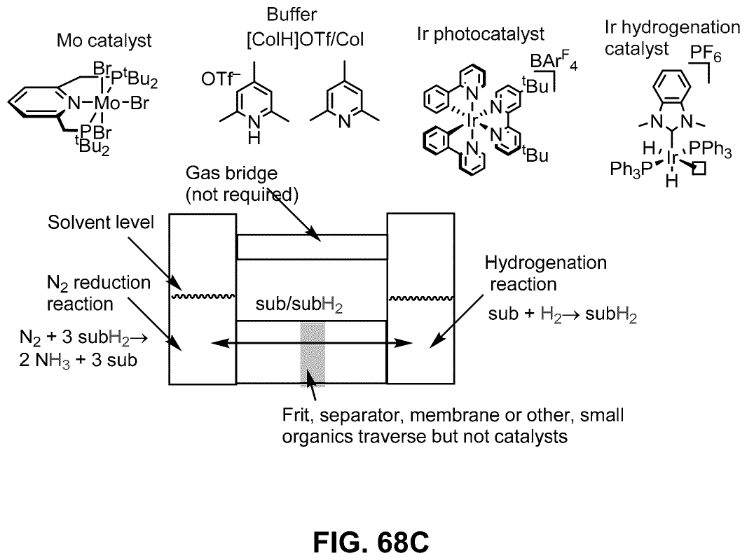

This section is best read in view of FIGS. 67-68C. In this strategy, to avoid side reactivity between the catalysts the hydrogenation reaction and N₂R reaction are separated in space, but in such a way that sub/subH₂ can migrate between the reactions. In this strategy one adds N₂R catalyst, solvent and a photocatalyst and buffer in one reaction chamber and a hydrogenation catalyst, sub, solvent, and buffer in a second reaction chamber. The reaction chambers are connected by a membrane, frit or other separator which will keep the catalysts apart but allows the transfer of sub, subH₂, buffer and solvent. The two chambers may also be connected by a pressure equilibrating bridge and thus having the same atmosphere, i.e., a mixed atmosphere such as strategy #1. Alternatively, the two chambers may have different atmospheres with H₂ gas on the hydrogenation side and N₂ gas on the N₂ reduction side. In the chamber with the hydrogenation catalyst sub is hydrogenated to subH₂. On the N₂ reduction side of N₂ is converted to NH₃ while converting subH₂ to sub, with this reaction being photodriven. An example of such a reaction is given below, where [MoBr]3 (2.3 mM), [Ir(ppy)₂(dtbbpy)]BAr^{F}₄ (1 equiv), 54 equiv Col, 54 equiv [ColH]OTf are added to the N₂ reduction side and 54 equiv methyl acridinium triflate, 108 equiv Col, 54 equiv [ColH]OTf and [Ir(PPh₃)(NHC)(COD)]PF₆+PPh₃ (1 equiv)⁴ are added to the hydrogenation side in toluene solvent. Under a mixed N₂ (1 bar)/H₂ gas (0.15 bar) atmosphere methyl acridinium triflate and Col are hydrogenated to methyl acridan and [ColH]OTf on the hydrogenation side, while on the N₂ reduction side 3 equivalents of methyl acridan and [ColH]OTf reduce N₂ to 2 NH₃ while forming methyl acridinium triflate and Col.

### Example 13: Exemplary Transfer Agent Selection Criteria

According to some aspects, a transfer agent may be selected according to the following criteria. For example, the transfer agent satisfies criteria (A) and one or both of criteria (B) & (C). In principle, there are no limits on the binding affinity of sub for H₂ due to the photochemical nature of the reaction. Dihydropyridines and hydroquinones are promising classes, particularly for the sub recycling strategies outlined above.

(A) subH₂ can be oxidized by n H⁺/n e⁻ (n=integer) to yield sub. To date most explored subH₂ donate 2H⁺/2e⁻ (i.e. Hantzsch ester, HEH₂↔HE), but 1 H⁺/1e⁻ (e.g. TEMPOH ↔TEMPO*) or 4H⁺/4e⁻ (e.g. 1,2,3,4-Tetrahydroquinaldine↔Quinaldine) are other possibilities. subH₂ does not need to be a single species, but could also be two species like a combination of hydride donor and proton donor (N-methyl-9-hydroacridine+collidinium ↔N-methyl aciridinium+collidine).

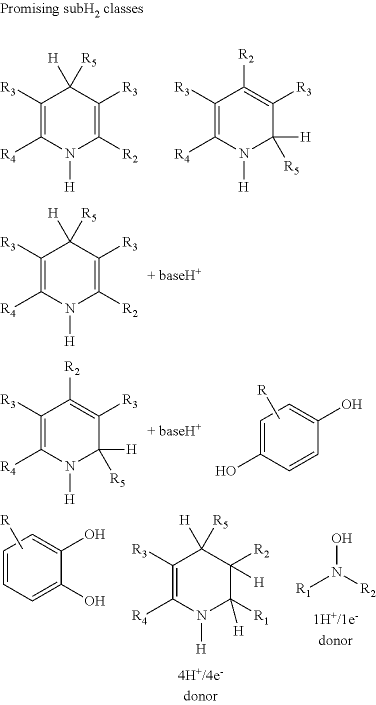

(B) subH₂ can react with the photocatalyst either via reductive quenching to generate the reduced photocatalyst or reductive regeneration of the oxidized photocatalyst to form the ground state photocatalyst.

(C) As is the case with the Hantzsch ester, subH₂ can serve as the chromophore, and upon excitation can donate H⁺/e⁻ equivalents. SubH₂ that have been demonstrated to serve as photoreductants for N₂RR with different light sources are summarized below.

TABLE 12
subH₂ photoreductants.

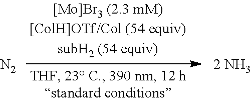

| | | | | NH₃ |
|---|---|---|---|---|
| | | NH₃ | NH₃ yield/subH₂ | (equiv/Mo) |
| Entry | subH₂ | (equiv/Mo) | (%) | Blue LED |
| 1 | HEH₂ | 15.8 ± 1.7 | 44 ± 5 | 9.5 ± 1 |
| 2 | ^{4-CNPh}HEH₂ | 2.1 ± 0.1 | 5.8 ± 0.3 | 1.75 ± 0.15 |
| 3 | phenH₂ | 0.9 ± 0.1 | 2.5 ± 0.3 | 0.16 ± 0.08 |
| 4 | BNAH | 1.3 ± 0.4 | 5 ± 2 | 0.4 ± 0.1 |
| 5 | acrH₂ | 0.4 | 1.1 | 0.21 ± 0.05 |
| 6 | ^{Ph}HE(Me)H | <0.1 | <0.3 | <0.1 |
| 7 | ^{Ph}HEH₂ | 2 ± 1 | 6 ± 3 | 0.76 ± 0.06 |
| 8 | ^{Ph}HKH₂ | 2.7 ± 0.8 | 7.4 ± 2.1 | 1.9 ± 0.8 |

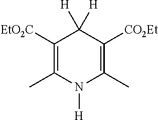 [SMILES: CCOC(=O)C1=C(C)NC(C)=C(C(=O)OCC)C1]

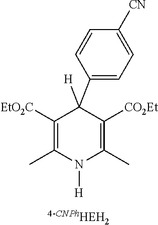 [SMILES: CCOC(=O)C1=C(C)NC(C)=C(C(=O)OCC)C1c1ccc(C#N)cc1]

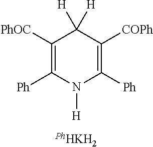

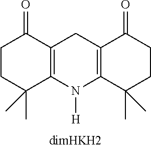 [SMILES: CC1(C)CCC(=O)C2=C1NC1=C(C2)C(=O)CCC1(C)C]

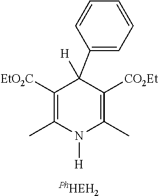 [SMILES: CCOC(=O)C1=C(C)NC(C)=C(C(=O)OCC)C1c1ccccc1]

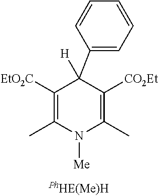 [SMILES: CCOC(=O)C1=C(C)N(C)C(C)=C(C(=O)OCC)C1c1ccccc1]

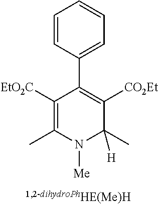 [SMILES: CCOC(=O)C1=C(C)N(C)C(C)C(C(=O)OCC)=C1c1ccccc1]

TABLE 13
subH₂ as reductive quenchers

| | | NH₃ | NH₃ yield/ |
|---|---|---|---|
| Entry | Variations | (equiv/Mo) | HEH₂ (%) |
| 1 | SubH₂ = HEH₂, THF solvent | 24 ± 4 | 67 ± 10 |
| 2 | SubH₂ = HEH₂, toluene solvent | 13.6 ± 4 | 38 ± 2 |
| 3 | SubH₂ = acrH₂, THF solvent | 6.4 ± 0.3 | 17.7 ± 0.8 |
| 4 | SubH₂ = phenH₂, THF solvent | 4.6 ± 0.8 | 13 ± 2 |
| 5 | SubH₂ = ^{N—Me}HEH + [ColH]OTf, | 4.4 ± 0.4 | 12 ± 1 |
| | toluene solvent | | |
| 6 | SubH₂ = ^{N—Me}acrH + [ColH]OTf, | 10.7 ± 0.3 | 30.0 ± 0.8 |
| | toluene solvent | | |
| 7 | SubH₂ = ^{N—Me}acrH + [ColH]OTf, | 9.4 ± 1 | 26 ± 3 |
| | THF solvent | | |
| 8 | SubH₂ = ^{N—Me}phenH + | 1.9 ± 0.1 | 5.0 ± 0.3 |
| | [ColH]OTf, toluene solvent | | |

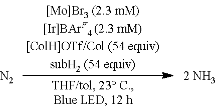

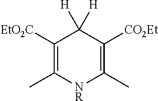

R = H or Me

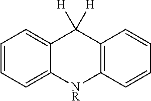

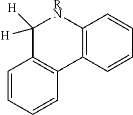

### Example 14: Exemplary Metal Catalyst Selection Criteria

According to some aspects, the catalyst (or, first metal-containing catalyst) is a catalyst that preferentially binds N₂ in a solvent at some temperature and pressure. M includes molecules such as [MoBr₃] which do not bind N₂ in their precatalyst form, but can be converted by the photoreduction system to an active species. We anticipate that the reported conditions could be compatible with Mo catalysts assembled in situ from simple mixtures of MoX₃(THF)₃ (X=Br, I) and monodentate or bidentate phosphine ligands.¹² Additional M that we have considered are listed below.^{13, 14}

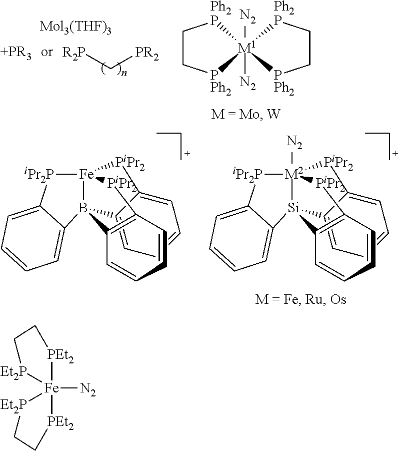

### Example 15: Exemplary Buffer Selection Criteria

According to some aspects the buffer is a combination of Brönsted acid and its conjugate base which undergo rapid proton transfer reactions with other components. In the presence of a photosensitizer (PS), buffer is not crucial to the N₂RR but it does enhance yields. In addition to the reported Col/[ColH]OTf buffer, the buffer system [^{2,6-Me}pyr]OTf/^{2,6-Me}pyr is compatible with the photoreduction (otherwise standard Ir-free conditions from

### Example 16: Exemplary Photosensitizer Selection Criteria

According to some aspects, the photosensitizer is a species which absorbs light and converts it to chemical energy through reductive or oxidative quenching mechanisms. PS should strongly absorb UV or visible light and have a long excited state lifetime. In addition to the Ir-based photoredox catalysts reported in the Science Advances paper, we have considered Ru-based PS and organic PS.¹⁵

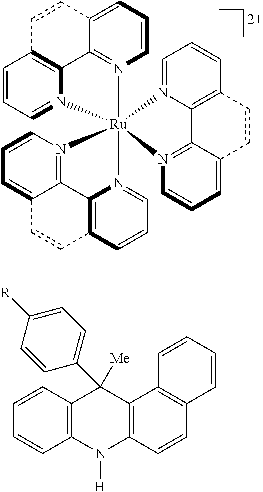

### Example 17: Exemplary Light Considerations

It is demonstrated above that use of UV light (390 nm, H160 lamp) in the photosensitizer-free reaction of Hantzsch ester with N₂ increases the reaction yield (otherwise standard Ir-free conditions; 15.8±1.7 equiv NH₃ per Mo, 44±5% yield with respect to Hantzsch ester). However, other wavelengths are useful as well, such as green light.

### Example 18: Exemplary Solvent Selection Criteria

According to some aspects, useful solvents include those described above (e.g., tetrahydrofuran, toluene, diethyl ether, benzene) as well as others such as alcohol solvents. Using otherwise standard conditions with the Ir photocatalyst, a 60:40 mixture of trifluoroethanol:THF yields 6.5±0.7 equiv NH₃ per Mo, while methanol yields 7.9 equiv. Biphasic solvent mixtures (toluene:water) are also compatible with N₂RR.

### Example 19: Exemplary Additional Aspects and Considerations

Many permutations of subH₂, metal catalyst, buffer, photosensitizer, light, and solvent are contemplated to achieve photodriven N₂RR. It is worth noting that particularly promising combinations can be identified to a priori limit the parameter space based on reported reaction conditions and thermodynamic compatibility considerations. Selection of the transfer agent may determine the useful candidates and criteria for the photosensitizer or photocatalyst. For example, use of the Hantzsch ester as subH₂ may narrow the pool of possible photosensitizers to those with an excited state that can be reductively quenched by the Hantzsch ester (E° (PSⁿ⁺*/PSⁿ⁻¹)>E° ([subH₂]*⁺/subH₂)). [Ir(ppy)₂(dtbpy)]⁺ was selected from the resulting pool because its reduction potential following reductive quenching (E° (PSⁿ⁺/Pⁿ⁻¹)) is a close match to decamethylcobaltocene (Cp*₂Co). On a thermodynamic basis, the Hantzsch ester/[Ir(ppy)₂(dtbpy)]⁺ pair should be capable of carrying out the most challenging electron transfer steps involved in any M-catalyzed N₂RR reported to function with Cp*₂Co as the chemical reductant, of which there are several. The selection of [MoBr₃] from this set then guides the buffer choice to match the pKₐ of the acids reported for chemical N₂R with this catalyst, thereby ensuring that the most challenging proton transfer steps with [MoBr₃] can occur. Importantly, the acid component of the buffer must not be deprotonated by subH₂ (or sub), and the base component must not competitively quench PS*.

### REFERENCES CITED IN EXAMPLES 10−19

(1) Chen, Q.-A.; Chen, M.-W.; Yu, C.-B.; Shi, L.; Wang, D.-S.; Yang, Y.; Zhou, Y.-G. Biomimetic Asymmetric Hydrogenation: In Situ Regenerable Hantzsch Esters for Asymmetric Hydrogenation of Benzoxazinones. J. Am. Chem. Soc. 2011, 133 (41), 16432-16435. https://doi.org/10.1021/ja208073w.
(2) Chen, Q.-A.; Gao, K.; Duan, Y.; Ye, Z.-S.; Shi, L.; Yang, Y.; Zhou, Y.-G. Dihydrophenanthridine: A New and Easily Regenerable NAD(P)H Model for Biomimetic Asymmetric Hydrogenation. J. Am. Chem. Soc. 2012, 134 (4), 2442-2448. https://doi.org/10.1021/ja211684v.
(3) Slinker, J. D.; Gorodetsky, A. A.; Lowry, M. S.; Wang, J.; Parker, S.; Rohl, R.; Bernhard, S.; Malliaras, G. G. Efficient Yellow Electroluminescence from a Single Layer of a Cyclometalated Iridium Complex. J. Am. Chem. Soc. 2004, 126 (9), 2763-2767. https://doi.org/10.1021/ja0345221.
(4) Dobereiner, G. E.; Nova, A.; Schley, N. D.; Hazari, N.; Miller, S. J.; Eisenstein, O.; Crabtree, R. H. Iridium-Catalyzed Hydrogenation of N-Heterocyclic Compounds under Mild Conditions by an Outer-Sphere Pathway. J. Am. Chem. Soc. 2011, 133 (19), 7547-7562. https://doi.org/10.1021/ja201493.
(5) Kim, S.; Park, Y.; Kim, J.; Pabst, T. P.; Chirik, P. J. Ammonia Synthesis by Photocatalytic Hydrogenation of a N₂-Derived Molybdenum Nitride. Nat. Synth. 2022, 1 (4), 297-303. https://doi.org/10.1038/s44160-022-00044-1.
(6) Kim, S.; Zhong, H.; Park, Y.; Loose, F.; Chirik, P. J. Catalytic Hydrogenation of a Manganese(V) Nitride to Ammonia. J. Am. Chem. Soc. 2020, 142 (20), 9518-9524. https://doi.org/10.1021/jacs.0c03346.
(7) Arashiba, K.; Miyake, Y.; Nishibayashi, Y. A Molybdenum Complex Bearing PNP-Type Pincer Ligands Leads to the Catalytic Reduction of Dinitrogen into Ammonia. Nat. Chem. 2011, 3(2), 120-125. https://doi.org/10.1038/nchem.906.
(8) Arashiba, K.; Eizawa, A.; Tanaka, H.; Nakajima, K.; Yoshizawa, K.; Nishibayashi, Y. Catalytic Nitrogen Fixation via Direct Cleavage of Nitrogen-Nitrogen Triple Bond of Molecular Dinitrogen under Ambient Reaction Conditions. Bull. Chem. Soc. Jpn. 2017. https://doi.org/10.1246/bcsj.20170197.
(9) Ashida, Y.; Onozuka, Y.; Arashiba, K.; Konomi, A.; Tanaka, H.; Kuriyama, S.; Yamazaki, Y.; Yoshizawa, K.; Nishibayashi, Y. Catalytic Nitrogen Fixation Using Visible Light Energy. Nat. Commun. 2022, 13 (1), 7263. https://doi.org/10.1038/s41467-022-34984-1.
(10) NISHIBAYASHI, Y.; ARASHIBA, K.; ASHIDA, Y.; Kondo, S.; Kikuchi, T. Ammonia Production Method and Ammonia Production Apparatus. US20230002917A1, Jan. 5, 2023. https://patents.google.com/patent/US20230002917A1/en?inventor=Yoshiaki+Nishibaya shi (accessed 2023-03-09).
(11) Peters, J. C.; Anderson, J. S.; CRUETZ, S. E.; RITTLE, J. D. Catalytic Ammonia Synthesis by Transition Metal Molecular Complexes. US20150104371A1, Apr. 16, 2015. https://patents.google.com/patent/US20150104371A1/en?inventor=Jonas+C+Peters (accessed 2023-03-09).
(12) Ashida, Y.; Arashiba, K.; Tanaka, H.; Egi, A.; Nakajima, K.; Yoshizawa, K.; Nishibayashi, Y. Molybdenum-Catalyzed Ammonia Formation Using Simple Monodentate and Bidentate Phosphines as Auxiliary Ligands. Inorg. Chem. 2019, 58 (14), 8927-8932.
(13) Hill, P. J.; Doyle, L. R.; Crawford, A. D.; Myers, W. K.; Ashley, A. E. Selective Catalytic Reduction of N₂ to N₂H₄ by a Simple Fe Complex. J. Am. Chem. Soc. 2016, 138 (41), 13521-13524. https://doi.org/10.1021/jacs.6b08802.
(14) Fajardo, J. Jr.; Peters, J. C. Catalytic Nitrogen-to-Ammonia Conversion by Osmium and Ruthenium Complexes. J. Am. Chem. Soc. 2017, 139 (45), 16105-16108. https://doi.org/10.1021/jacs.7b10204.
(15) Bortolato, T.; Simionato, G.; Vayer, M.; Rosso, C.; Paoloni, L.; Benetti, E. M.; Sartorel, A.; Lebouf, D.; Dell'Amico, L. The Rational Design of Reducing Organophotoredox Catalysts Unlocks Proton-Coupled Electron-Transfer and Atom Transfer Radical Polymerization Mechanisms. J. Am. Chem. Soc. 2023, 145 (3), 1835-1846. https://doi.org/10.1021/jacs.2c11364.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation and method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method for photodriven hydrogenation of N₂, the method comprising:
hydrogenating N₂ to NH₃ in the presence of a light, an organic transfer agent, and a first metal-containing catalyst;
wherein:
the transfer agent and the first catalyst are in a solution;
the transfer agent comprises n chemically transferable electrons and protons, n being an integer equal to or greater than 1;
the step of hydrogenating comprises at least one charge-transfer reaction via which the transfer agent donates at least one electron and at least one proton to one or more other chemical species;
the step of hydrogenating comprises at least one photochemical reaction; and
the light is characterized by energy sufficient to drive the at least one photochemical reaction.

2. The method of claim 1, wherein the transfer agent is a phototransfer agent; and wherein the light is characterized by energy sufficient to photoexcite the phototransfer agent from a first state to an excited state thereof.

3. The method of claim 1, wherein the step of hydrogenating further occurs in the presence of a photosensitive cocatalyst; wherein the photosensitive cocatalyst is in the solution; wherein the light is characterized by energy sufficient to photoexcite the photosensitive cocatalyst from a first state to an excited state thereof; wherein the transfer agent chemically reduces the excited state of the photosensitive cocatalyst to a reduced first state of the photosensitive cocatalyst; and wherein the reduced first state of the photosensitive cocatalyst reduces the first metal catalyst and/or one or more species comprising the first metal catalyst during N₂ hydrogenation.

4. The method of claim 3, wherein the excited state of the photosensitive cocatalyst reduces the first metal catalyst and/or one or more species comprising the first metal catalyst thereby forming an oxidized first state of the photosensitive cocatalyst; and wherein the transfer agent reduces the oxidized first state of the photosensitive cocatalyst thereby regenerating the first state of the photosensitive cocatalyst.

5. The method of claim 1, wherein the transfer agent comprises one or more azine groups, one or more pyridine groups, a dihydropyridine group, a hydroquinone group, a Hantzsch Ester, and/or a derivative thereof.

6. (canceled)

7. (canceled)

8. (canceled)

9. The method of claim 1, wherein n is 1, 2, or 4.

10. (canceled)

11. The method of claim 1, wherein the transfer agent is a combination of at least one hydride- or electron-donor species and at least one proton-donor species.

12. The method of claim 1, wherein each molecule of the transfer agent comprises the n transferable electrons and protons.

13. The claim 1, wherein the transfer agent comprises at least one compound characterized by formula FX1, FX2, FX3, FX4, FX5, FX6, FX7, FX8, FX9A, FX9B, FX10A, FX10B, FX11, FX12A, FX12B, FX13A, FX13B, FX14A, FX14B, FX15A, FX15B, FX16A, FX16B, FX17A, FX17B, FX18A, FX18B, or any derivative thereof: 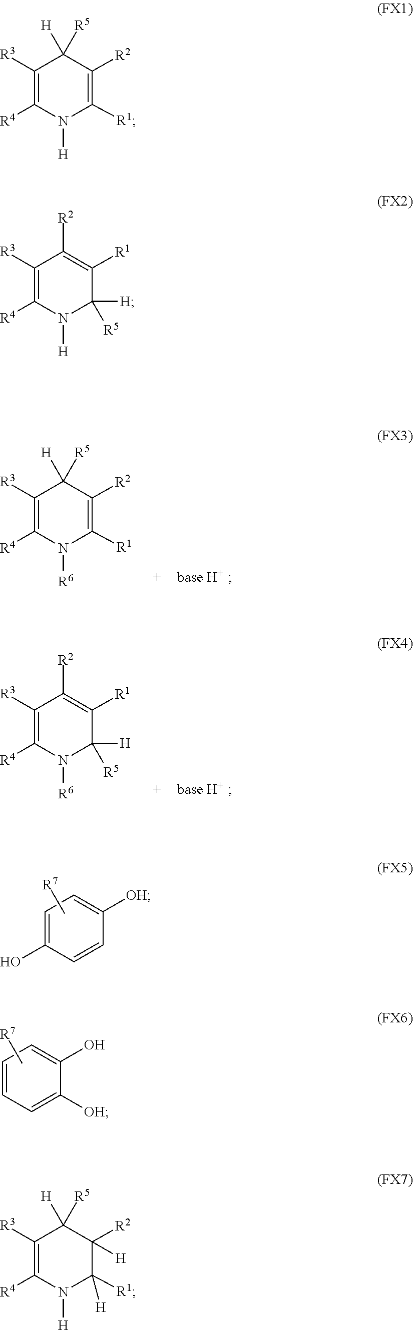 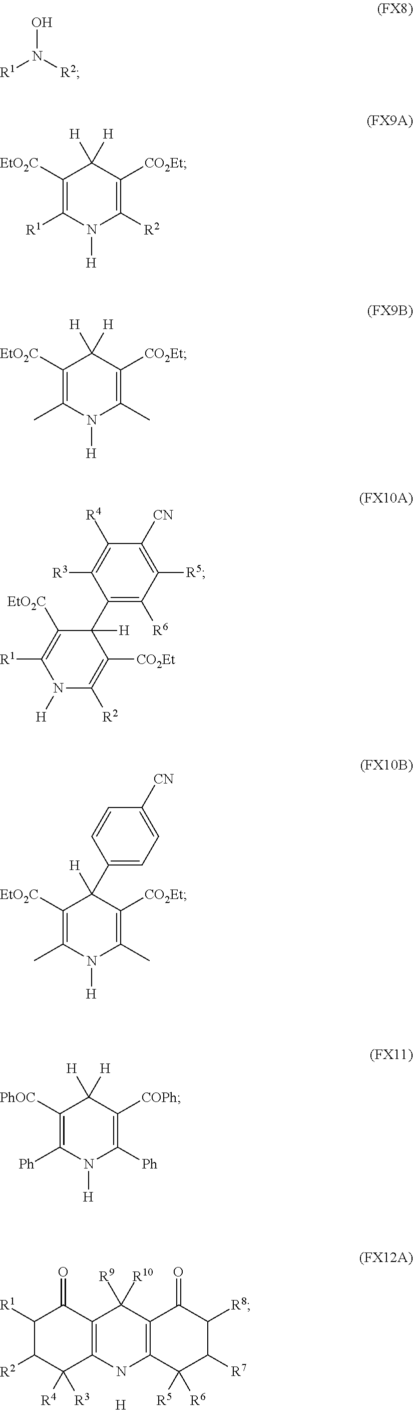 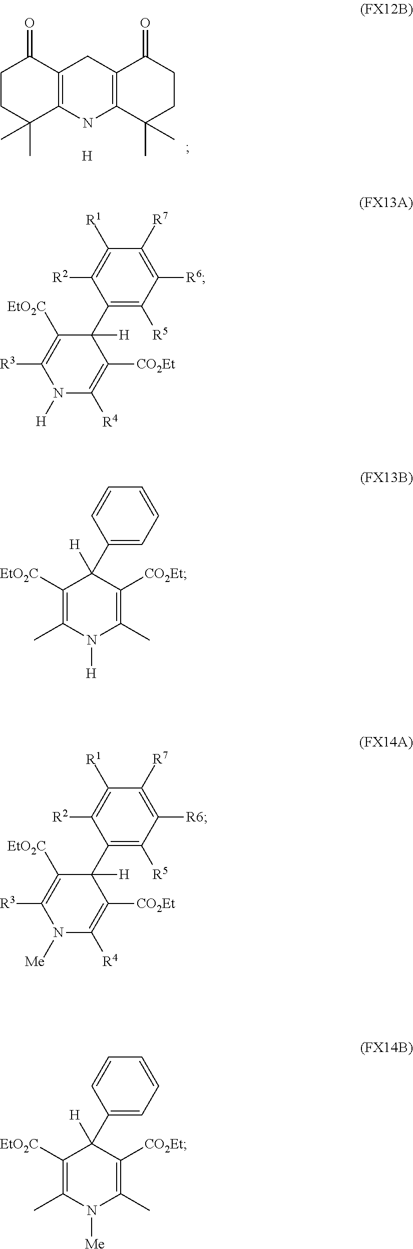 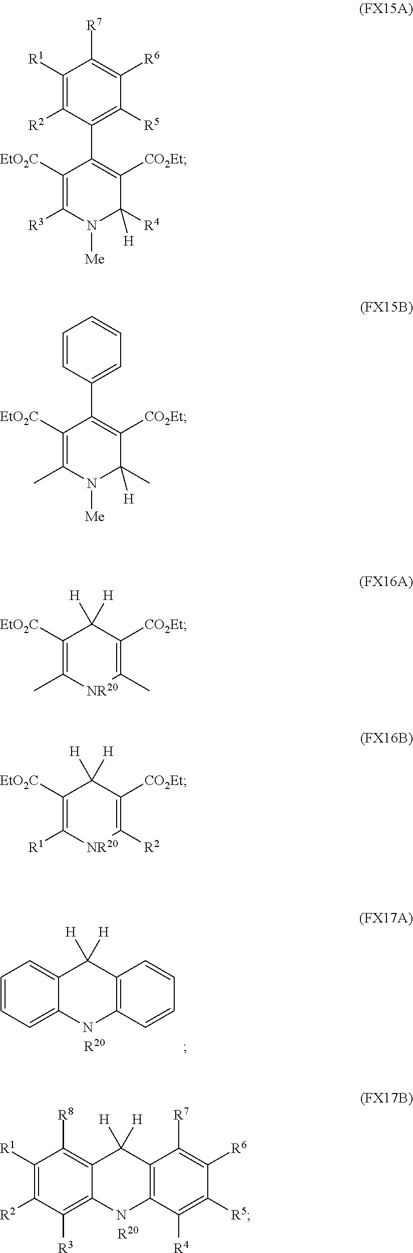 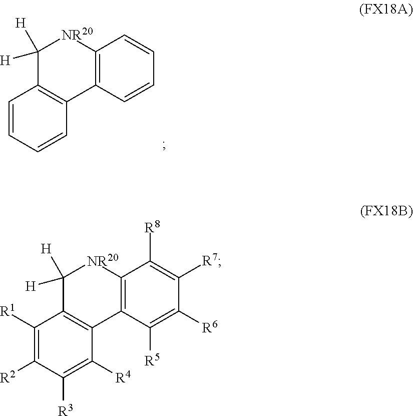
wherein:
each of R₁, R₂, R₃, R₄, R₅, R₆, R₇, R₈, R₉, and R₁₀ is independently H or a monovalent functional group characterized by a molecular weight less than 400 g/mol;
each R²⁰ is independently H or a methyl group;
each baseH+ is independently a Bronsted base;
each Et is an ethyl group;
each Me is a methyl group; and
each Ph is a phenyl group.

14. The method of claim 13, wherein each of R₁, R₂, R₃, R₄, R₅, R₆, R₇, R₈, R₉, and R₁₀ is independently not an alkyne group nor a nitro group.

15. The method of claim 1, wherein the step of hydrogenating is characterized by an overall reaction comprising a 3:1 ratio of transfer agent to N₂ and a 3:2 ratio of transfer agent to produced NH₃.

16. The method of claim 1, wherein the step of hydrogenating comprises a sequence of reactions, the sequence of reactions comprising at least two intermediate reactions having transfer of a proton from the transfer agent.

17. The method of claim 1, wherein the step of hydrogenating is characterized by an overall reaction characterized by equation EQ1:
3(subH₂)+N₂→2NH₃+3(sub) (EQ1); wherein:
subH₂ is the transfer agent characterized by n being 2; and
sub is a spent-transfer agent, being the transfer agent after donating two protons and two electrons.

18. The method of claim 1, wherein the transfer agent has a concentration in the solution selected from the range of 1 mM to 10 M.

19-61. (canceled)

62. The method of claim 1, wherein hydrogenation of N₂ to NH₃ comprises oxidation of the transfer agent to a spent-transfer agent, the spent-transfer agent having two protons and two electrons fewer than the transfer agent; wherein the solution is a first solution; and wherein the method further comprises:
regenerating the spent-transfer agent back into the transfer agent.

63. A method of hydrogenation of N₂, the method comprising:
hydrogenating N₂ to NH₃ in the presence of a light, an organic transfer agent, and a first metal-containing catalyst; and
regenerating a spent-transfer agent back into the transfer agent;
wherein hydrogenation of N₂ to NH₃ comprises oxidation of the transfer agent to the spent-transfer agent;
wherein the transfer agent and the first catalyst are in a first solution;
wherein the light is characterized by energy sufficient to photoexcite the transfer agent from a first state to an excited state thereof;
wherein the transfer agent comprises n transferable electrons and protons, n being an integer equal to or greater than 1; and
wherein the step of hydrogenating comprises the transfer agent donating at least one electron and at least one proton.

64. The method of claim 63, wherein the first solution further comprises a buffer and an organic photosensitizer; and wherein the step of hydrogenating occurs in the presence of the buffer and the photosensitizer.

65. The method of claim 62, wherein the steps of hydrogenating and regenerating are occurring simultaneously in the same first solution;
wherein the step of regenerating comprises one or more regeneration reactions;
wherein the solution further comprises a hydrogenation catalyst for catalyzing at least one of the regeneration reactions; and
wherein the steps of hydrogenating and regenerating are occurring in the presence of N₂ gas and H₂ gas.

66. The method of claim 62, wherein the steps of hydrogenating and regenerating are performed sequentially, in any order, in said first solution in the presence of the first metal-containing catalyst;
wherein the step of regenerating comprises one or more regeneration reactions;
wherein the solution further comprises a hydrogenation catalyst for catalyzing at least one of the regeneration reactions;
wherein the step of regenerating is performed in the presence of an H₂ gas; and
wherein the step of hydrogenating is performed in the presence of N₂ gas.

67. (canceled)

68. (canceled)

69. (canceled)

70. The method of claim 62, wherein the steps of hydrogenating and regenerating are performed separately; wherein the step of hydrogenating occurs in the first solution and the step of regenerating occurs in a second solution;
wherein the step of regenerating comprises one or more regeneration reactions;
wherein the second solution comprises:
a hydrogenation catalyst for catalyzing at least one of the regeneration reactions; and
the spent-transfer agent; and
wherein the step of regenerating is performed in the presence of an H₂ gas.

71. (canceled)

72. (canceled)

73. (canceled)

74. (canceled)

75. (canceled)

76. A method for photodriven hydrogenation of a starting chemical species, the method comprising:
hydrogenating a starting chemical species to one or more hydrogenated product species in the presence of a light, an organic transfer agent, and a first metal-containing catalyst;
wherein:
the transfer agent, the first catalyst, and the starting chemical species are in a solution;
the transfer agent comprises n chemically transferable electrons and protons, n being an integer equal to or greater than 1;
the step of hydrogenating comprises at least one charge-transfer reaction via which the transfer agent donates at least one electron and at least one proton to one or more other chemical species;
the step of hydrogenating comprises at least one photochemical reaction; and
the light is characterized by energy sufficient to drive the at least one photochemical reaction.

77. (canceled)

78. (canceled)

79. (canceled)

80. (canceled)

81. (canceled)
